(19) United States
(12) Patent Application Publication
(10) Pub. No.: US 2025/0339778 A1
(43) Pub. Date: Nov. 6, 2025

(54) NON-TRANSITORY COMPUTER READABLE MEDIUM, INFORMATION PROCESSING METHOD, AND GAME APPARATUS

(71) Applicant: CYGAMES, INC., Tokyo (JP)

(72) Inventors: Kosuke Hirahata, Tokyo (JP); Yujiro Deguchi, Tokyo (JP); Yuki Tamura, Tokyo (JP); Tomonori Suzuki, Tokyo (JP); Xu Guo, Tokyo (JP)

(73) Assignee: CYGAMES, INC., Tokyo (JP)

(21) Appl. No.: 19/269,689

(22) Filed: Jul. 15, 2025

Related U.S. Application Data
(63) Continuation of application No. PCT/JP2024/002426, filed on Jan. 26, 2024.

(30) Foreign Application Priority Data
Feb. 7, 2023 (JP) 2023-017034
Feb. 7, 2023 (JP) 2023-017035

(51) Int. Cl. A63F 13/69

(52) U.S. Cl. CPC A63F 13/69

(57) ABSTRACT

A non-transitory computer readable medium stores a program causing a computer to execute processing of updating a parameter associated with a nurture target character, based on a player operation during a nurture game; processing of enabling a skill to be obtained by consuming points during the nurture game, the skill being set with a first effect and associated with the nurture target character at the start of the nurture game; processing of associating obtained information to the skill obtained; and processing of enabling the skill or the first effect set for the skill to be changed, when a change condition set for each skill and set for the skill associated with the obtained information is satisfied.

### CROSS REFERENCE TO RELATED APPLICATIONS

This application is a continuation application of International Application No. PCT/JP2024/002426, filed on Jan. 26, 2024, which claims priority to Japanese Patent Applications Nos. 2023-017034 and 2023-017035, filed on Feb. 7, 2023, the entire contents of which are incorporated by reference herein.

### BACKGROUND ART

### Technical Field

The present invention relates to an information processing program, an information processing method, and a game apparatus. This application claims the benefit of priority based on Japanese Patent Application No. 2023-017034 filed on Feb. 7, 2023 and Japanese Patent Application No. 2023-017035 filed on Feb. 7, 2023, the contents of which are incorporated herein by reference.

In the related art, a game of the genre referred to as a nurture game is known. For example, Patent Document 1 discloses a game in which a player selects any one of a plurality of types of nurturing events to nurture a nurture target character.

### CITATION LIST

### Patent Literature

Patent Literature 1: JP 7198902 B

### SUMMARY OF INVENTION

### Technical Problem

As described above, in the game in which the nurture target character is nurtured, there is a problem in that if the game lacks in strategic performance required from the player, this may cause a reduction in the player's motivation to play the game.

An object of the present invention is to provide an information processing program, an information processing method, and a game apparatus that can motivate a player to play the game by improving the strategic performance.

### Solution to Problem

To solve the problems described above, provided is an information processing program that causes a computer to execute processing of updating a parameter associated with a nurture target character, based on a player operation during a nurture game; processing of enabling a skill to be obtained by consuming points during the nurture game, the skill being set with a first effect and associated with the nurture target character at the start of the nurture game; processing of associating obtained information to the skill obtained; and processing of enabling the skill or the first effect set for the skill to be changed when a change condition set for each skill and set for the skill associated with the obtained information is satisfied.

Also, the skill may be associated with a plurality of second skills or second effects, and the processing of enabling the skill or the first effect to be changed may include enabling a player to select the second skill or the second effect.

Also, the skill may be associated with a plurality of second skills or second effects,
the plurality of second skills or second effects may be associated with different change conditions, and the processing of enabling the skill or the first effect to be changed may include enabling the skill or the first effect to be changed to the second skill or second effect for which the change condition is satisfied.

Also, the computer may be caused to further execute:
processing of displaying an obtainment screen where the skill can be obtained, during the nurture game, wherein
the change condition set for the skill and an achievement level of the change condition may be displayed on the obtainment screen.

Also, the computer may be caused to further execute:
processing of displaying an obtainment screen where the skill can be obtained, during the nurture game, wherein
the skill for which the change condition is satisfied may be highlighted on the obtainment screen.

To solve the problems described above, provided is an information processing method executed by one or more computers, including:
processing of updating a parameter associated with a nurture target character, based on a player operation during a nurture game;
processing of enabling a skill to be obtained by consuming points during the nurture game, the skill being set with a first effect and associated with the nurture target character at the start of the nurture game;
processing of associating obtained information to the skill obtained; and
processing of enabling the skill or the first effect set for the skill to be changed when a change condition set for each skill and set for the skill associated with the obtained information is satisfied.

To solve the problems described above, provided is a game apparatus including:
one or more computers, wherein the one or more computers execute
processing of updating a parameter associated with a nurture target character, based on a player operation during a nurture game;
processing of enabling a skill to be obtained by consuming points during the nurture game, the skill being set with a first effect and associated with the nurture target character at the start of the nurture game;
processing of associating obtained information to the skill obtained; and
processing of enabling the skill or the first effect set for the skill to be changed when a change condition set for each skill and set for the skill associated with the obtained information is satisfied.

### Effects of Disclosure

According to the present invention, the motivation of the players to play can be improved by improving the strategic performance.

### BRIEF DESCRIPTION OF DRAWINGS

FIG. 1 is an explanatory diagram illustrating a schematic configuration of an information processing system.

FIG. 2A is a diagram for describing a hardware configuration of a player terminal. FIG. 2B is a diagram for describing a hardware configuration of a server.

FIG. 3A is a diagram for describing an example of a home screen. FIG. 3B is a diagram for describing an example of an option setting screen. FIG. 3C is a diagram for describing an example of a profile setting screen.

FIG. 4 is a diagram for describing a rough progression flow of a nurture game.

FIG. 5A is a diagram for describing an example of scenario initial additional value data. FIG. 5B is a diagram for describing an example of scenario initial upper limit value data. FIG. 5C is a diagram for describing an example of scenario event additional value data.

FIG. 6A is a diagram for describing a nurture target character selection screen. FIG. 6B is a first diagram for describing a character detail screen. FIG. 6C is a second diagram for describing the character detail screen.

FIG. 7A is a diagram for describing an ability parameter (initial value) table. FIG. 7B is a diagram for describing an aptitude parameter (initial value) table. FIG. 7C is a diagram for describing skills. FIG. 7D is a diagram for describing an exclusive event.

FIG. 8 is a diagram for describing a character strengthening screen.

FIG. 9A is a first diagram for describing an inheritance character selection screen. FIG. 9B is a first diagram for describing a nurtured character list screen. FIG. 9C is a second diagram for describing the inheritance character selection screen. FIG. 9D is a third diagram for describing the inheritance character selection screen.

FIG. 10 is a diagram for describing an inheritance system.

FIG. 11 is a diagram for describing factor information.

FIG. 12A is a diagram for describing the effects of basic ability factors. FIG. 12B is a diagram for describing the effects of character factors.

FIG. 13A is a diagram for describing compatibility determination targets, and FIG. 13B is a diagram for describing compatibility determination items.

FIG. 14A is a first diagram for describing a support card organization screen. FIG. 14B is a diagram for describing a support card selection screen. FIG. 14C is a second diagram for describing the support card organization screen.

FIG. 15A is a diagram for describing a support card table. FIG. 15B is a diagram for describing support effects. FIG. 15C is a diagram for describing base skills. FIG. 15D is a diagram for describing support events.

FIG. 16A is a diagram for describing a final confirmation screen. FIG. 16B is a diagram for describing a preset selection screen.

FIG. 17 is a diagram for describing selection items in each turn.

FIG. 18 is a diagram for describing a top screen.

FIG. 19A is a first diagram for describing a training screen. FIG. 19B is a second diagram for describing the training screen. FIG. 19C is a diagram for describing a training result notification screen. FIG. 19D is a diagram for describing an event screen.

FIG. 20A is a first diagram for describing an inheritance event. FIG. 20B is a second diagram for describing an inheritance event. FIG. 20C is a third diagram for describing an inheritance event. FIG. 20D is a fourth diagram for describing an inheritance event.

FIG. 21A is a first diagram for describing a skill screen. FIG. 21B is a second diagram for describing the skill screen.

FIG. 22 is a diagram for describing examples of evolution conditions.

FIG. 23A is a diagram for describing an evolution skill confirmation screen. FIG. 23B is a first diagram for describing the evolution condition confirmation screen. FIG. 23C is a second diagram for describing the evolution condition confirmation screen.

FIG. 24A is a first diagram for describing a race selection screen. FIG. 24B is a diagram for describing a race start screen. FIG. 24C is a first diagram for describing a race result screen. FIG. 24D is a second diagram for describing the race result screen.

FIG. 25 is a diagram for describing a rough flow of turn-start processing.

FIG. 26 is a diagram for describing the placing percentage for the training items.

FIG. 27A is a diagram for describing a training level. FIG. 27B is a diagram for describing a fixed increase value (speed). FIG. 27C is a diagram for describing a fixed increase value table (power).

FIG. 28A is a diagram for describing an end confirmation dialog. FIG. 28B is a diagram for describing a suggestive image. FIG. 28C is a first diagram for describing an evolution skill selection dialog. FIG. 28D is a second diagram for describing the evolution skill selection dialog.

FIG. 29A is a third diagram for describing the evolution skill selection dialog. FIG. 29B is a fourth diagram for describing the evolution skill selection dialog.

FIG. 30A is a first diagram for describing an evolution performance image. FIG. 30B is a second diagram for describing an evolution performance image. FIG. 30C is a third diagram for describing an evolution performance image.

FIG. 31A is a fourth diagram for describing an evolution performance image. FIG. 31B is a fifth diagram for describing an evolution performance image. FIG. 31C is a sixth diagram for describing an evolution performance image.

FIG. 32A is a first diagram for describing an evolution performance image according to a modified example. FIG. 32B is a second diagram for describing an evolution performance image according to the modified example. FIG. 32C is a third diagram for describing an evolution performance image according to the modified example.

FIG. 33A is a diagram for describing a nurture completion screen. FIG. 33B is a second diagram for describing the nurture completion screen. FIG. 33C is a third diagram for describing the nurture completion screen.

FIG. 34 is a diagram for describing a configuration of a memory in the player terminal and a function as a computer.

FIG. 35 is a diagram for describing a configuration of a memory in a server and a function as a computer.

FIG. 36 is a sequence diagram for describing processing of the player terminal and the server related to the nurture game.

FIG. 37 is a flowchart for describing character strengthening processing in the player terminal.

FIG. 38 is a flowchart for describing preparation stage processing in the player terminal.

FIG. 39 is a flowchart for describing the preparation stage processing in the server.

FIG. 40 is a flowchart for describing nurture stage processing in the server.

FIG. 41 is a flowchart for describing turn-start processing in the server.

FIG. 42 is a flowchart for describing nurture stage processing in the player terminal.

FIG. 43 is a flowchart for describing skill screen display processing in the player terminal.

FIG. 44 is a flowchart for describing selection command reception processing in the server.

FIG. 45 is a flowchart for describing result information reception processing in the player terminal.

FIG. 46 is a flowchart for describing nurture game end pre-processing in the player terminal.

FIG. 47 is a flowchart for describing nurture game end processing in the server.

### DESCRIPTION OF EMBODIMENTS

Hereinafter, an aspect of an embodiment of the present invention will be described in detail with reference to the accompanying drawings. Numerical values and the like described in the embodiment are merely examples for facilitating understanding, and do not limit the present invention unless otherwise specified. In this specification and the drawings, elements having substantially the same function and configuration are denoted by the same reference numerals, and redundant description thereof will be omitted, and elements not directly relating to the present invention will not be illustrated.

### Overall Configuration of Information Processing System S

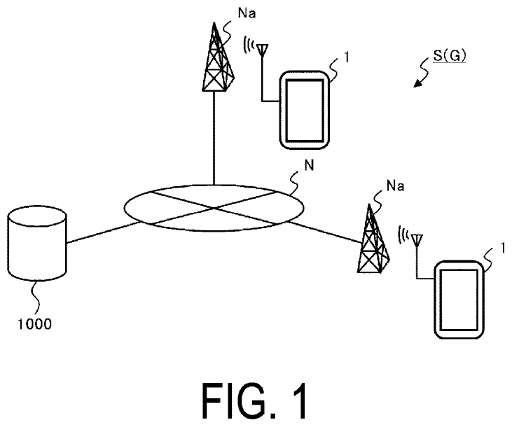

FIG. 1 is an explanatory diagram illustrating a schematic configuration of an information processing system S. The information processing system S is a so-called client-server system including a player terminal 1 functioning as a client, that is, a game terminal; a server 1000; and a communication network N including a communication base station Na.

In the information processing system S of the present embodiment, the player terminal 1 and the server 1000 function as a game apparatus G. Each of the player terminal 1 and the server 1000 has a role of controlling the progress of the game, and the game can progress via cooperation between the player terminal 1 and the server 1000.

The player terminal 1 can establish communication with the server 1000 via the communication network N. The player terminal 1 widely includes an electronic device capable of establishing a wireless or wired communication connection with the server 1000. Examples of the player terminal 1 include a smartphone, a mobile phone, a tablet device, a personal computer, a game console, and the like. In the present embodiment, a case where a smartphone is used as the player terminal 1 will be described.

The server 1000 is communicatively connected to a plurality of player terminals 1. The server 1000 accumulates various types of information for each player who plays the game. In addition, the server 1000 mainly performs processing such as updating the accumulated information and downloading images and various types of information to the player terminal 1, based on an operation input from the player terminal 1.

The communication base station Na is connected to the communication network N and wirelessly exchanges information with the player terminal 1. The communication network N is constituted by a cellular network, an Internet network, a local area network (LAN), a dedicated line, or the like, and establishes a wireless or wired communication connection between the player terminal 1 and the server 1000.

### Hardware Configuration of Player Terminal 1 and Server 1000

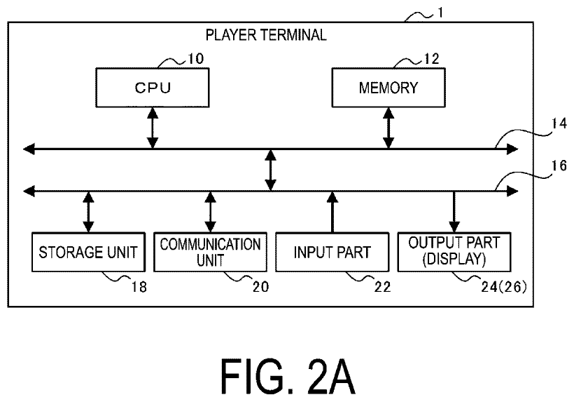

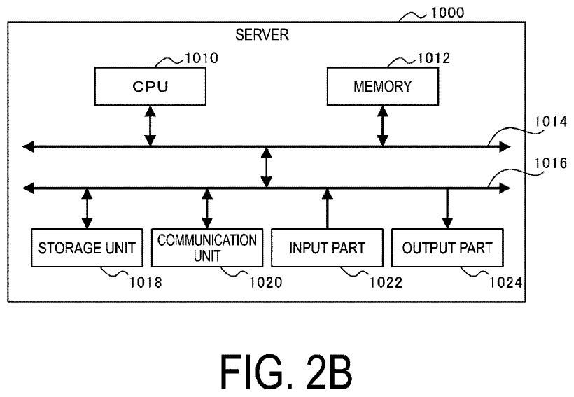

FIG. 2A is a diagram for describing a hardware configuration of the player terminal 1. FIG. 2B is a diagram for describing a hardware configuration of the server 1000. As illustrated in FIG. 2A, the player terminal 1 includes a central processing unit (CPU) 10, a memory 12, a bus 14, an input/output interface 16, a storage unit 18, a communication unit 20, an input part 22, and an output part 24.

As illustrated in FIG. 2B, the server 1000 includes a CPU 1010, a memory 1012, a bus 1014, an input/output interface 1016, a storage unit 1018, a communication unit 1020, an input part 1022, and an output part 1024.

The configurations and functions of the CPU 1010, the memory 1012, the bus 1014, the input/output interface 1016, the storage unit 1018, the communication unit 1020, the input part 1022, and the output part 1024 of the server 1000 are substantially the same as the CPU 10, the memory 12, the bus 14, the input/output interface 16, the storage unit 18, the communication unit 20, the input part 22, and the output part 24 of the player terminal 1, respectively. Thus, the hardware configuration of the player terminal 1 will be described below, and the description of the server 1000 will be omitted.

The CPU 10 operates a program stored in the memory 12 to control the progress of the game. The memory 12 is constituted by a read-only memory (ROM) or a random-access memory (RAM) and stores programs and various kinds of data necessary for controlling the progress of the game. The memory 12 is connected to the CPU 10 via the bus 14.

The input/output interface 16 is connected to the bus 14. The storage unit 18, the communication unit 20, the input part 22, and the output part 24 are connected to the input/output interface 16.

The storage unit 18 is constituted by a semiconductor memory such as a dynamic random access memory (DRAM) and stores various kinds of programs and data. In the player terminal 1, the programs and data stored in the storage unit 18 are loaded into the memory 12 (RAM) by the CPU 10.

The communication unit 20 is wirelessly communicatively connected to the communication base station Na and exchanges information such as various kinds of data and programs with the server 1000 via the communication network N. In the player terminal 1, programs or the like received from the server 1000 are stored in the memory 12 or the storage unit 18.

The input part 22 includes, for example, a touch panel, a button, a keyboard, a mouse, a four-direction key, an analog controller, and the like for inputting player operations (receiving operations). Alternatively, the input part 22 may be a dedicated controller provided in the player terminal 1 or connected (externally attached) to the player terminal 1. Furthermore, the input part 22 may be constituted by an acceleration sensor that detects the inclination or movement of the player terminal 1 or a microphone that detects audio from the player. That is, the input part 22 widely includes apparatuses that allow the player to identifiably input their intention.

The output part 24 includes a display apparatus and a speaker. Note that the output part 24 may be a device connected (externally attached) to the player terminal 1. In the present embodiment, the player terminal 1 includes a display 26 as the output part 24 and a touch panel layered over the display 26 as the input part 22.

### Details of Game

Next, a game provided by the information processing system S and the game apparatus G of the present embodiment will be described. The player can possess game content obtained through a lottery called a gacha or game content distributed from a management side. In the present embodiment, the player can possess character cards and support cards as game content. That is, one character is always associated with a character card or support card. The character associated with the character card is a nurture target in the nurture game. Hereinafter, a character associated with a character card may be referred to simply as a character.

As will be described in detail below, in the game according to the present embodiment, a nurture game is provided. In the nurture game, the player can nurture a character and create a nurtured character associated with various parameters. In addition, the nurture game according to the present embodiment has a game property of nurturing a character associated with a character card while having the character participate in a race simulating horse racing.

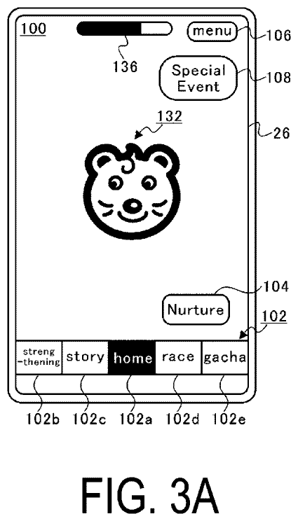

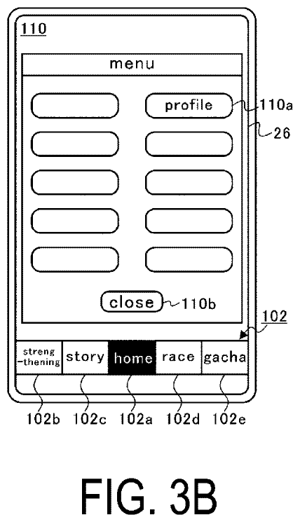

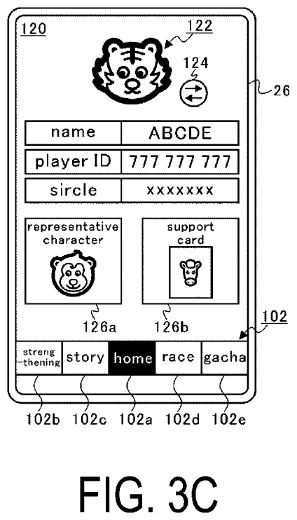

FIG. 3A is a diagram for describing an example of a home screen 100. When the game application is run on the player terminal 1, the home screen 100 is displayed on the display 26. A menu bar 102 is displayed at a lower portion of the home screen 100. The menu bar 102 is provided with a plurality of operation portions that can be operated (tapped) by the player.

Here, the menu bar 102 is provided with a home screen selection operation portion 102a, a strengthening screen selection operation portion 102b, a story screen selection operation portion 102c, a racing game selection operation portion 102d, and a gacha screen selection operation portion 102e. In the menu bar 102, the operation portion corresponding to the screen being displayed is highlighted so that the screen being displayed on the display 26 can be identified.

When the home screen selection operation portion 102a is tapped, the home screen 100 illustrated in FIG. 3A is displayed on the display 26.

When the strengthening screen selection operation portion 102b is tapped, a strengthening screen (not illustrated) is displayed. On the strengthening screen, it is possible to strengthen the character or the support card possessed by the player. The player can increase the level set for the character or the support card by strengthening the character or the support card. Various parameters are set for the character and the support card, and the parameter increases as the level increases. By increasing the parameters of the character and the support card, the player can nurture the nurtured character to have higher stats in the nurture game.

When the story screen selection operation portion 102c is tapped, a story screen (not illustrated) is displayed. Here, a story image is provided for each character appearing in the game. The player can select and view a character and a story image on the story screen.

When the racing game selection operation portion 102d is tapped, a racing game selection screen (not illustrated) is displayed. In the present embodiment, various racing games are provided in which a nurtured character nurtured in the nurture game which will be described can be caused to participate. On the racing game selection screen, the player can select a racing game in which the nurtured character is entered. An example of a racing game is a team competition game in which a team formed by a plurality of nurtured characters and a team of other players selected by a computer are made to compete with each other. The team competition game has a game property of competing with other players for ranking.

When the gacha screen selection operation portion 102e is tapped, a gacha screen (not illustrated) is displayed. On the gacha screen, the player can play a so-called gacha lottery by spending in-game currency or tickets. With the gacha lottery, a character card or support card can be obtained.

In addition, on the home screen 100, a nurture game operation portion 104 is provided above the menu bar 102. When the nurture game operation portion 104 is tapped, a nurture game screen is displayed, and a nurture game which will be described below is started. The nurture game is roughly divided into a preparation stage and a nurture stage. First, in the preparation stage, the player selects one character from among characters possessed by the player and sets the character as a character to be nurtured (hereinafter referred to as a nurture target character).

Further, in the preparation stage, the player sets a deck to be used when nurturing the nurture target character. The deck is formed of a plurality of inheritance characters, which will be described in detail below, and a plurality of support cards. Thus, in the nurture game, the inheritance characters and the support cards forming the deck are used.

When the settings for the nurture target character and the deck (the inheritance characters and the support cards) are completed, the processing transitions from the preparation stage to the nurture stage, and the game for nurturing the nurture target character is started. In the nurture game, parameters of the nurture target character can be changed. The player can possess the character nurtured in the nurture game as a nurtured character. As described above, the player can form a team of nurtured characters possessed by the player and use the nurtured characters in a team competition game or the like.

As described above, the main purpose of the game according to the present embodiment is to create nurtured characters via the nurture game and to increase the ranking in the team competition game using the nurtured characters.

In addition, in the present embodiment, a function for sharing a nurtured character or a support card among players and a function for sharing information among a plurality of players are provided. The player can set a nurtured character and a support card that can be used by another player in the nurture game. To be specific, as illustrated in FIG. 3A, a setting operation portion 106 is provided in an upper right portion of the home screen 100. When the setting operation portion 106 is tapped, an option setting screen 110 is displayed.

FIG. 3B is a diagram for describing an example of the option setting screen 110. The option setting screen 110 is a screen on which various types of information can be confirmed and set. The option setting screen 110 is provided with a plurality of operation portions, and when an operation portion is tapped, information corresponding to the operation portion can be confirmed and set.

The operation portions of the option setting screen 110 include a profile setting operation portion 110a and a close operation portion 110b. When the close operation portion 110b is tapped, the option setting screen 110 is closed and the home screen 100 is displayed. When the profile setting operation portion 110a is tapped, a profile setting screen 120 is displayed.

FIG. 3C is a diagram for describing an example of the profile setting screen 120. On the profile setting screen 120, the player can confirm and set their own profile information. The profile information includes a profile character, a player name, a player ID, a circle the player belongs to, a representative character, and a rental card.

The profile character functions as a character that is displayed when the player's information is viewed by another player. For example, the profile character is displayed when the player uses a function of a circle being a place for sharing information with other players. On the profile setting screen 120, a profile character image 122 that is currently set is displayed. Near the profile character image 122, a change button 124 is provided. When the change button 124 is tapped, a profile character change screen (not illustrated) is displayed. The player can change the profile character on the profile character change screen.

The profile setting screen 120 displays the player name set by the player, the player ID given to the player, and the name of the circle the player belongs to. The profile setting screen 120 is provided with a representative character setting operation portion 126a and a rental card setting operation portion 126b.

When the representative character setting operation portion 126a is tapped, a representative character setting screen (not illustrated) is displayed. The player can set any one of the nurtured characters nurtured by the player as a representative character on the representative character setting screen. In the representative character setting operation portion 126a, an icon image indicating the currently set representative character is displayed. As will be described in detail below, the representative character can be used for forming a deck as an inheritance character in the nurture game played by another player.

When the rental card setting operation portion 126b is tapped, a rental card setting screen (not illustrated) is displayed. The player can set any one of the support cards possessed by the player as a rental card on the rental card setting screen. In the rental card setting operation portion 126b, an icon image indicating the currently set rental card is displayed. As described above, a support card set as a rental card can be used for forming a deck by another player and is used in the nurture game played by another player.

Although a detailed description is omitted, when the setting of the profile information is changed on the profile setting screen 120, setting change information is transmitted to the server 1000. In the server 1000, profile information is stored for each player.

In addition, in the present embodiment, various limited-time events are held irregularly. A special event icon 108 is displayed on the home screen 100 during the active period of the special event which is a limited-time event. When the special event icon 108 is tapped, a special event screen is displayed. On the special event screen, for example, the player can exchange special event points provided only in the special event with various rewards.

When the nurture game operation portion 104 is tapped on the home screen 100, a nurture game screen is displayed and the nurture game is started. The player can play the nurture game by spending game points. The game points are given to the player at a rate of a predetermined value (for example, +1) every predetermined amount of time (for example, 10 minutes). An upper limit value (for example, 100) is set for the game points that can be possessed by the player, and the player can possess game points within the range of the upper limit value. A game point display bar 136 is provided in an upper portion of the home screen 100, and a ratio of the currently possessed game points to the upper limit value is visually displayed.

The game points are subtracted by a predetermined value (for example, −30) at a time when the nurture game is started. Thus, when the player does not possess the required game points, the player cannot start the nurture game. However, the player can possess an item for recovering game points and can recover game points using the item. For example, this item can be given as a reward in the nurture game or the team competition game or can be obtained by spending in-game currency. Hereinafter, the nurture game will be described in detail.

### Nurture Game

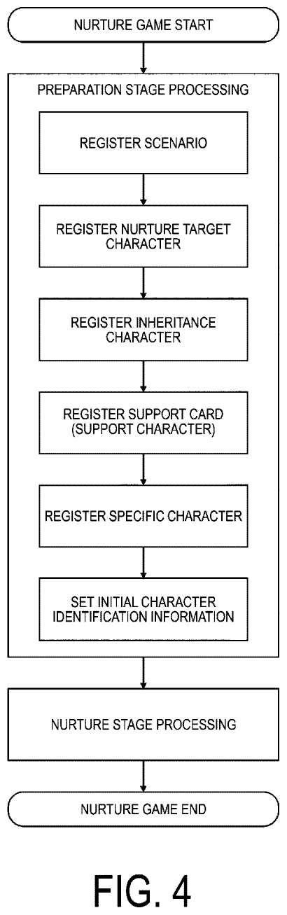

FIG. 4 is a diagram for describing a rough flow of the nurture game. The nurture game is roughly divided into a setting game and a nurture main game. As will be described in detail below, the nurture main game is a game in which one character selected from among the characters possessed by the player is nurtured as a character to be nurtured (hereinafter, also referred to as a nurture target character).

In addition, the setting game is a game in which the player registers the nurture target character and a deck (inheritance characters and support cards), and is corresponding to the preparation stage of the nurture game. Hereinafter, the processing executed in the setting game is referred to as preparation stage processing, and the processing executed in the nurture main game is referred to as nurture stage processing. Here, in order to facilitate understanding, a rough flow of the preparation stage processing and the nurture stage processing will be described first.

As illustrated in FIG. 4, in the preparation stage processing, scenario registration, nurture target character registration, inheritance character registration, support card registration, and specific character registration are performed in this order. Note that the order of the registration and setting processing described above is merely an example. Thus, the order of the registration and setting processing described above can be changed as appropriate.

### Preparation Stage Processing

In the preparation stage processing, registration of a scenario, registration of a nurture target character, registration of a deck (inheritance characters and support cards) are mainly performed. Note that the support cards are for assisting the nurturing of the nurture target character. One character is always associated with each support card, and the character associated with the support card registered in the preparation stage processing assists the nurturing of the nurture target character. Hereinafter, a character associated with a support card is referred to as a support character.

Scenario Registration When the player taps the nurture game operation portion 104 on the home screen 100, a scenario selection screen (not illustrated) is displayed. In the present embodiment, a plurality of scenarios of the nurture main game are provided. In each scenario of the nurture main game, a final goal, a goal for during the game, and the like are set. The player needs to sequentially clear the goal set for each scenario. The goal, a time period until the goal is achieved, the game difficulty, and the like are different for each scenario.

Furthermore, the nurture main game has a story component, and the game progresses following the story. Also, during the nurture main game, events occur at various timings. Events that occur during the nurture main game include events specific to scenarios. Thus, in the plurality of scenarios, at least a portion of the events that occur during the nurture main game are different from each other. The player can select any one of the plurality of scenarios on the scenario selection screen.

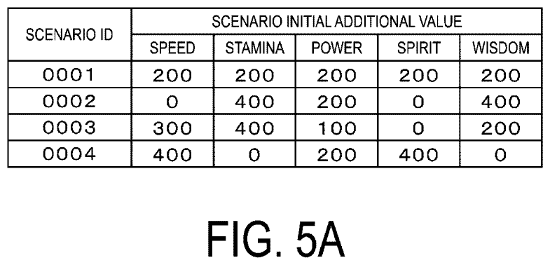

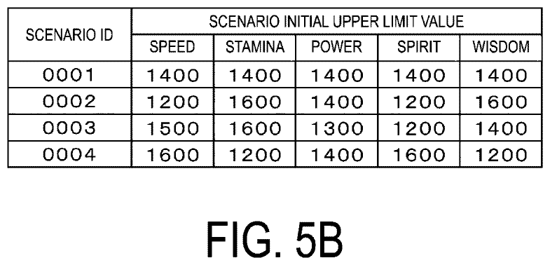

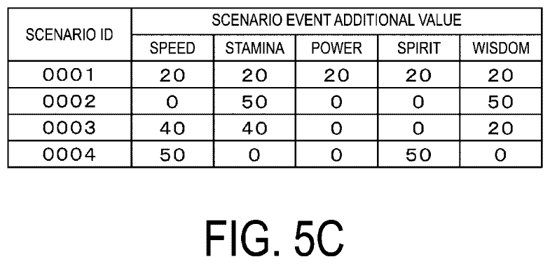

FIG. 5A is a diagram for describing an example of scenario initial additional value data. FIG. 5B is a diagram for describing an example of scenario initial upper limit value data. FIG. 5C is a diagram for describing an example of scenario event additional value data. As illustrated in FIG. 5A, each scenario is associated with a unique scenario ID. When the player selects a scenario on the scenario selection screen, a scenario ID associated with the selected scenario is registered. In this example, four scenario IDs 0001 to 0004 are provided.

As will be described in detail below, the goal of the nurture game includes increasing the ability parameters of a nurture target character. The five ability parameters provided correspond to speed, stamina, power, spirit, and wisdom. Higher values for the five ability parameters means that races will develop more advantageously for the nurture target character.

However, an upper limit value is set for each ability parameter, and in the nurture main game, the value for each ability parameter is updated only within the range of the upper limit value, and updating of the ability parameter exceeding the upper limit value is restricted. At the start of the nurture main game, an initial upper limit value for each ability parameter is set. This initial upper limit value is different for each scenario. The upper limit value for each ability parameter may increase from the initial upper limit value during the game.

The scenario initial additional value data is stored in the player terminal 1 and the server 1000. The scenario initial additional value data is data in which the respective initial additional values of the five ability parameters are associated with the scenario ID. In the present embodiment, at the start of the nurture main game, the initial upper limit value for each ability parameter is set based on the scenario initial additional value data.

Specifically, a common base value is preset for each ability parameter. In the present embodiment, “1200” is set as the common base value. This common base value is common for all scenarios and all ability parameters. However, the common base value may be different for each scenario or may be different for each ability parameter. Then, at the start of the nurture main game, the scenario initial additional value corresponding to the scenario selected by the player is added to the common base value, and the initial upper limit value for each ability parameter is set.

For example, as illustrated in FIG. 5A, according to the scenario initial additional value data, “200” is set as the scenario initial additional values of the five ability parameters associated with the scenario ID “0001”. Thus, when the scenario ID “0001” is selected and the nurture main game is started, the initial upper limit values for the five ability parameters are all “1400”.

Furthermore, for example, when the scenario ID “0002” is selected and the nurture main game is started, the initial upper limit values for the ability parameters of speed and spirit are “1200”, which is the common base value, the initial upper limit values for the ability parameters of stamina and the wisdom are “1600”, and the initial upper limit value of the ability parameter of power is “1400”.

Here, the initial upper limit value is derived by adding the initial additional value of the ability parameter to the common base value. However, as illustrated in FIG. 5B, scenario initial upper limit value data may be provided, and the initial upper limit value for each ability parameter may be derived based on the scenario initial upper limit value data. According to the scenario initial upper limit value data, the initial upper limit value for each of the five ability parameters is associated with the scenario ID. In the scenario initial upper limit value data, the value of the initial upper limit value associated with each scenario ID is a value obtained by adding the initial additional value of the scenario initial additional value data to the common base value.

As described above, the scenario initial upper limit value associated with the scenario ID may be set as the initial upper limit value for each ability parameter. Alternatively, a value obtained by adding the scenario initial additional value to the common base value may be set as the initial upper limit value for each ability parameter.

In the nurture main game, a scenario event in which the upper limit value for each ability parameter increases may occur at a predetermined timing. When a scenario event occurs, the scenario event additional value associated with the scenario event is added to the upper limit value at that point in time. For example, when a predetermined scenario event occurs in the nurture main game having the scenario ID of “0001”, the upper limit values of the five ability parameters increase by “20”.

As illustrated in FIG. 5C, the upper limit value of the ability parameter to be increased by the scenario event differs for each scenario. Note that a plurality of scenario events in which the upper limit values of the ability parameters are increased may be provided for one scenario or may not be provided for a scenario. In addition, the occurrence timing of the scenario event may be common for all scenarios or may be different.

As described above, the upper limit values for the ability parameters vary depending on the scenario selected by the player. As a result, it is possible to nurture characters having different abilities and characteristics for each scenario. Thus, the player's motivation to play in various scenarios is improved.

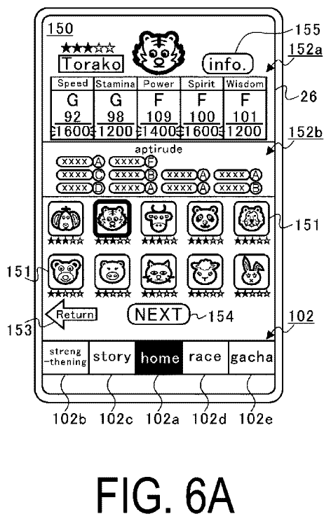

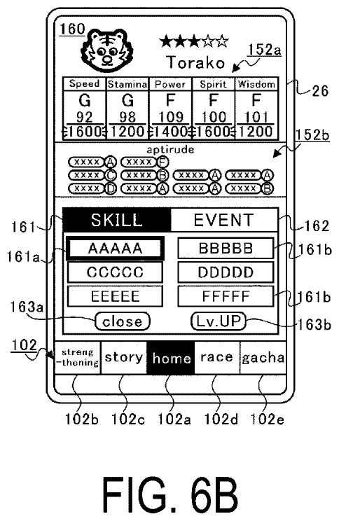

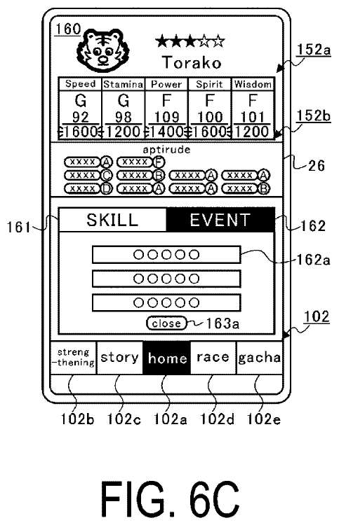

Registration of Nurture Target Character FIG. 6A is a diagram for describing a nurture target character selection screen 150. When the player selects a scenario on the scenario selection screen, the nurture target character selection screen 150 illustrated in FIG. 6A is displayed. At a central portion of the nurture target character selection screen 150, a plurality of character icons 151 are displayed and a list of characters possessed by the player is displayed.

In addition, an ability parameter display portion 152a and an aptitude parameter display portion 152b are displayed in an upper portion of the nurture target character selection screen 150. In addition, a return operation portion 153 and a next operation portion 154 are displayed in a lower portion of the nurture target character selection screen 150.

In the present embodiment, the initial values for the ability parameters are set for each character. The initial values for the ability parameters of the character corresponding to a character icon 151 selected by the player are displayed as a value in an ability parameter display portion 152a. In the present embodiment, the larger the numerical value of the ability parameter is, the higher the ability is.

The initial upper limit value for each ability parameter is displayed in the ability parameter display portion 152a. In other words, the upper limit value for each ability parameter set at the start of the nurture main game is displayed in the ability parameter display portion 152a in a state where the player can select a scenario or after the player has selected a scenario. In the ability parameter display portion 152a, the initial upper limit value corresponding to the scenario selected by the player is displayed as the denominator, and the initial value of the ability parameter of the character selected by the player is displayed in the numerator.

Here, in the ability parameter display portion 152a, the initial upper limit value exceeding the common base value are identifiably displayed. For example, in the example illustrated in FIG. 6A, the initial upper limit values of speed, power, and spirit exceed “1200”, which is the common base value. Thus, in the ability parameter display portion 152a, the initial upper limit values of speed, power, and spirit are identifiably displayed with respect to the initial upper limit values of stamina and wisdom. Here, as the identification display, the initial upper limit value exceeding the common base value is displayed blinking or in a different color.

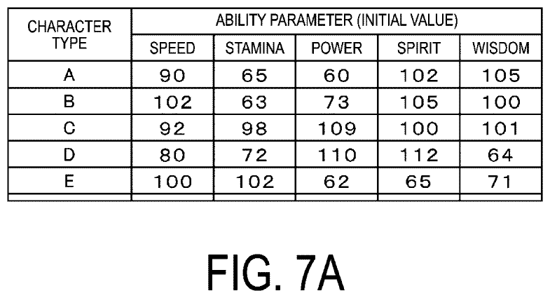

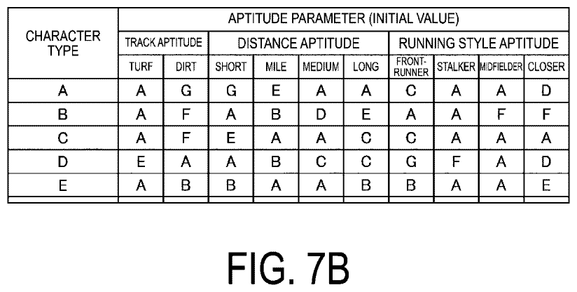

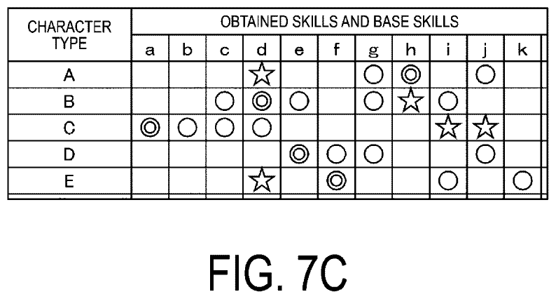

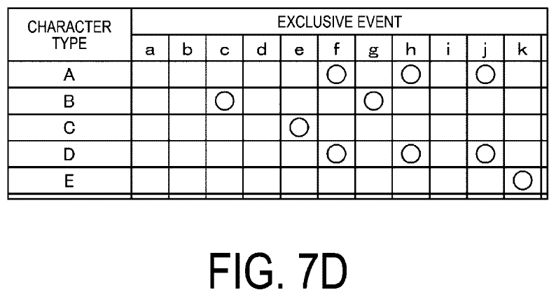

FIG. 7A is a diagram for describing an ability parameter (initial value) table. In the present embodiment, as illustrated in FIG. 7A, initial values of ability parameters for each character are stored in the ability parameter (initial value) table. Then, based on the initial values of the ability parameters stored in the ability parameter (initial value) table, the initial values of the ability parameters are displayed in the ability parameter display portion 152a.

In the present embodiment, an initial value of an ability parameter is set for each one of a plurality of types of abilities for each character. To be more specific, a speed ability parameter denoted by “Speed” in the ability parameter display portion 152a, a stamina ability parameter denoted by “Stamina” in the ability parameter display portion 152a, a power ability parameter denoted by “Power” in the ability parameter display portion 152a, a spirit ability parameter denoted by “Spirit” in the ability parameter display portion 152a, and a wisdom ability parameter denoted by “Wisdom” in the ability parameter display portion 152a are provided as the ability parameters.

Note that the initial values for the ability parameters of each character are increased by strengthening the character (character card). For example, each character is provided with stat levels of five stages, and the player can increase the stat level of the character by spending in-game currency and predetermined items. As the stat level of the character increases, the initial value of the ability parameter of the character increases.

The initial values when the character is at a predetermined level are illustrated in FIG. 7A. Note that the player can increase the value of the ability parameters in the nurture main game. That is, the goal of the nurture main game is to nurture a character to have higher numerical values for the ability parameters.

In the present embodiment, an aptitude parameter (initial value) is set for each character. As illustrated in FIG. 6A, the initial values of the aptitude parameters of the character corresponding to the character icon 151 selected by the player are displayed with an alphabetical letter in the aptitude parameter display portion 152b.

FIG. 7B is a diagram for describing an aptitude parameter (initial value) table. In the present embodiment, as illustrated in FIG. 7B, the initial values of the aptitude parameters for each character are stored in the aptitude parameter (initial value) table. The initial values of the aptitude parameters are set to any one of seven levels of alphabetical letters A to G. For the initial values of the aptitude parameters, A indicates the highest aptitude and G indicates the lowest aptitude. Based on the initial values of the aptitude parameters stored in the aptitude parameter (initial value) table, the initial values of the aptitude parameters are displayed in the aptitude parameter display portion 152b.

In the present embodiment, an initial value of the aptitude parameter is set for each one of a plurality of types of aptitude for each character. Specifically, the aptitude parameters include aptitude parameters related to track aptitude for turf and dirt; aptitude parameters related to distance aptitude for short distance, mile, medium distance, and long distance; and aptitude parameters related to running style aptitude for front-runner, stalker, midfielder, and closer.

In the nurture game, the player can enter the nurture target character in various races. At this time, if the aptitude of the nurture target character that matches the race content is high, the nurture target character will be more advantageous in the developments of the race.

The initial values of the aptitude parameters for each character may be increased by spending in-game currency. Further, the values of the aptitude parameters may change in the nurture main game. Further, in the nurture main game, the aptitude parameter may be set to S, which is a higher aptitude than A.

FIG. 6B is a first diagram for describing a character detail screen 160. FIG. 6C is a second diagram for describing the character detail screen 160. When tapping and holding the character icon 151 on the nurture target character selection screen 150, the character detail screen 160 is displayed on the display 26. On the character detail screen 160, the details of the abilities of the character corresponding to the character icon 151 which was tapped and held on the nurture target character selection screen 150 are displayed.

A skill operation portion 161 and an event operation portion 162 are displayed at a central portion of the character detail screen 160. As illustrated in FIG. 6B, when the character detail screen 160 is first displayed, the skill operation portion 161 is highlighted, and the skills provided for each character are displayed. A skill is an ability that may be activated when a predetermined condition is satisfied while a race or a team race is being executed as will be described below. Activating skills gives each character an advantage in the developments of the race.

FIG. 7C is a diagram for describing skills. As illustrated in FIG. 7C, each character possesses a plurality of skills. As illustrated in FIG. 6B, the skills possessed by the character (hereinafter referred to as base skills) are displayed on the character detail screen 160. In the nurture main game, the base skills of the nurture target character can be obtained when a predetermined condition is satisfied. Note that a skill is not activated just by being in possession of it during a race and first becomes possible to be activated by the base skill being obtained. Hereinafter, a skill in a state of being able to be activated by the character, that is, a skill obtained by the character, is referred to as an obtained skill.

One obtained skill is set for the character from the beginning of the nurture main game. In addition to the obtained skill, a plurality of base skills are set for the character. A base skill can be obtained by spending skill points which will described below after the start of the nurture main game. That is, a base skill can become an obtained skill in exchange for skill points.

In the present embodiment, a skill indicated by “⊚” in FIG. 7C is displayed as an obtained skill on the character detail screen 160 in FIG. 6B. Also, a skill indicated by “◯” in FIG. 7C is displayed as a base skill on the character detail screen 160 in FIG. 6B. In the present embodiment, as illustrated in the character detail screen 160 in FIG. 6B, the obtained skill is highlighted so that the obtained skill and the base skill can be easily distinguished from each other.

Specifically, on the character detail screen 160 illustrated in FIG. 6B, one obtained skill is displayed in an obtained skill display field 161a and seven base skills are displayed in a base skill display field 161b. Note that the number of obtained skills and base skills may be different for each character. Further, for example, the number of obtained skills or base skills for each character may be increased by an increase in the level of the character, spending of in-game currency or items, and the like.

Here, base skills includes awakening skills. The awakening skill is a skill associated with a character as a base skill from the start of the nurture game when an unlock condition is satisfied. That is, an awakening skill with an unsatisfied unlock condition is not a base skill at the start of the nurture game. However, an awakening skill with an unsatisfied unlock condition may become a base skill during the nurture main game.

In FIG. 7C, an awakening skill is indicated by a star symbol. Here, four awakening skills are set for each character. However, the number of awakening skills may be different for each character. Note that the awakening skills differ for each character. In addition, for example, skill d in the diagram is set as an awakening skill for character A, set as an obtained skill for character B, and set as a normal base skill for character C. As described above, skills includes skills set differently, such as an obtained skill, a base skill, and an awakening skill, depending on the character.

In the present embodiment, the awakening level of the character is set as the condition for unlocking the awakening skill. The characters (character cards) are associated with the stat levels described above and the awakening level. The player can individually increase the stat levels and the awakening level. As illustrated in FIG. 6B, a close operation portion 163a and a strengthening operation portion 163b are provided on the character detail screen 160. When the strengthening operation portion 163b is tapped, a character strengthening screen 165 is displayed on the display 26.

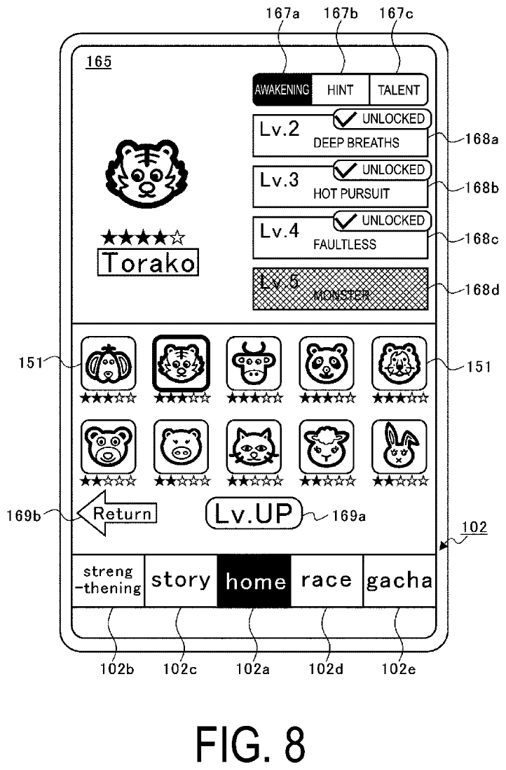

FIG. 8 is a diagram for describing the character strengthening screen 165. The character strengthening screen 165 is displayed when the strengthening operation portion 163b of the character detail screen 160 is tapped and when the strengthening screen selection operation portion 102b is tapped. The character icon 151 corresponding to a possessed character is displayed from the center to the lower side of the character strengthening screen 165. When the character icon 151 is tapped by the player, the character corresponding to the tapped character icon 151 is put in a selected state.

When the strengthening operation portion 163b of the character detail screen 160 is tapped and the character strengthening screen 165 is displayed, the character that is in the selected state on the character detail screen 160 is also put in the selected state when the display of the character strengthening screen 165 is started. In the upper portion of the character strengthening screen 165, information related to the character in the selected state is displayed.

Specifically, the character strengthening screen 165 is provided with an awakened tab 167a, a hint tab 167b, and a stats tab 167c. When the awakened tab 167a is tapped, the awakening skill display fields 168a, 168b, 168c, and 168d are displayed. At the start of display of the character strengthening screen 165, the awakened tab 167a is in a selected state, and the awakening skill display fields 168a, 168b, 168c, and 168d are displayed. The names of the awakening skills corresponding to the awakening levels are listed in the awakening skill display fields 168a, 168b, 168c, and 168d.

Below the character strengthening screen 165, an awakening level up button 169a is provided. When the awakening level up button 169a is tapped, a confirmation screen (not illustrated) is displayed. The confirmation screen displays the item necessary for increasing the awakening level and that the awakening level will increase by consuming the item. Then, when a predetermined operation is input on the confirmation screen, the awakening level of the character in the selected state increases.

In the present embodiment, the awakening level is set to level 1 in the initial state of each character. The player can increase the awakening level of the character up to level 5 by consuming items. One awakening skill is associated with each awakening level. By increasing the awakening level, the awakening skill corresponding to the increased awakening level is unlocked. Specifically, when the awakening level becomes level 2, the awakening skill corresponding to level 2 is unlocked. Similarly, when the awakening level becomes level 5, the awakening skill corresponding to level 5 is unlocked.

As described above, each character is set with four awakening skills. Then, by increasing the awakening level, the player can unlock the same number of awakening skills as the number of increases in the awakening level. The awakening skills function as an obtained base skill when unlocked.

In the awakening skill display fields 168a, 168b, 168c, and 168d, the awakening skills unlocked at awakening levels 2, 3, 4, and 5 are displayed, respectively. At this time, “unlocked” is written in the awakening skill display fields 168a, 168b, 168c, and 168d for the awakening skills that have been unlocked. On the other hand, for the locked awakening skills, the awakening skill display fields 168a, 168b, 168c, and 168d are grayed out. FIG. 8 illustrates a state in which the awakening level is level 4 and three awakening skills are unlocked.

Although detailed description is omitted, when the awakening skill display fields 168a, 168b, 168c, and 168d are long-pressed, detailed information such as the content of each awakened skill is displayed. When the hint tab 167b is tapped, a hint level strengthening screen (not illustrated) is displayed. On the hint level strengthening screen, it is possible to increase the hint level of a base skill, which will be described later, by consuming an item.

Also, when the stats tab 167c is tapped, a stat level strengthening screen (not illustrated) is displayed. On the stat level strengthening screen, it is possible to increase the stat level of the character by consuming an item. The character strengthening screen 165 is provided with a return operation portion 169b. When the return operation portion 169b is tapped, the character strengthening screen 165 is closed and the character detail screen 160 is displayed.

When the player taps the event operation portion 162 of the character detail screen 160, the content of the character detail screen 160 is switched as illustrated in FIG. 6C, and an exclusive event display field 162a indicating an exclusive event provided for each character is displayed. An exclusive event occurs when a predetermined condition is satisfied in the nurture main game. When an exclusive event occurs, a story image relating to the character appearing in the nurture game may be displayed, the values of the ability parameters may change, and the like.

FIG. 7D is a diagram for describing an exclusive event. As illustrated in FIG. 7D, each character is associated with a plurality of exclusive events. As illustrated in FIG. 6C, the exclusive events associated with the characters are displayed on the character detail screen 160. Note that the exclusive event includes a hint event that enables a character to possess or obtain a skill, an ability event that increases or decreases the numerical value of an ability parameter of the character, and the like.

Also, the exclusive event displayed in the character detail screen 160 illustrated in FIG. 6C may be entirely executed during the nurture main game, may be at least partially executed during the nurture main game, or need not be entirely executed during the nurture main game when a predetermined condition is not satisfied. Also, for example, the number of exclusive events provided for each character may increase due to an increase in the level of the character, spending of in-game currency or items, and the like. In addition, when a predetermined condition is satisfied, an exclusive event that is not displayed as an exclusive event may be executed during the nurture main game.

As illustrated in FIGS. 6B and 6C, the close operation portion 163a is displayed at the lower portion of the character detail screen 160. When the close operation portion 163a of the character detail screen 160 is tapped, the display of the character detail screen 160 is terminated, and the nurture target character selection screen 150 is displayed on the display 26.

When the return operation portion 153 is tapped on the nurture target character selection screen 150 illustrated in FIG. 6A, the home screen 100 illustrated in FIG. 3A is displayed on the display 26. The nurture target character selection screen 150 is provided with a nurture information display button 155. When the nurture information display button 155 is tapped, a nurture information display screen (not illustrated) is displayed. The player can confirm the information related to the character selected on the nurture target character selection screen 150 on the nurture information display screen.

The goal of the nurture game is to produce a stronger nurtured character by nurturing a character selected as the nurture target character, which is the nurture target, from among characters possessed by the player. As will be described in detail below, the nurture main game includes a plurality of turns, and the player needs to make the nurture target character train or participate in a race for each turn.

A plurality of clear goals are set for each character. On the nurture information display screen, a clear goal set for the selected character can be checked. A race in which the nurture target character can be entered is predetermined for each turn. The clear goal includes entering the nurture target character in a predetermined race at a predetermined turn and the nurture target character getting a predetermined place.

Further, when the nurture target character, which is the nurture target, is entered in a race, the nurture target character can obtain fans. In each race, the base obtaining number of fans are determined for each placing, and the higher the placing, the larger the number of obtained fans. In addition, a difficulty is set for each race, and in a race with a higher difficulty, more fans can be obtained.

Here, the number of fans that can be obtained by running in the race is calculated by adding a bonus obtaining number to the base obtaining number determined for each placing. Specifically, a correction value is determined based on the race result, and the bonus obtaining number is calculated by multiplying the base obtaining number by the correction value. The total number of the bonus obtaining number and the base obtaining number is the number of fans obtained by the nurture target character. For example, when the race result is first place, the correction value increases as the difference between the nurture target character and the second place character increases. In addition, when the race result is from second to fifth place, the correction value increases as the difference between the nurture target character and the first character decreases.

The nurture target character activates a skill (obtained skill) at a predetermined probability during the race. At this time, as the number of activated skills increases, the correction value increases. As described above, in each race, the condition for adding the number of fans is determined, and the number of fans to be obtained increases depending on various race results other than the placing and the progress of the race. However, the number of fans obtained by the nurture target character is at least equal to or greater than the base obtaining number corresponding to the placing.

In some races, the number of fans is set as a race entry condition. When the number of fans obtained by the nurture target character is less than the number of fans set as the race entry condition, the player cannot enter the nurture target character in the race. The higher the difficulty of a race, the greater the number of fans required to enter in the race. Thus, in a case where a race with the number of fans set as the race entry condition is set as a race that is a target of a clear goal (hereinafter referred to as a target race), the nurture target character needs to obtain the number of fans set for the target race by the turn in which the target race is run.

The clear goal includes obtaining a predetermined number or more of fans by a predetermined turn. In addition, the clear goal includes, for example, placing first in a race of a high difficulty (for example, GI) a predetermined number of times or more within a predetermined turn range. In this way, a plurality of clear goals are set for each character. By achieving a clear goal, the player can continue the nurture main game until the final turn. On the other hand, when the clear goal cannot be achieved, the nurture main game ends in this turn.

Thus, if the number of fans set for the target race is not obtained by the turn in which the target race is run, the nurture target character cannot enter in the target race. In this case, the clear goal is not achieved, and the nurture game ends.

In the nurture main game, since various parameters of the nurture target character increase each turn, a stronger nurtured character can be created as the turn number increases. Thus, in playing the nurture main game, it is necessary to increase the parameters of the nurture target character so that all of the clear goals can be cleared.

Basically, the clear goals set for each character are fixed, and the same clear goals are set as tasks every time the nurture game is played. However, a clear goal that changes according to the progress status of the nurture main game may be set, or a character that allows the player to select a clear goal may be included.

When the nurture game is completed, a nurtured character is created. Evaluation scores are derived for the nurtured character when the nurture game ends, and a nurture rank is derived based on the evaluation scores. The evaluation scores are calculated, based on a preset calculation formula such as a score calculated using various parameters of the nurture target character at the time of nurture completion, a score calculated using the obtained skills, or the like. The nurture information display screen displays information indicating the rank, the evaluation scores, the name, and the registration date of the top three nurtured characters having highest evaluation scores among the nurtured characters nurtured based on the selected character.

Although a detailed description is omitted, a plurality of scenarios are provided in the nurture game. The basic game specifications are common to each scenario, but some functions are different for each scenario. On the nurture information display screen, a scenario selected when each nurtured character is nurtured is displayed.

As described above, the player can select a nurture target character while checking various information of each character on the nurture target character selection screen 150 illustrated in FIG. 6A. When the next operation portion 154 is tapped on the nurture target character selection screen 150, the selected character is set as the nurture target character, and an inheritance character selection screen 170 is displayed on the display 26.

### Registration of Inheritance Character

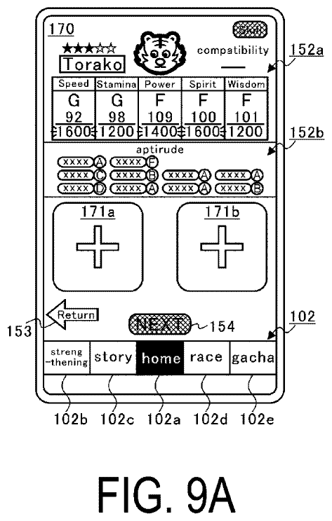

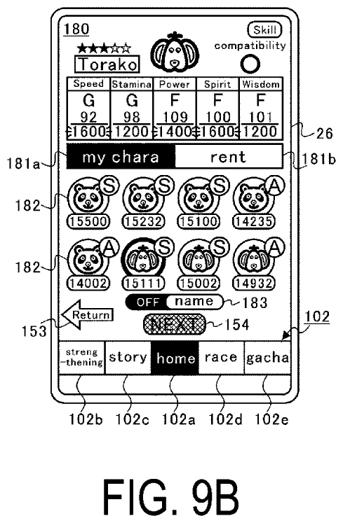

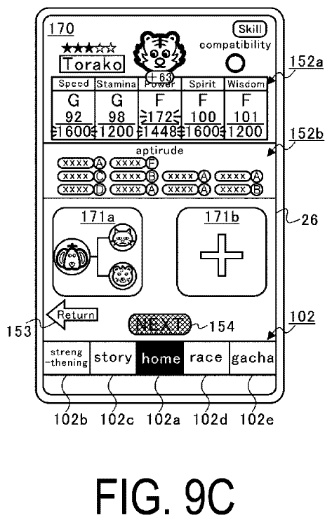

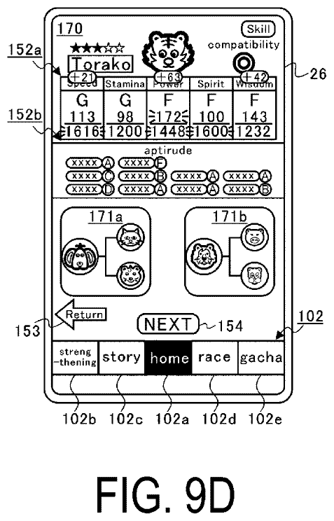

FIG. 9A is a first diagram for describing the inheritance character selection screen 170. FIG. 9B is a first diagram for describing a nurtured character list screen 180. FIG. 9C is a second diagram for describing the inheritance character selection screen 170. FIG. 9D is a third diagram for describing the inheritance character selection screen 170. The inheritance character selection screen 170 is a screen for the player to register an inheritance character.

An inheritance character is a character that causes the nurture target character to inherit an ability value, a skill, or the like. The player can select two inheritance characters from the nurtured characters possessed by the player and representative characters of other players extracted in accordance with a predetermined extraction condition, such as the representative characters of friends such as followers, and use the representative characters to form a deck and register the representative characters. Note that only one representative character of another player can be used as an inheritance character to form a deck in one nurture game.

The inheritance character selection screen 170 is provided with the ability parameter display portion 152a, the aptitude parameter display portion 152b, a first inheritance character selection region 171a, and a second inheritance character selection region 171b. When the screen transitions from the nurture target character selection screen 150 to the inheritance character selection screen 170, the first inheritance character selection region 171a and the second inheritance character selection region 171b are displayed as blank fields as illustrated in FIG. 9A.

When the first inheritance character selection region 171a or the second inheritance character selection region 171b is tapped, the nurtured character list screen 180 illustrated in FIG. 9B is displayed. The nurtured character list screen 180 is provided with a my character tab 181a and a rental tab 181b. Below the my character tab 181a and the rental tab 181b, a nurtured character list display region is provided. A nurtured character icon 182 is displayed in the nurtured character list display region.

In a state where the my character tab 181a is selected, the nurtured character icons 182 corresponding to the nurtured characters possessed by the player are displayed as illustrated in FIG. 9B. Although not illustrated, in a state where the rental tab 181b is selected, the representative character of a friend, that is, the nurtured character icon 182 corresponding to the nurtured character nurtured by a friend is displayed.

Further, when the nurtured character icon 182 is tapped, the nurtured character corresponding to the nurtured character icon 182 is put in a provisionally selected state. When the nurtured character icon 182 is tapped, the inheritance character selection screen 170 is displayed as illustrated in FIG. 9C. At this time, for example, when the first inheritance character selection region 171a is tapped to display the nurtured character list screen 180 and the nurtured character icon 182 is tapped on the nurtured character list screen 180, an image indicating the nurtured character in the provisionally selected state is displayed in the first inheritance character selection region 171a.

In this state, for example, when the second inheritance character selection region 171b is tapped to display the nurtured character list screen 180 and the nurtured character icon 182 is tapped on the nurtured character list screen 180, an image indicating the nurtured character in the provisionally selected state is displayed in the second inheritance character selection region 171b as illustrated in FIG. 9D.

In addition, the nurtured character is stored in association with information related to the inheritance character used in the nurturing. In the first inheritance character selection region 171a, information related to the inheritance character used when nurturing the nurtured character is displayed.

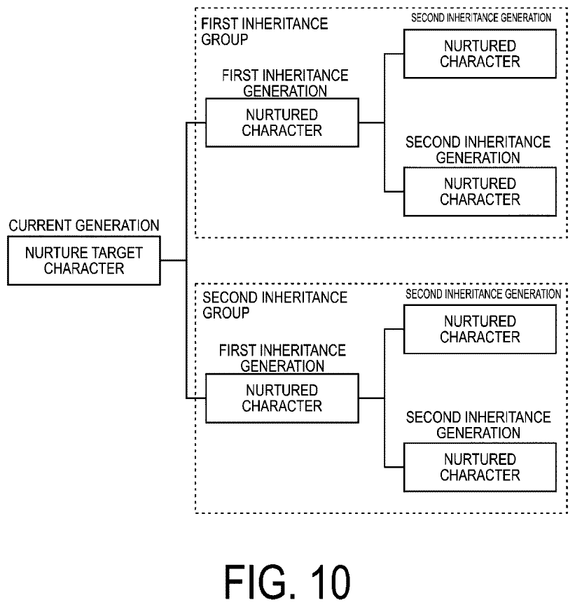

FIG. 10 is a diagram for describing an inheritance system. In the nurture game, various effects such as an increase in the values of an ability parameter and an aptitude parameter of the nurture target character are achieved based on the factor information of the inheritance character. Here, two inheritance characters are set for one nurture target character, and these inheritance characters are the previously produced nurtured characters. Thus, when a nurtured character set as an inheritance character is produced, two inheritance characters are set for the nurtured character.

As illustrated in FIG. 10, the nurture target character, which is the nurture target, of the nurture main game to be started is set to the current generation. Further, two nurtured characters set as inheritance characters for the nurture target character are set as first inheritance generation. Further, two nurtured characters are set as inheritance characters at the start of the nurturing of the first inheritance generation nurtured character. The two nurtured characters set as inheritance characters when the nurtured character of the first inheritance generation is produced are set as second inheritance generation.

In this case, as illustrated in FIG. 10, the nurtured characters of the first inheritance generation and the second inheritance generation have an effect on the nurture target character of the current generation. As described above, since two inheritance characters (first inheritance generation) are set for one nurture target character, a total of six nurtured characters have an effect on one nurture target character.

For example, one of the two first inheritance generation nurtured characters and the two second inheritance generation nurtured characters that are inheritance characters of this nurtured character form a first inheritance group. In a similar manner, the other of the two first inheritance generation nurtured characters and the two second inheritance generation nurtured characters that are inheritance characters of this nurtured character form a second inheritance group.

As illustrated in FIG. 9D, in the first inheritance character selection region 171a, icons corresponding to one first inheritance generation nurtured character and two second inheritance generation nurtured characters forming the first inheritance group are displayed. In a similar manner, in the second inheritance character selection region 171b, icons corresponding to one first inheritance generation nurtured character and two second inheritance generation nurtured characters forming the second inheritance group are displayed.

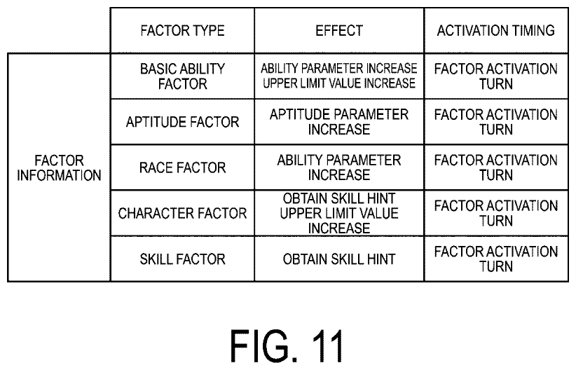

FIG. 11 is a diagram for describing factor information. As will be described in detail below, when the nurture game is completed, the nurture target character is registered as a nurtured character, and at this time, factor information is stored in association with the nurtured character. Specifically, when the nurturing of the nurtured character is completed, a factor to be obtained by the nurtured character is determined through a lottery or the like. Then, factor information indicating the determined factor is associated with the nurtured character. In other words, at the completion of the nurture game, the nurtured character can obtain the factor gained through the lottery.

However, the factor obtained by the nurtured character does not affect the abilities of the nurtured character themselves. For example, the nurtured character can be entered in a racing game such as a team competition game. At this time, in the race, a simulation, that is, computational processing of determining the placing and the race developments is performed based on the ability parameters, the aptitude parameters, the obtained skills, and the like of all the nurtured characters running. Since the factor of the nurtured character is not used in the computational processing, even if the nurtured character has a large number of factors, the nurtured character is not given an advantage in the race.

When the nurtured character is set as the inheritance character, the factor of the nurtured character affects only the nurture target character. Factors that can be obtained by the nurtured character are classified into a plurality of types. FIG. 11 illustrates a basic ability factor, an aptitude factor, a race factor, a character factor, and a skill factor as factor types. Each factor is set to one of a plurality of levels. Here, three factor levels, level 1, level 2, and level 3, are provided as factor levels.

The factor level is determined through a lottery. At this time, after the factors to be obtained by the nurtured character are determined, the factor level may be determined through the lottery for each of the obtained factors. Alternatively, a success ratio may be set for each combination pattern of a factor and a factor level, and any combination pattern may be determined based on the set success ratio. In this case, the factor to be obtained and the factor level are determined at the same time.

For factor levels, level 3 has the largest effect and level 1 has the least effect. In the lottery for determining the factor level, the success probability of level 3 is set to be the lowest and the success probability of level 1 is set to be the highest. However, the success probability of the factor to be obtained or the success probability of the factor level may be changed depending on the result of the nurture game. In this case, for example, a higher factor level may be determined for a nurtured character that has a higher ability parameter or evaluation score.

The basic ability factor increases the values for the ability parameters of the nurture target character and the upper limit values of the ability parameters. Five basic ability factors are provided including a speed factor, a stamina factor, a power factor, a spirit factor, and a wisdom factor. The nurtured character always obtains one basic ability factor from among the five basic ability factors. The five basic ability factors correspond to the five ability parameters for speed, stamina, power, spirit, and wisdom. For example, when the nurtured character of the first inheritance generation or the second inheritance generation has a speed factor, the value of the ability parameter and the upper limit value for speed of the nurture target character increases.

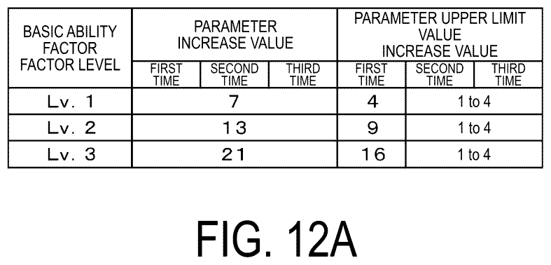

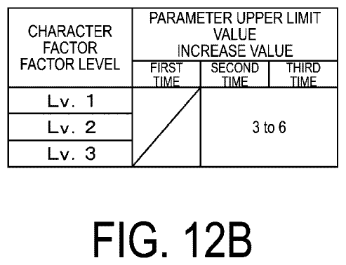

FIG. 12A is a diagram for describing the effects of basic ability factors. The increase value for each ability parameter and the increase value of the upper limit value vary depending on the factor level of the basic ability factor. For example, when the factor level of the speed factor is level 1, the ability parameter for speed for the nurture target character increases by “7”; when the factor level is level 2, the ability parameter increases by “13”; and when the factor level is level 3, the ability parameter increases by “21”.

Thus, if a total of six nurtured characters including two first inheritance generation characters and four second inheritance generation characters all have a speed factor of level 3, the ability parameter for speed for the nurture target character increases by a maximum of 126 (increase value 21×6).

However, an activation timing and an activation condition are set for each factor. Thus, even if the inheritance character has a factor, if the activation condition is not satisfied at the activation timing, there is no effect on the nurture target character.

As described above, the nurture main game is composed of a plurality of turns, and of these, a predetermined turn is set as a factor activation turn. For example, three turns, namely the first turn, the 31st turn, and the 55th turn of the nurture main game are set as factor activation turns. In this case, the first turn is the first activation timing, the 31st turn is the second activation timing, and the 55th turn is the third activation timing. In each factor activation turn, whether to activate is determined for each factor (inheritance character), and in a case where it is determined to activate the factor, the activation condition of the factor is satisfied, and the effect corresponding to the factor is achieved.

Whether to activate the basic ability factor is determined through a lottery. At this time, the probability of success in the lottery as to whether to activate the basic ability factor, that is, the probability of activating the basic ability factor (hereinafter referred to as the activation probability) may be different in the three factor activation turns. Here, in the first turn, the activation probability of the basic ability factor is set to 100% regardless of the factor level. Also, in the 31st turn and the 55th turn, the activation probability of the basic ability factor varies depending on the factor level. For example, in the 31th turn and the 55th turn, the activation probability of a level 3 basic ability factor is set to 100%, the activation probability of a level 2 basic ability factor is set to 90%, and the activation probability of level 1 basic ability factor is set to 80%.

On the inheritance character selection screen 170, an increase value that increases the ability parameter in the first turn is displayed. For example, in FIG. 9C, one inheritance character in the first inheritance group is provisionally selected. In this case, the type of the ability parameter to be increased in the first turn and the increase value thereof are displayed for the one inheritance character being provisionally selected. Here, “+63” is displayed above the power ability parameter, which indicates that the power ability parameter increases by 63 points in the first turn. Further, in the ability parameter display portion 152a, the value to which the increase value increased in the first turn is added is displayed.

Further, in FIG. 9D, two inheritance characters in the first inheritance group and the second inheritance group are provisionally selected. In this case, the type of the ability parameter to be increased in the first turn and the increase value thereof are displayed for the two inheritance character being provisionally selected. Here, “+21”, “+63”, and “+42” are displayed above the ability parameters for speed, power, and wisdom, respectively, which indicate that the ability parameters for speed, power, and wisdom increase by 21 points, 63 points, and 42 points, respectively, in the first turn.

In the inheritance character selection screen 170, the increase value of the ability parameter to be increased by the inheritance character in the first inheritance group and the increase value of the ability parameter to be increased by the inheritance character in the second inheritance group are displayed in a distinguishable manner. For example, in FIG. 9D, the “+63” displayed above the power ability parameter and the “+21” and “+42” displayed above the speed and wisdom ability parameters are displayed in different colors.

When the basic ability factor is activated, the upper limit value of the corresponding ability parameter increases. At this time, the increase value of the upper limit value of the ability parameter varies depending on the factor level of the basic ability factor. In addition, the increase value of the upper limit value of the ability parameter varies depending on the activation timing. For example, when the factor level of the speed factor is level 1, the upper limit value of the ability parameter of speed for the nurture target character increases by “4” at the first activation timing, and the upper limit value of the ability parameter of speed increases by a number in the range of “1” to “4” at the second and third activation timings.

Also, when the factor level of the speed factor is level 2, the upper limit value of the ability parameter of speed for the nurture target character increases by “9” at the first activation timing, and the upper limit value of the ability parameter of speed increases by a number in the range of “1” to “4” at the second and third activation timings. Also, when the factor level of the speed factor is level 3, the upper limit value of the ability parameter of speed for the nurture target character increases by “16” at the first activation timing, and the upper limit value of the ability parameter of speed increases by a number in the range of “1” to “4” at the second and third activation timings.

Here, at the first activation timing, the upper limit value of the ability parameter is always increased by the increase value corresponding to the factor level. On the other hand, at the second and third activation timings, a lottery for determining whether to activate is performed. When it is determined to activate, a lottery for determining the increase value of the upper limit value is performed. In this case, the higher the factor level is, the higher the probability may be set for determining activation. Further, the increase value of the upper limit value may be set to increase as the factor level increases.

In addition, whether to activate the basic ability factor may be determined on a factor basis or may be separately determined for each effect. For example, in a case where whether to activate one basic ability factor is determined on a factor basis, it is assumed that activating the basic ability factor has been determined. In this case, according to the factor level, the value of the corresponding ability parameter increases and the upper limit value of the same ability parameter increases.

On the other hand, in a case where whether to activate one basic ability factor is determined for each effect, the determination of whether to increase the value of the ability parameter and the determination of whether to increase the upper limit value are made through separate lotteries. Thus, in this case, for example, only one of the value of the ability parameter and the upper limit value of the ability parameter may be increased. In any case, in the present embodiment, the basic ability factor is always activated at the first activation timing. Thus, with the start of the nurture main game, the value of the ability parameter and the upper limit value increase in accordance with the factor level.

As illustrated in FIGS. 9C and 9D, the initial upper limit value of the ability parameter displayed in the ability parameter display portion 152a of the inheritance character selection screen 170 is updated to a value obtained by adding the additional value of the upper limit value increased by the basic ability factor. In this manner, by displaying the initial upper limit value in which the scenario initial additional value and the additional value from the basic ability factor are taken into account, the user-friendliness in selecting the inheritance character is improved.

The aptitude factor illustrated in FIG. 11 increases the aptitude parameter of the nurture target character. The aptitude factors include six factors: a turf factor, a dirt factor, a short distance factor, a mile factor, a medium distance factor, and a long distance factor. The nurtured character always obtains one aptitude factor from among the six aptitude factors. The six aptitude factors correspond to turf aptitude, dirt aptitude, short distance aptitude, mile aptitude, medium distance aptitude, and long distance aptitude. For example, when the nurtured character of the first inheritance generation or the second inheritance generation includes a nurtured character having a turf factor, the aptitude parameter for the turf aptitude of the nurture target character increases.

The activation timing and the activation condition are also set for the aptitude factor, and whether to activate is determined for each aptitude factor in the same factor activation turn as that of the basic ability factor. If activation of the aptitude factor is determined, the corresponding aptitude parameter is increased by one level. In this example, in the first turn, the activation probability of the aptitude factor is set to 100% regardless of the factor level.

For example, the aptitude factors of three nurtured characters belonging to the first inheritance group are the turf factor, the short distance factor, and the mile factor; and the aptitude factors of three nurtured characters belonging to the second inheritance group are the turf factor, the short distance factor, and the medium distance factor. In this case, the turf aptitude and the short distance aptitude of the nurture target character are each increased by two levels, and the mile aptitude and the medium distance aptitude are each increased by one level.

Further, for example, the aptitude factors of the three nurtured characters belonging to the first inheritance group are all the turf factor, and the aptitude factors of the three nurtured characters belonging to the second inheritance group are all the short distance factors. In this case, the turf aptitude and the short distance aptitude of the nurture target character each increase by three levels. In another example, the aptitude factors of the three nurtured characters belonging to the first inheritance group are all the turf factor, and the aptitude factors of the three nurtured characters belonging to the second inheritance group are the turf factor, the short distance factor, and the mile factor. In this case, the turf aptitude of the nurture target character increases by four levels, and the short distance aptitude and the mile aptitude each increase by one level.

However, for the first turn, a limit is placed on the increase value of the aptitude parameter. Specifically, in the first turn, the upper limits of all the aptitude parameters are set to A. Thus, if the initial value of the turf aptitude of the nurture target character is A, the turf aptitude does not increase in the first turn even if the inheritance character has the turf factor.

On the other hand, in the 31st turn and the 55th turn, a lottery is used to determine whether to activate based on the factor level for each aptitude factor. As an example, in the 31st turn and the 55th turn, the activation probability of a level 3 aptitude factor is set to 5%, the activation probability of a level 2 aptitude factor is set to 3%, and the activation probability of a level 1 aptitude factor is set to 1%. In the 31st turn or the 55th turn, when the activation of the aptitude factor is determined through a lottery, the aptitude parameter corresponding to the aptitude factor increases. In the 31st turn and the 55th turn, the upper limit of each aptitude is raised from A to S. Thus, in the 31st turn and the 55th turn, the value of the aptitude parameter can be increased to S by activation of the aptitude factor.

The value of the aptitude parameter increased in the first turn is displayed in the aptitude parameter display portion 152b of the inheritance character selection screen 170.

The race factor increases the ability parameter of the nurture target character. The race factor is provided for each race with a high difficulty (hereinafter referred to as a factor target race), such as GI races, from among the races that can be entered in the nurture main game. When the nurture game is completed, a lottery to determine whether a race factor is obtained is performed for each factor target race in which the nurture target character comes in first place. The nurtured character can obtain a race factor via a successful lottery.

Note that the race factor is provided with factor levels, and the factor level is determined through a lottery for each race factor determined to be obtained. Here, there is no upper limit to the number of race factors that can be obtained by one nurtured character, and the nurtured character can obtain a plurality of race factors.

For each race factor, an ability parameter to be increased by activation and an increase value thereof are set in advance. For example, race factors may include a factor to increase the speed ability parameter and a factor to increase the power ability parameter. At this time, the higher the factor level, the greater the increase value of the ability parameter.

In addition, the activation timing and the activation condition are also set for the race factor, and whether to activate is determined for each race factor in the factor activation turn. If activation of a race factor is determined, the ability parameter corresponding to the race factor is increased. The factor activation turns of the race factor are limited to the 31st turn and the 55th turn. In addition, the activation probability of the race factor in the factor activation turn varies depending on the factor level, and the higher the factor level, the higher the activation probability.

The character factor is a factor specific to the character, and for example, only when a character strengthened to a predetermined level is nurtured as a nurture target character, the character factor set for the character is always given to the nurtured character at the completion of the nurture game. Since only one character factor is set for one character, the maximum number of character factors that one nurtured character can obtain is one. When a nurtured character is produced based on a character that is not strengthened to a predetermined level, a character factor cannot be obtained.

The character factor can be activated in a factor activation turn set in advance and is activated by a successful lottery executed in the factor activation turn. When a character factor is activated, a hint event set for each character factor occurs, and a skill hint can be obtained as described above. When a character factor is activated, the upper limit value of a predetermined ability parameter increases.

FIG. 12B is a diagram for describing the effects of character factors. The increase in the upper limit value of the ability parameter by the character factor is restricted to the second and third activation timings. However, the character factor may be activated at the first activation timing. When the character factor is activated at the first activation timing, as described above, the nurture target character obtains a hint for the skill, but the upper limit value of the ability parameter does not increase.

When the character factor is activated at the second or third activation timing, the upper limit value of the ability parameter increases in addition to obtaining a hint for the skill. Here, regardless of the factor level, the upper limit value of the ability parameter increases by a value within the range of “3” to “6”. The increase value of the upper limit value is determined through a lottery, for example. At this time, the increase value may be set to increase as the factor level increases.

In the present embodiment, the ability parameter with an upper limit value that is increased by the activation of the character factor is set in advance for each character factor. For example, according to character factor A, the upper limit value of stamina is increased by a value in the range of “3” to “6”; and according to character factor B, the upper limit value of speed is increased by “1” and the upper limit value of spirit is increased by “2”, the upper limit value of speed is increased by “2” and the upper limit value of spirit is increased by “2”, or the like. As with the basic ability factor, whether to activate the character factor may be determined on a factor basis or may be determined separately for each effect.

The skill factor illustrated in FIG. 11 is given based on the obtained skill obtained by the nurtured character. Specifically, at the completion of the nurture game, for each obtained skill obtained by the nurtured character, whether a skill factor is obtained is determined through a lottery. By being successful in the lottery, a skill factor is given to the nurtured character. In other words, the nurtured character can obtain some or all of the skill factors corresponding to the obtained skills. When it is determined to obtain a skill factor, the factor level of the skill factor is determined through a lottery.

The skill factor can be activated in a factor activation turn set in advance and is activated by a successful lottery executed in the factor activation turn. At this time, the higher the factor level, the higher the success probability. When a skill factor is activated, a hint event set for each skill factor occurs, and a skill hint can be obtained. Thus, the nurture target character can obtain the same skill as the obtained skill obtained by the inheritance character or the like.

As described above, whether the skill factor is obtained is determined from within a range of the obtained skill obtained by the nurtured character. Thus, the more obtained skills the nurtured character has, the higher the possibility of obtaining the skill factor. However, since whether a skill factor is obtained is determined through a lottery, even if the nurtured character has many obtained skills, a skill factor may not be obtained.

Although the nurtured character obtains the skill factor separately from the obtained skill, the skill that can be obtained by the nurture target character may be determined based on the obtained skill of the nurtured character as the inheritance character without providing the skill factor.

As described above, the ability parameter of the nurture target character greatly changes depending on the inheritance character used to form the deck. In addition, even if the ability of the nurtured character itself is high, since whether a factor is obtained is determined through a lottery, the nurtured character with higher ability does not necessarily correspond to the inheritance character. On the other hand, even when the ability of the nurtured character itself is not high, the nurtured character may effectively function as an inheritance character by obtaining a large number of factors having a high factor level. In this manner, by making it possible to form a deck using the inheritance characters, not only simply nurturing a strong nurtured character, but also nurturing a nurtured character that is effective as an inheritance character is made enjoyable.

Furthermore, in the present embodiment, the compatibility between the nurture target character, the nurtured character of the first inheritance generation, and the nurtured character of the second inheritance generation is determined. Then, in the case of a combination of characters having good compatibility, an advantageous factor activation condition is achieved.

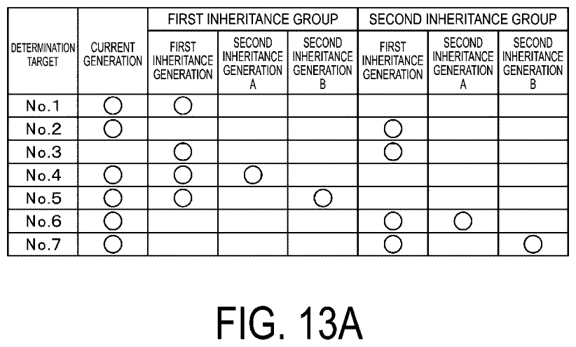

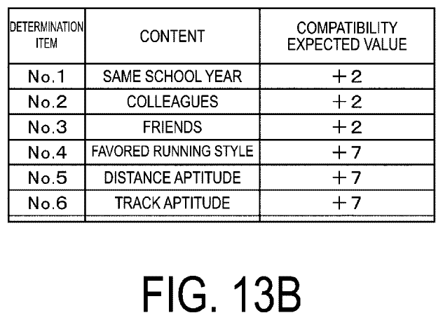

FIG. 13A is a diagram for describing a compatibility determination target, and FIG. 13B is a diagram for describing compatibility determination items. As illustrated in FIG. 13A, in the present embodiment, seven determination targets from No. 1 to No. 7 are provided. The first determination target (No. 1) is the nurture target character of the current generation and the nurtured character of the first inheritance generation in the first inheritance group. The second determination target (No. 2) is the nurture target character of the current generation and the nurtured character of the first inheritance generation in the second inheritance group.

The third determination target (No. 3) is the nurtured character of the first inheritance generation in the first inheritance group and the nurtured character of the first inheritance generation in the second inheritance group. The fourth determination target (No. 4) is the nurture target character of the current generation, the nurtured character of the first inheritance generation in the first inheritance group, and one of the nurtured characters (nurtured character A) of the second inheritance generation in the first inheritance group. The fifth determination target (No. 5) is the nurture target character of the current generation, the nurtured character of the first inheritance generation in the first inheritance group, and the other nurtured character (nurtured character B) of the second inheritance generation in the first inheritance group.

The sixth determination target (No. 6) is the nurture target character of the current generation, the nurtured character of the first inheritance generation in the second inheritance group, and one of the nurtured characters (nurtured character A) of the second inheritance generation in the second inheritance group. The seventh determination target (No. 7) is the nurture target character of the current generation, the nurtured character of the first inheritance generation in the second inheritance group, and the other nurtured character (nurtured character B) of the second inheritance generation in the second inheritance group.

For each determination target, it is determined whether the condition is satisfied for each one of the plurality of determination items. Example of the determination items are illustrated in FIG. 13B. In the present embodiment, the world view of the game is set such that characters that can be selected as nurture target characters are students and each character performs training in a school.

As illustrated in FIG. 13B, settings including same school year, colleagues, and friends are set in advance for each character. The determination items include, for example, whether the two or three determination target characters are in the same school year, are colleagues, or are friends. In addition, the determination items include whether the running style, the distance aptitude, and the track aptitude that the determination target character is good at match.

Each determination item is associated with a compatibility expected value, and the compatibility expected values of the determination items established between the determination target characters are accumulated. Here, the compatibility expected value differs depending on the determination item, but the compatibility expected value may be common to all the determination items.

For example, in the case of determining the compatibility, first, it is determined whether all determination items are established between the nurture target character of the current generation which is a first determination target and the nurtured character of the first inheritance generation of the first inheritance group. At this time, the compatibility expected values associated with the established determination items are accumulated and counted. As described above, the calculation of the compatibility expected value is sequentially performed from the first determination target to the seventh determination target, and the activation probability of the factor is corrected based on the finally calculated compatibility expected value. That is, the higher the compatibility expected value, the higher the activation probability of all the factors, and the lower the compatibility expected value, the lower the activation probability of all the factors.

The activation probability may be calculated by using the calculated compatibility expected value as a correction value. For example, a correction value for correcting the activation probability of a factor may be set for each compatibility level, and the compatibility level may be determined based on the calculated compatibility expected value.

As described above, since the activation probability of the factor varies depending on the compatibility between the nurture target character and the inheritance character or the compatibility between the inheritance characters, the combination of the two inheritance characters greatly affects the nurturing of the nurture target character. In other words, the compatibility between characters is an important criterion for selecting an inheritance character.

As illustrated in FIGS. 9B, 9C, and 9D, in a state in which the inheritance character is selected, a compatibility mark indicating compatibility is displayed on an upper right of the inheritance character selection screen 170 and the nurtured character list screen 180. Here, the compatibility level of the selected characters is indicated by three compatibility marks: ⊚, ∘, and Δ. As illustrated in FIG. 9A, the compatibility mark is not displayed in a state in which an inheritance character is not selected.

As illustrated in FIG. 9B, a switch display button 183 is provided on the nurtured character list screen 180. When the switch display button 183 is operated, a display condition setting screen (not illustrated) is displayed. On the display condition setting screen, the player can rearrange or filter the nurtured character icons 182 displayed on the nurtured character list screen 180, that is, the nurtured characters selectable as inheritance characters.

### Registration of Support Card

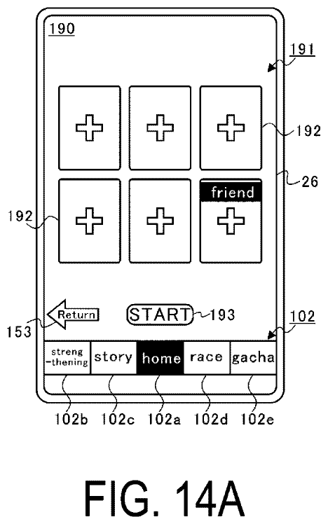

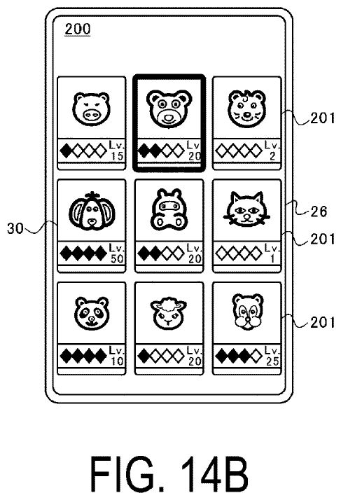

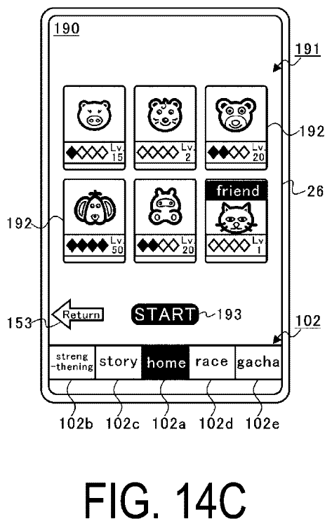

FIG. 14A is a first diagram for describing the support card organization screen 190. When two inheritance characters are registered on the inheritance character selection screen 170, the support card organization screen 190 illustrated in FIG. 14A is displayed. A support card display region 191 is provided at a central portion of the support card organization screen 190. The support card display region 191 includes a plurality of support card display frames 192. In addition, the return operation portion 153 and a start operation portion 193 are displayed at a lower portion of the support card organization screen 190.

In the support card display region 191, a plurality of (here, six) support card display frames 192 are displayed. The number of support card display frames 192 displayed is the same as the number of support cards that can be set by the player. When the support card organization screen 190 is first displayed, the support card display frames 192 are blank.

In the present embodiment, the player can set six types of support cards in the deck. One or more (for example, five types) of the six types that can be set by the player can be selected from among the support cards possessed by the player. In addition, the remaining (for example, one type) of the six types that can be set by the player can be selected from support cards set as rental cards by other players such as friends.

FIG. 14B is a diagram for describing a support card selection screen 200. When the support card display frame 192 (excluding the support card display frame 192 displayed at a lower right) is tapped on the support card organization screen 190 of FIG. 14A, the support card selection screen 200 illustrated in FIG. 14B is displayed on the display 26. The support card selection screen 200 displays a list of card icons 201 corresponding to the support cards owned by the player. By tapping the card icon 201 displayed on the support card selection screen 200, the player can select a support card.

Although not illustrated, when the support card display frame 192 displayed at the lower right of the support card organization screen 190 is tapped, a support card set as a rental card by a friend or a player extracted based on a predetermined condition such as a lottery is displayed on the support card selection screen 200. At this time, the player can select one friend support card by tapping a support card displayed on the support card selection screen 200. In this manner, the player can use a support card possessed by another player in the nurture game.

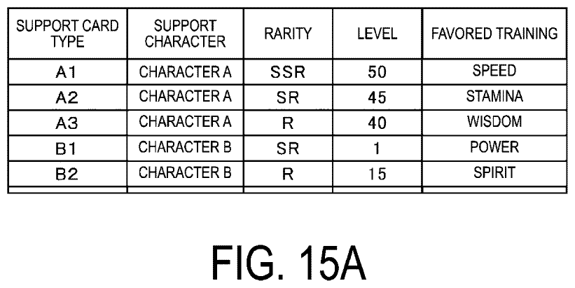

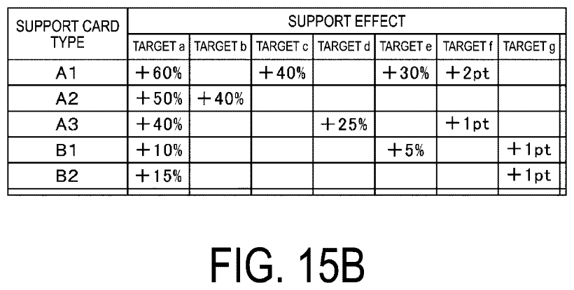

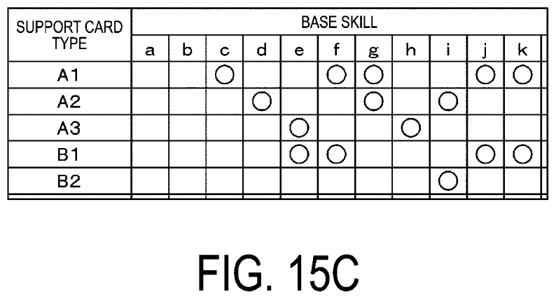

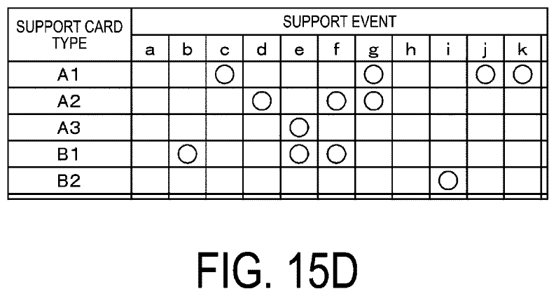

FIG. 15A is a diagram for describing a support card table. As illustrated in FIG. 15A, the support card table stores the type of support character (that is, a character ID), rarity, level, and favored training for each type of support card possessed by the player (that is, support card ID). The support characters are in one-to-one correspondence with the types of support cards. That is, one character ID is always associated with a support card ID. In other words, one support card is always associated with one support character.

In the present embodiment, a rarity is set for each support card. The rarity has three levels: R (rare), SR (super rare), and SSR (super special rare). R is set to the lowest rarity and SSR is set to the highest rarity. In the present embodiment, a support card having a higher rarity tends to have a higher support effect to be described below. In the present embodiment, the number of base skills and the number of support events to be described below tend to increase as the rarity of a support card increases.

For the levels of the support card, 50 levels from level 1 to level 50 are provided. The level of the support card can be increased by the player, and the level increased by the player is stored for each support card. The level of the support card can be raised by using in-game currency, an item, or the like. The level of the support card has an upper limit depending on rarity.

For example, level 20 is set as the upper limit for a support card with a rarity of R, level 25 is set as the upper limit for a support card with a rarity of SR, and level 30 is set as the upper limit for a support card with a rarity of SSR.

The upper limit of the level can be raised incrementally when a predetermined condition is satisfied. For example, a support card with a rarity of R may have its upper limit raised to level 40, a support card with a rarity of SR may have its upper limit raised to level 45, and a support card with a rarity of SSR may have its upper limit raised to level 50.

FIG. 15B is a diagram for describing support effects. As illustrated in FIG. 15B, each support card stores a plurality of support effects. The support effects increase various stats in the nurture main game. A support card has support effects for a plurality of targets. Examples of the support effect targets include energy, speed, stamina, power, spirit, and wisdom.

FIG. 15C is a diagram for describing base skills. As illustrated in FIG. 15C, each support card is set with a plurality of base skills. In the present embodiment, base skills are also associated with support cards so that each character possesses a base skill. The base skill set for each support card can be obtained by the nurture target character selected by the player when a hint event occurs during the nurture main game or can be obtained by another character promoted to a team member as will be described below.

FIG. 15D is a diagram for describing support events. As illustrated in FIG. 15D, each support card is associated with a plurality of support events. A support event is an event that may occur during the nurture main game. When a support event occurs, the values of various stats in the nurture main game may increase or decrease.

For example, a support event that occurs according to the turn number, or a support event that occurs according to a predetermined lottery may be determined. A plurality of support events to occur may be selected in one turn. In any case, the support event to occur may be determined according to a predetermined determination method set in advance.

Note that the support events may include a hint event and an ability event. Also, hint events may include a first hint event that may occur at the start of a turn in the nurture game and a second hint event that may occur after training is performed in the nurture game which will be described below. Also, ability events may include a first ability event that may occur at the start of a turn in the nurture game and a second ability event that may occur after training is performed in the nurture game.

The first hint event and the second hint event are events that make it possible to possess or obtain a skill. Further, the first ability event and the second ability event are events for increasing or decreasing the numerical value of an ability parameter of the character. Hereinafter, the first hint event and the first ability event are collectively referred to as a first event, and the second hint event and the second ability event are collectively referred to as a second event.

FIG. 14C is a second diagram for describing the support card organization screen 190. In the present embodiment, when all six support cards are selected, the start operation portion 193 becomes operable as illustrated in FIG. 14C. On the other hand, when all the six support cards are not selected, the start operation portion 193 cannot be operated as illustrated in FIG. 14A.

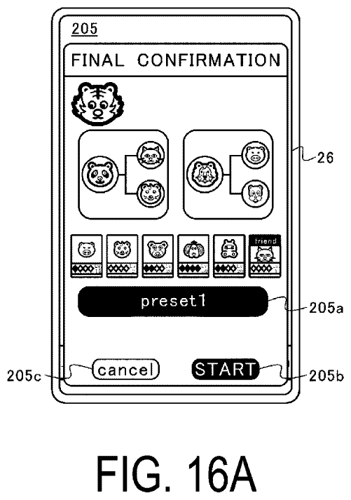

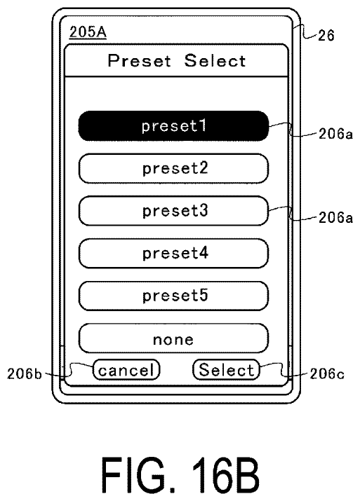

When the return operation portion 153 is operated on the support card organization screen 190, the inheritance character selection screen 170 illustrated in FIG. 9D is displayed on the display 26. Further, as illustrated in FIG. 14C, when the start operation portion 193 is tapped on the support card organization screen 190, the selected support card is temporarily registered, and a final confirmation screen 205 is displayed as illustrated in FIG. 16A.

FIG. 16A is a diagram for describing the final confirmation screen 205. FIG. 16B is a diagram for describing a preset selection screen 205A. On the final confirmation screen 205, the nurture target character selected by the player, the nurtured character in the first inheritance group, the nurtured character in the second inheritance group, and the support cards are displayed. Further, a preset display portion 205a is displayed on the final confirmation screen 205. In the preset display portion 205a, the number of the preset currently selected is indicated.

Here, the preset is reservation information on a race in which the nurture target character is entered in the nurture main game. The player can select any race from all the races to create a preset. A plurality of presets can be stored, and one preset can be selected from the stored presets on the final confirmation screen 205. To be more specific, when the preset display portion 205a is tapped, the preset selection screen 205A illustrated in FIG. 16B is displayed.

On the preset selection screen 205A, preset read buttons 206a corresponding to stored presets are displayed. The player can set a preset by tapping any of the preset read buttons 206a and then tapping a select operation portion 206c. When the select operation portion 206c is tapped, the preset selection screen 205A is closed, and the final confirmation screen 205 is displayed. When a cancel operation portion 206b of the preset selection screen 205A is tapped, the preset selection screen 205A is displayed without changing the preset.

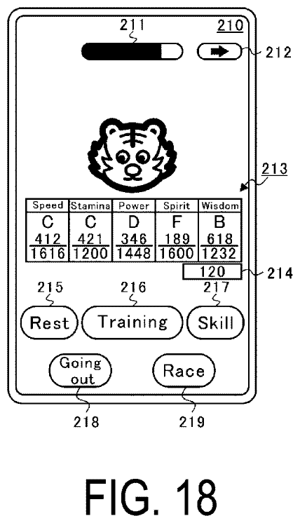

When a cancel operation portion 205c is tapped on the final confirmation screen 205, the support card organization screen 190 is displayed. On the other hand, when a start operation portion 205b is tapped, a top screen 210 (FIG. 18A) is displayed on the display 26.

### Registration of Specific Character

As illustrated in FIG. 4, after a scenario, a nurture target character, an inheritance character, and a support card are registered, next, a specific character is registered. The specific character is predetermined for each scenario, and a character corresponding to the scenario selected by the player is set as the specific character.

As described above, when the nurture target character, the inheritance character, the support character (support card), and the specific character are registered, the preparation stage processing ends.

### Nurture Stage Processing

When the preparation stage processing ends, the nurture stage processing is started. Via the nurture stage processing, the nurture main game in which the nurture target character can be nurtured progresses. Hereinafter, in order to facilitate understanding, first, a basic flow of the nurture main game will be described.

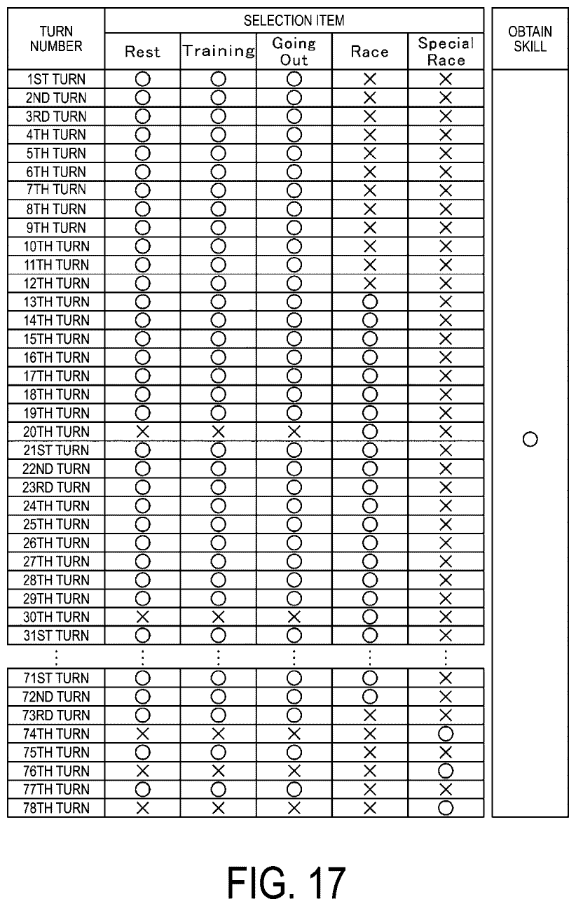

FIG. 17 is a diagram for describing selection items in each turn. Here, the selection items that can be selected are different for each turn depending on the type of the nurture target character. However, the selection items that can be selected may be the same in each turn regardless of the type of the nurture target character. As illustrated in FIG. 17, the nurture main game includes a first turn to a 78th turn. Various parameters are updated in accordance with the selection item selected by the player in each turn.

FIG. 18 is a diagram for describing the top screen 210. In the nurture stage processing, the top screen 210 illustrated in FIG. 18 is displayed on the display 26. In an upper portion of the top screen 210, an energy display portion 211 and a mood display portion 212 are displayed. The nurture target character is provided with an “energy” parameter. The “energy” parameter is mainly used for calculation of a failure rate which is a probability of failure in training which will be described below. The energy display portion 211 is displayed so that the current remaining amount of the “energy” of the nurture target character can be visually recognized with respect to the upper limit value of the “energy”.

The nurture target character is provided with a “mood” parameter. The mood display portion 212 displays the current “mood” of the nurture target character using a plurality of levels (five levels including very bad, bad, normal, good, and very good) so that the user can visually recognize the mood. With the “mood” parameter is higher, race developments become more advantageous for the nurture target character and the increase value of ability parameters in training are increased.

As illustrated in FIG. 18, an image of the nurture target character, a stats display portion 213, and a skill point display portion 214 are displayed at a central portion of the top screen 210. In the stats display portion 213, the current stats of the nurture target character are indicated by a numerical value and an alphabetical letter indicating rank for each numerical value. Specifically, in the present embodiment, the numerical values and ranks of the ability parameters for speed, stamina, power, spirit, and wisdom are displayed. In the skill point display portion 214, the skill points possessed by the nurture target character is indicated by a numerical value.

As illustrated in FIG. 18, a rest operation portion 215, a training operation portion 216, a skill operation portion 217, a going out operation portion 218, and a race operation portion 219 are displayed at a lower portion of the top screen 210. The current turn number is displayed in the upper left portion of the top screen 210.

In addition, in each turn, the player can select one of the items of the rest operation portion 215, the training operation portion 216, the going out operation portion 218, and the race operation portion 219.

The player can select “Rest” as the selection item by operating the rest operation portion 215. When “Rest” is selected, the energy of the nurture target character is recovered. In addition, the player can select training to be executed by the nurture target character by operating the training operation portion 216.

The player can select “Going out” as the selection item by operating the going out operation portion 218. When “Going out” is selected, the mood of the nurture target character is raised. In addition, the player can select the race type to enter the nurture target character in by operating the race operation portion 219.

When the nurture target character performs any one of rest, training, going out, and race entry, the current turn ends and the current turn shifts to the next turn.

In the present embodiment, a race-limited turn in which each item of the rest operation portion 215, the training operation portion 216, and the going out operation portion 218 cannot be selected is set for each character. In the race-limited turn, the rest operation portion 215, the training operation portion 216, and the going out operation portion 218 are displayed grayed out, and an operation by the player is not accepted.

Thus, in the race-limited turn, the player has to operate the race operation portion 219 to enter the nurture target character in a race. Although detailed description is omitted, as illustrated in FIG. 17, the 74th turn, the 76th turn, and the 78th turn are set to race-limited turns for all of the characters in common. In these three turns, the player needs to enter the nurture target character in a special race.

In addition, the skill operation portion 217 is set to be always selectable in all turns. Although details will be described later, even if skill obtainment is performed, the turn does not end.

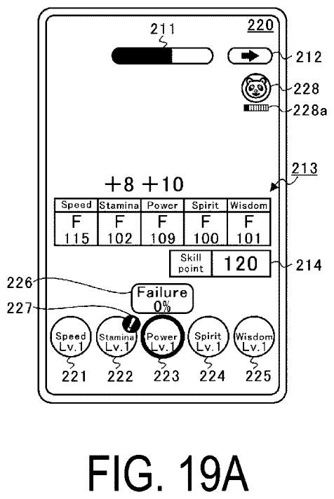

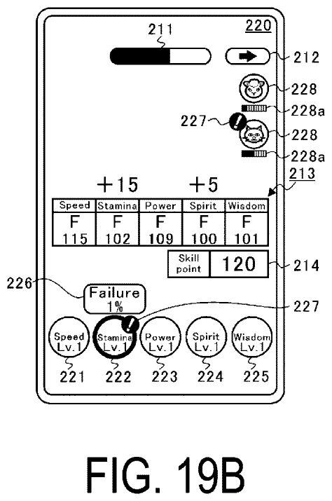

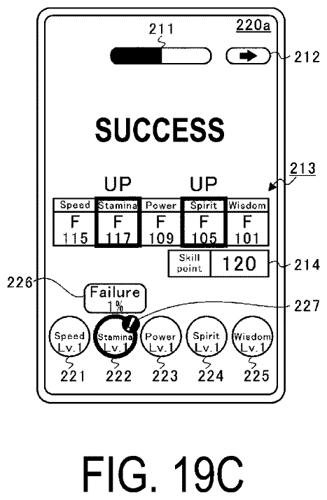

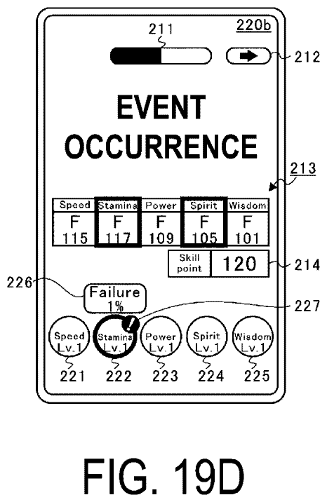

FIG. 19A is a first diagram for describing a training screen 220. FIG. 19B is a second diagram for describing the training screen 220. When the training operation portion 216 of the top screen 210 is operated, the training screen 220 is displayed on the display 26.

As illustrated in FIG. 19A, training items are displayed in a lower portion of the training screen 220. Here, a speed operation portion 221, a stamina operation portion 222, a power operation portion 223, a spirit operation portion 224, and a wisdom operation portion 225 are displayed.

When the player operates one of the operation portions 221 to 225, the training item corresponding to the operated operation portion 221 to 225 is put in a provisionally selected state. At this time, the operation portion 221 to 225 corresponding to the training item in the provisionally selected state is highlighted. In FIG. 19A, the power operation portion 223 is provisionally selected. In FIG. 19B, the stamina operation portion 222 is provisionally selected.

When the speed operation portion 221 in the provisionally selected state is operated again, speed training is executed. Similarly, when the stamina operation portion 222, the power operation portion 223, the spirit operation portion 224, or the wisdom operation portion 225 in the provisionally selected state is operated again, training of stamina, power, spirit, or wisdom is executed, respectively.

In addition, a training level for each training item is also displayed in each of the operation portions 221 to 225. The training level is a parameter that increases based on the number of trainings, and as the training levels are higher, the increase value of the ability parameter when the training is performed is larger. The training level is initially set to level 1 and can increase up to level 5.

In addition, a failure rate display portion 226 is displayed at the operation portion 221 to 225 in the provisionally selected state. The failure rate displayed as a numerical value in the failure rate display portion 226 is set so as to increase in inverse proportion to the remaining energy displayed in the energy display portion 211.

Further, in the stats display portion 213, the increase value of the ability parameter when training corresponding to the operation portion 221 to 225 in the provisionally selected state is successful is displayed. In the example illustrated in FIG. 19A, the power operation portion 223 is provisionally selected, and “+8” is displayed in the stamina field of the stats display portion 213 and “+10” is displayed in the power field of the stats display portion 213. Also, in the example illustrated in FIG. 19B, the stamina operation portion 222 is provisionally selected, and “+15” is displayed in the stamina field of the stats display portion 213 and “+5” is displayed in the spirit field of the stats display portion 213.

In addition, when the training is successfully executed, a predetermined event may occur. In this case, an event notification display 227 is displayed at the operation portion 221 to 225 corresponding to the training item for which the predetermined event occurs. Note that the event notification display 227 may have different display modes depending on the type of the event.

In a turn in which training can be executed, a character may be placed in each training item. The characters placed in the training items are the above-described support characters, specific characters, other team member or sub-member characters, and story characters set separately from these characters. In a turn in which training can be executed, for each character that can be placed in training, whether to place the character in a training item and the training item for placement are determined through a lottery.

As illustrated in FIG. 19B, in an upper right portion of the training screen 220, a placed character icon 228 corresponding to the character placed in training (hereinafter referred to as a placed character) for each of the provisionally selected operation portions 221 to 225 is displayed. When the training is successful, a predetermined event may occur that is associated with the placed character. In this case, the event notification display 227 is displayed on the corresponding placed character icon 228.

Also, when training associated with a placed character is successful, the parameter increase value of the nurture target character is higher than that when training not associated with any of the placed characters is successful. Hereinafter, training in which a character is placed will be referred to as joint training.

Further, a bond gauge 228a is displayed below the placed character icon 228. The bond gauge 228a visually displays the bond parameter associated with the placed character. When the placed character succeeds in the associated training, the bond parameter of the placed character increases. When the bond parameter values are higher, the increase value of the ability parameter of the nurture target character when the training is successful is larger.

Also, when a support character whose bond parameter is equal to or greater than a predetermined value is placed in a predetermined training item, a friendship training possible state is set for the training item. When the training item in which the friendship training possible state is set is selected and the training is successful, friendship training occurs. In other words, when the training in the friendship training possible state is successful, the normal joint training is promoted to the friendship training. In the friendship training, the increase value of the ability parameter of the nurture target character is larger than that in the normal joint training.

Note that any one of the five training items of speed, stamina, power, spirit, and wisdom may be associated with the support card (support character) as a favored training. Here, the setting conditions for the friendship training possible state are that the support character is placed in the favored training and that the bond parameter of the support character is equal to or greater than a predetermined value.

Thus, when a support character whose bond parameter is equal to or greater than a predetermined value is placed in the favored training of the support character, the friendship training possible state is set for this training item. Then, when the training item in which the friendship training possible state is set is selected and the training is successful, the ability parameter of the nurture target character greatly increases as compared with the normal joint training.

Note that the support card (support character) may include a support card (support character) not associated with the favored training. For a support card (support character) not associated with a favored training, the friendship training possible state may be set on the condition that the bond parameter of the support character is equal to or greater than a predetermined value regardless of the placed training item. Alternatively, for a support card (support character) not associated with a favored training, the friendship training possible state may not be set.

As described above, in the present embodiment, the setting conditions of the friendship training possible state include that the bond parameter of the support character is equal to or greater than a predetermined value and that a support character is placed in a pre-set training item.

FIG. 19C is a diagram for describing a training result notification screen 220a. When any one of the operation portions 221 to 225 in the provisionally selected state is operated again, the training corresponding to the operated operation portion 221 to 225 is executed. When the training is performed, the training result notification screen 220a is displayed on the display 26. On the training result notification screen 220a, an image notifying of the success or failure of the training is displayed.

Although not illustrated, in a case where normal joint training is executed, an image of the nurture target character executing training is displayed on the training result notification screen 220a. The image displayed at this time is provided for each training item. In addition, the image corresponding to each training item is provided with a success pattern displayed when the training is successful and a failure pattern displayed when the training is failed.

When the training in which the friendship training possible state is set is successful, a friendship-training-exclusive performance is executed. The friendship-training-exclusive performance includes a performance in which a support character is displayed on the training result notification screen 220a. The support character displayed at this time is a character satisfying the setting conditions of the friendship training possible state.

For example, the character A, which is a support character, is placed in the training item of speed. Also, in this example, the bond parameter of the character A is equal to or greater than a predetermined value and the favored training of the character A (support card) is speed. In this case, the speed training item is in a friendship training possible state. In this state, let's assume that the speed training item is selected and the speed training is successful. In this case, an image including the character A is displayed on the training result notification screen 220a.

In one turn, a plurality of support characters placed in the same training item may satisfy the setting condition of the friendship training possible state. Take an example in which four support characters of the characters A, B, C, and D are placed in the training item of stamina. At this time, let's assume that the characters A, B, C, and D all satisfy the setting condition of the friendship training possible state. In this case, a friendship-training-exclusive performance in which the characters A, B, C, and D are displayed simultaneously or sequentially on the training result notification screen 220a is executed.

In the friendship-training-exclusive performance, the character satisfying the setting condition of the friendship training possible state and the nurture target character perform training together. Thus, it can be said that the friendship training possible state is set to the support character in addition to the training item.

Although not illustrated, an effect is superimposed and displayed on the placed character icon 228 corresponding to the placed character for which the friendship training possible state is set. Accordingly, the player can identify which placed character the friendship training occurs with. In addition, when the friendship training possible state is set to any one of the training items, the effect is also superimposed and displayed on the training operation portion 216 of the top screen 210. Thus, also via the top screen 210, the player can recognize that the friendship training possible state is set.

Also, on the training result notification screen 220a, the ability parameters of the stats display portion 213 are updated and displayed. That is, the ability parameter of the nurture target character corresponding to the training item selected by the player is updated.

Here, the value of the ability parameter that increases when the training displayed in the stats display portion 213 in FIG. 19A or 19B is successful is added. In addition, the display of the energy display portion 211 is updated according to the performed training item. When speed, stamina, power, or spirit training is successful, the energy decreases. On the other hand, when wisdom training is successful, energy is recovered.

When the training is failed, a predetermined penalty is given. Specifically, the content of the penalty may include a decrease in energy, a decrease in a numerical value of an ability parameter, a decrease in mood, and the like. Note that, for example, the penalty given when the failure rate is high may be more disadvantageous than the penalty given when the failure rate is low (for example, the numerical value of the decrease in energy is large, the numerical value of the decrease in the ability parameter is large, or the level of the decreasing mood is large).

The content of the penalty may be determined in accordance with the training item. For example, the value of the ability parameter for speed may be decreased when the training of speed has failed, and the value of the ability parameter for power may be decreased when the training of power has failed. In addition, for one or more training items (for example, wisdom), even if training fails, it can be set that a penalty is not given.

FIG. 19D is a diagram for describing an event screen 220b. When the display of the training result notification screen 220a ends, the event screen 220b may be displayed on the display 26. Various events are performed via the event screen 220b. Note that a plurality of events may occur during one turn.

For example, when a first hint event or a second hint event occurs, a skill hint may be obtained. When skill hint is obtained, the player can obtain the skill by spending skill points. A plurality of types of skills are provided, and a predetermined ability may be activated for each skill. An activation condition and an effect are determined for each skill, and when an activation condition is satisfied, a predetermined effect is activated. A skill may be activated while a race is being executed as will be described below.

The events include, in addition to the first hint event and the second hint event for obtaining a skill hint, an event for recovering energy, an event for decreasing energy, a first ability event and a second ability event for increasing or decreasing an ability parameter, an event for increasing mood, an event for decreasing mood, and the like. Also, as will be described in detail below, examples of the event include an event that occurs in a predetermined turn and an event that occurs via a successful lottery. In addition, there are events that occur at the start of a turn and events that occur before the end of a turn. When all the events that have occurred end, the top screen 210 related to the next turn is displayed.

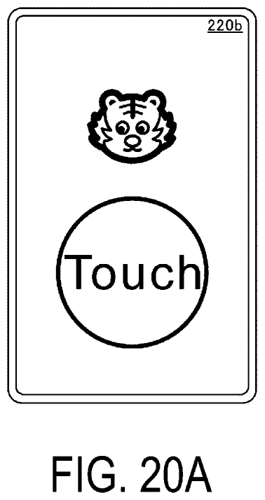

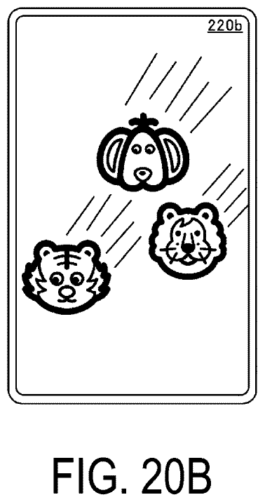

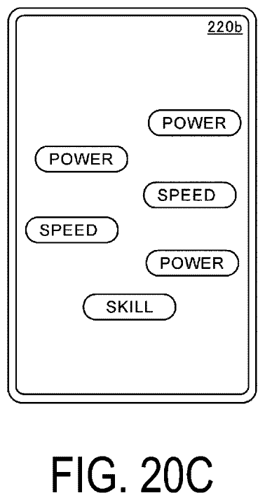

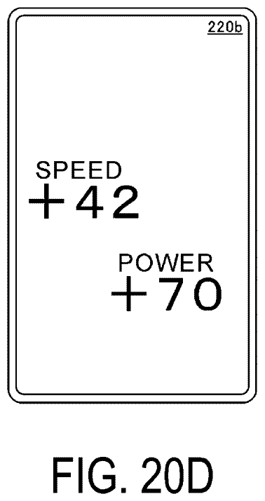

FIG. 20A is a first diagram for describing an inheritance event. FIG. 20B is a second diagram for describing an inheritance event. FIG. 20C is a third diagram for describing an inheritance event. FIG. 20D is a fourth diagram for describing an inheritance event. In the factor activation turn described above, an inheritance event occurs with the start of the turn. Note that this inheritance event is a scenario-shared event to be described later and always occurs in the same turn regardless of the scenario selected by the player. In the present embodiment, the first turn, the 31st turn, and the 55th turn are set as factor activation turns. The example described is of an inheritance event occurring on the 31st turn.

When the 31st turn is started, first, as illustrated in FIG. 20A, the nurture target character and an operation portion labelled with “Touch” are displayed on the event screen 220b. When the operation portion displayed on the event screen 220b is tapped, an animation image including the nurture target character and the two inheritance characters is displayed as illustrated in FIG. 20B. In addition, when the operation portion is tapped, a lottery for whether to active is performed for all the factors possessed by a total of six nurtured characters of the first inheritance generation and the second inheritance generation.

Then, as illustrated in FIG. 20C, the factor which is successful through the lottery for whether to activate and is determined to be activated is displayed, and thereafter, as illustrated in FIG. 20D, the type of the ability parameter or the aptitude parameter which is increased by the activation of the factor and the increase value are displayed, and the parameter is updated. When the inheritance event ends, the top screen 210 illustrated in FIG. 18A is displayed, and the player can select any item. At this time, the stats display portion 213 is in a state in which the increase values for the ability parameter and the aptitude parameter displayed in the inheritance event are added.

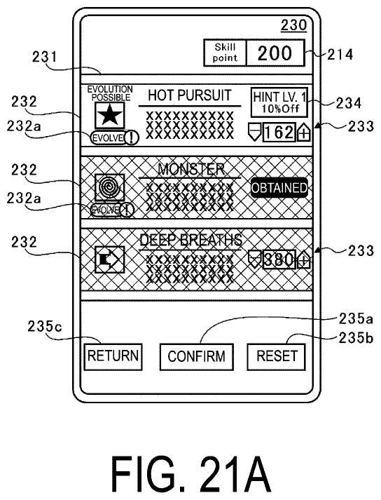

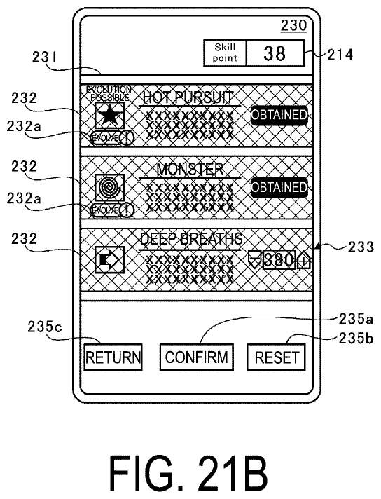

FIG. 21A is a first diagram for describing a skill screen 230. FIG. 21B is a second diagram for describing the skill screen 230. When the skill operation portion 217 of the top screen 210 is operated, the skill screen 230 illustrated in FIG. 21A is displayed on the display 26. A skill point display portion 214 is displayed on the skill screen 230. In the skill point display portion 214, the current skill points possessed by the nurture target character (player) is displayed as described above.

A skill display region 231 is provided below the skill point display portion 214. A plurality of skill display fields 232 are provided in the skill display region 231. In the skill display field 232, an obtained skill, a base skill set in advance for the nurture target character, a base skill possessed due to one of various events, and the like are displayed. Although three skill display fields 232 are displayed in the skill display region 231 in FIG. 21A, when a slide operation is input to the skill display region 231, another skill display field 232 is further displayed in the skill display region 231.

The skill name, the skill activation condition and effect when the skill is activated, and the like are displayed in the skill display region 231. On the right side of the skill display region 231, a required points display portion 233 is displayed. The required point display portion 233 displays the skill points necessary for obtaining the skill. Further, the required point display portion 233 is provided with an operation portion marked with “+” or “−”. The player can set the skill displayed in the skill display field 232 to the selected state by operating the operation portion marked with “+”. Also, the player can cancel the selected state of the skill displayed in the skill display field 232 by operating the operation portion marked with “−”.

When the first hint event or the second hint event occurs for a base skill, the skill points spent to obtain the base skill is discounted. Also, when the hint level of the character is strengthened before the start of the nurture game, the skill points for obtaining the base skill are discounted. Here, the skill points after the discount are displayed in the required point display portion 233 for the base skill for which a hint has been obtained. At this time, a discount rate display icon 234 indicating the discount rate is displayed in the skill display field 232.

On the skill screen 230, the skill display field 232 corresponding to an obtainable skill and the skill display field 232 corresponding to an unobtainable skill are identifiably displayed. For example, the skill display field 232 corresponding to the obtained skill and the skill display field 232 corresponding to the base skill that cannot be obtained due to a shortage of skill points are grayed out (indicated by cross-hatching in the diagram). In the skill display field 232 corresponding to the obtained skill, an icon indicating “obtained” is displayed instead of the required point display portion 233.

Below the skill display region 231, a confirmation operation portion 235a, a reset operation portion 235b, and a return operation portion 235c are provided. When the confirmation operation portion 235a is operated in a state where any one of the skills is in a selected state, a confirmation screen (not illustrated) is displayed. When a predetermined operation for obtaining a skill is input on the confirmation screen, obtained information is associated with the skill in the selected state. That is, the base skill is updated to an obtained skill.

For example, a skill corresponding to the skill display field 232 displayed at the top row of the skill display region 231 is obtained in the state illustrated in FIG. 21A. In this case, in conjunction with the skill being obtained, the skill screen 230 is updated as illustrated in FIG. 21B. Here, the skill display field 232 displayed at the top row of the skill display region 231 is grayed out. In the skill point display portion 214, the remaining skill points after obtaining the skill are displayed.

When the reset operation portion 235b is operated, the selected states of all the skills are canceled. When the return operation portion 235c is operated, the skill screen 230 is closed and the top screen 210 is displayed.

Here, in the present embodiment, evolution conditions are set for some skills. In the present embodiment, among the four awakening skills set for each character, an evolution condition is set for the awakening skills unlocked at the awakening levels “3” and “5”. Hereinafter, an awakening skill with a set evolution condition is referred to as an evolution-compatible skill. Although a case where the awakening skill unlocked at an awakening level of “3” and “5” is an evolution-compatible skill is described here, the evolution-compatible skill may be any other skill.

Whether a skill corresponds to an evolution-compatible skill is not determined by the type of skill, but is determined for each character (character card). Specifically, the skill “Hot pursuit” illustrated in FIG. 21A is associated with various characters as a base skill. For this example, the skill “Hot pursuit” is set to the character A as an awakening skill of an awakening level of 3 and is set to the character B as just a base skill.

In this case, in the nurture game in which the character A is set as the nurture target character, the skill of “Hot pursuit” is an evolution-compatible skill, but in the nurture game in which the character B is set as the nurture target character, the skill of “Hot pursuit” is not an evolution-compatible skill. Thus, in the nurture game in which the character B is set as the nurture target character, the player cannot evolve the skill of “Hot pursuit”.

In the above-described example, it is assumed that the skill of “Hot pursuit” is not unlocked for the character A. In this case, basically, the nurture target character cannot obtain the skill of “Hot pursuit”. However, as described above, the base skill may be set to a support card in a similar manner to a character card, and the character A may come to possess the skill of “Hot pursuit” afterward due to the occurrence of a support event. However, even if the player obtains the base skill of “Hot pursuit” afterward, the player cannot evolve the skill.

That is, it can be said that the evolution condition includes satisfying the unlock condition of the evolution-compatible skill. However, as described above, the player may also be able to evolve a skill possessed afterward. In addition, for example, an evolution-compatible skill that is not related to the type of character, the history of possession, or the like may be provided. In this case, if the evolution condition set for the evolution-compatible skill is satisfied, the player can evolve the skill regardless of the type of the nurture target character, the history of possession of the skill, and the like.

When the evolution condition is satisfied, “Evolution possible” is displayed in the skill display field 232. That is, on the skill screen 230, a skill for which the evolution condition is satisfied is highlighted. Note that the content of the highlighted display of the skill for which the evolution condition is satisfied is not limited to this. For example, the effect may be displayed in the skill display field 232 corresponding to the skill for which the evolution condition is satisfied. Alternatively, the skill display field 232 corresponding to the skill for which the evolution condition is satisfied may be displayed in a color different from that of the other skill display fields 232. Alternatively, the skill display field 232 corresponding to the skill for which the evolution condition is satisfied may be displayed larger than the other skill display fields 232. This improves the user-friendliness at the time when the player obtains a skill.

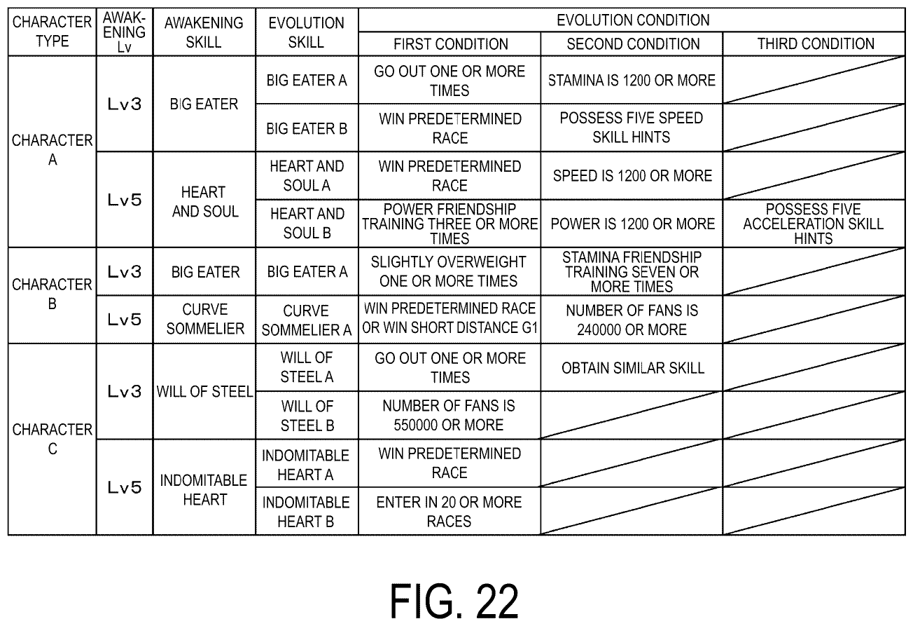

FIG. 22 is a diagram for describing examples of evolution conditions. FIG. 22 illustrates evolution-compatible skills set for each of the characters A, B, and C. Specifically, in the example illustrated in FIG. 22, the awakening skill of “Big eater” unlocked at an awakening level of 3 and the awakening skill of “Heart and soul” unlocked at an awakening level of 5 are set for the character A. Also, the awakening skill of “Big eater” unlocked at an awakening level of 3 and the awakening skill of “Curve sommelier” unlocked at an awakening level of 5 are set for the character B. Also, the awakening skill of “Will of steel” unlocked at an awakening level of 3 and the awakening skill of “Indomitable heart” unlocked at an awakening level of 5 are set for the character C.

Here, two awakening skills unlocked when the awakening level is “3” or “5” are set as evolution-compatible skills. As described above, in the present embodiment, two evolution-compatible skills are set for all of the characters associated with the character card, that is, all of the characters that can be set as the nurture target character. However, the number of evolution-compatible skills may be different depending on the character. Further, a character for which an evolution-compatible skill is not set may be provided.

One or more evolution skills are always associated with an awakening skill that is an evolution-compatible skill. An evolution skill is a skill that can be changed from an evolution-compatible skill when an evolution condition is satisfied. Specifically, “Big eater A” and “Big eater B” are associated as evolution skills with the skill “Big eater”, which is the evolution-compatible skill of the character A.

In this example, the evolution skill has a higher performance than the evolution-compatible skill before evolution. However, it is sufficient that the evolution skill and the evolution-compatible skill before evolution are different from each other at least partially in terms of performance (activation condition, effect exhibited when activated, and the like). Thus, the performance of the evolution skill may be partially or totally inferior to that of the evolution-compatible skill.

In addition, here, the evolution skill is given a name different from that of the evolution-compatible skill. In addition, one skill ID is always associated with each skill. Thus, here, different skill IDs are associated with the evolution skill and the evolution-compatible skill. However, the evolution skill may be given the same name as the evolution-compatible skill. In addition, the same skill ID as that of the evolution-compatible skill may be associated with the evolution skill. For example, a skill in which at least a part of parameters associated with an evolution-compatible skill has changed may be set as an evolution skill.

In addition, the skills are classified into a plurality of systems according to the effect brought about by activation, the activation condition, or the like. For example, the skills are classified based on the effect of the activation, such as a speed system in which the speed increases during the race, a stamina system in which the stamina recovers during the race, and the like. In addition, for example, the skills are classified based on the distance or strategy of a race in which it can be activated. Thus, for example, there are skills belonging to a plurality of systems such as a stamina system and a long-distance system. On the other hand, there may be a skill that belongs to only one system or a skill that does not belong to any system.

Here, the evolution skill and the evolution-compatible skill before evolution are at least partially in common in term of the systems. However, the evolution skill may be of completely different systems from the evolution-compatible skill before evolution.

As described above, an evolution condition is set for the evolution-compatible skill. Since an evolution condition is provided for each evolution skill, it can be said that an evolution condition is set for an evolution skill. One or more evolution conditions are always set for an evolution skill. For example, two evolution conditions, a first condition and a second condition, are set for the skill “Big eater A” which is an evolution skill of the character A. Here, the first condition is set to “Going out” being executed once or more during the nurture game, and the second condition is set to the value of the stamina ability parameter being 1200 or more.

Thus, when the character A having an awakening level of “3” or more is the nurture target character and the player has obtained the skill “Big eater”, the first condition and the second condition are satisfied. Thus, the player can evolve the obtained skill “Big eater” to the skill “Big eater A”, which is the evolution skill.

In addition, for example, for the skill “Big eater B”, which is the evolution skill of the character A, the first condition is set to the character A winning a predetermined race during the nurture game, and the second condition is set to the character A possessing five hints of a speed system skill. The evolution condition is not limited to the speed system and includes an evolution condition that a predetermined number of hints of a specific skill are possessed.

Here, in a case where the number of possessed hints of a specific skill is used as an evolution condition, even if a hint related to the same skill is obtained a plurality of times, the count of the number of possessed hints may not increase. In addition, when the number of possessed hints of a specific skill is used as the evolution condition, the number of possessed hints of an evolution-compatible skill before evolution corresponding to the evolution skill may be included in the count. In addition, when the number of possessed hints of a specific skill is used as the evolution condition, a skill (hint level 0) that has become obtainable due to an increase in the awakening level may not be included in the count of the number of possessed hints. In addition, when the number of possessed hints of a specific skill is used as an evolution condition, a skill in which the hint level of the awakening skill has increased and become 1 or more may be included in the count of the number of possessed hints.

Evolution conditions that are at least partially different from each other are set for a plurality of evolution skills associated with one evolution-compatible skill. If both the evolution condition set for the skill “Big eater A” and the evolution condition set for the skill “Big eater B” are satisfied, the player can select “Big eater A” or “Big eater B” as the evolution destination of the obtained skill “Big eater”. However, only one evolution condition may be set for an evolution-compatible skill associated with a plurality of evolution skills, and the player may be allowed to select any one of the evolution skills when the one evolution condition is satisfied.

In the present embodiment, as illustrated in FIG. 22, the number of evolution conditions set for one evolution skill is from one to three. However, the number of evolution conditions set for one evolution skill may be the same for all evolution skills. In addition, for example, a larger number of set evolution conditions may mean that the evolution skill has a more powerful performance.

Further, as illustrated in FIG. 22, the skill “Big eater” is set as an awakening skill to be unlocked at an awakening level of 3 for both the character A and the character B. However, as is apparent from FIG. 22, the character A and the character B have different numbers of evolution skills associated with the same skill “Big eater”.

That is, for the character A, the skill “Big eater A” and the skill “Big eater B” are associated with the skill “Big eater” as evolution skills. For the character B, only the skill “Big eater A” is associated with the skill “Big eater” as an evolution skill. As described above, even if the evolution-compatible skill is the same, the number and types of evolution skills associated with the evolution-compatible skill may differ depending on the character.

The evolution condition of the skill “Big eater A”, which is an evolution skill, is different between the character A and the character B. In this manner, even with the same evolution skill, since the evolution condition differs depending on the character, a higher degree of strategic performance is required of the player. In other words, it is necessary for each character to progress the game in their own unique manner. This realizes diversification in the nurture game and improves the enjoyment of the game. In addition, in order to obtain an evolution skill, it is necessary to achieve an evolution condition. The evolution conditions include a condition that cannot be achieved unless the nurture game is systematically progressed through for the entire game. Thus, a long-term strategy plan is required, and the enjoyment of the game is improved.

Here, the number of evolution skills associated with one evolution-compatible skill and the evolution condition are different for each character. However, the number of evolution skills associated with one evolution-compatible skill and the evolution condition may be the same for all characters. The evolution conditions illustrated in FIG. 22 are merely examples, and the content of the evolution conditions can be set as appropriate.

As described above, the evolution skill and the evolution condition associated with the evolution-compatible skill are important matters to be considered in progressing through the nurture game. However, since there are a variety of evolution skills and evolution conditions, it is difficult for the player to understand all of these pieces of information. Thus, as illustrated in FIG. 21A, an evolution icon 232a is displayed in the skill display field 232. When the evolution icon 232a is operated, the player can confirm the information relating to the evolution skill.

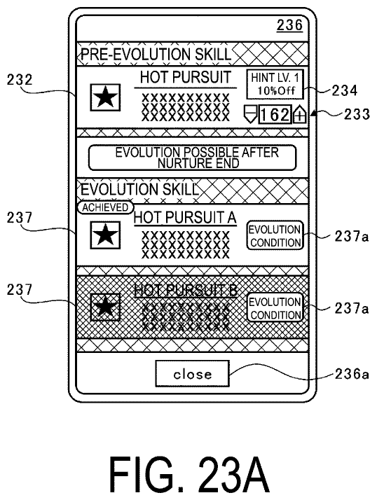

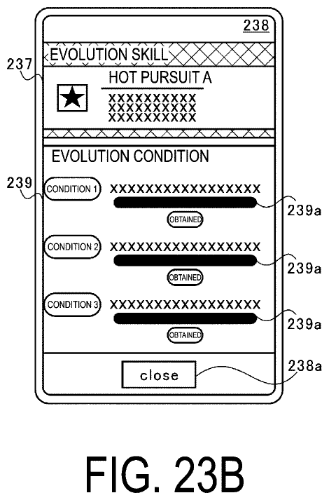

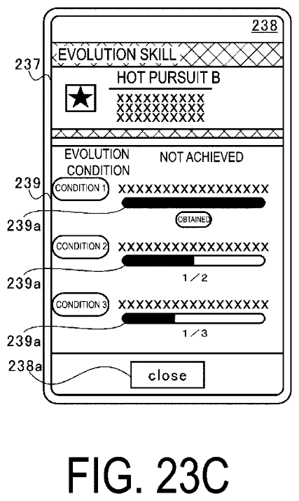

FIG. 23A is a diagram for describing an evolution skill confirmation screen 236. When the evolution icon 232a is operated, the evolution skill confirmation screen 236 illustrated in FIG. 23A is displayed. In an upper portion of the evolution skill confirmation screen 236, the skill display field 232 of the operated evolution icon 232a is displayed. That is, in the upper portion of the evolution skill confirmation screen 236, the skill display field 232 corresponding to the skill (evolution-compatible skill) selected by the player is displayed. “Pre-evolution skill” is displayed in the upper portion of the skill display field 232 to notify that the skill selected by the player is a pre-evolution skill.

Further, below the skill display field 232, a message reading “Evolution is possible after completion of nurturing” is displayed. Below the message, an evolution skill display field 237 is provided. In the evolution skill display field 237, information related to the evolution skill is displayed, such as the name, the activation condition, and the effect when activated of the evolution skill associated with the skill displayed in the skill display field 232. The number of the evolution skill display fields 237 displayed is the same as the number of evolution skills associated with the skills displayed in the skill display fields 232.

At this time, the evolution skill display fields 237 of the evolution skills for which the evolution condition is satisfied are identifiably displayed from the evolution skill display fields 237 of the evolution skills for which the evolution condition is not satisfied. Specifically, the evolution skill display field 237 of an evolution skill for which the evolution condition is not satisfied is grayed out. Further, in the evolution skill display field 237 in which the evolution condition is satisfied, an icon indicating “Achieved” is superimposed and displayed. In this manner, by highlighting the evolution skill display field 237 of the evolution skill for which the evolution condition is satisfied, the user-friendliness for the player is improved.

The evolution skill confirmation screen 236 is provided with a close operation portion 236a. When the close operation portion 236a is operated, the evolution skill confirmation screen 236 is closed and the skill screen 230 is displayed. A condition display operation portion 237a is provided in the evolution skill display field 237. When the condition display operation portion 237a is operated, an evolution condition confirmation screen 238 is displayed.

FIG. 23B is a first diagram for describing the evolution condition confirmation screen 238. FIG. 23C is a second diagram for describing the evolution condition confirmation screen 238. FIG. 23B illustrates a case where the condition display operation portion 237a provided in the evolution skill display field 237 at the upper row of FIG. 23A is operated. FIG. 23C illustrates a case where the condition display operation portion 237a provided in the evolution skill display field 237 at the lower row of FIG. 23A is operated.

In the upper portion of the evolution condition confirmation screen 238, the evolution skill display field 237 corresponding to the evolution skill selected by the player on the evolution skill confirmation screen 236 is displayed. Below the evolution skill display field 237, an evolution condition display field 239 is displayed. In the evolution condition display field 239, (the content of) the evolution condition set for the evolution skill and the level of achievement of the evolution condition are displayed. Specifically, in the evolution condition display field 239, an achievement level display bar 239a is provided for each condition. The achievement level display bar 239a visually displays the level of achievement of each condition, and the display color changes in accordance with the level of achievement as illustrated in FIG. 23C. For an achieved condition, “Achieved” is displayed below the achievement level display bar 239a.

As described above, the user-friendliness for the player is improved by the evolution condition confirmation screen 238. The evolution condition confirmation screen 238 is provided with a close operation portion 238a. When the close operation portion 238a is operated, the evolution skill confirmation screen 236 is displayed.

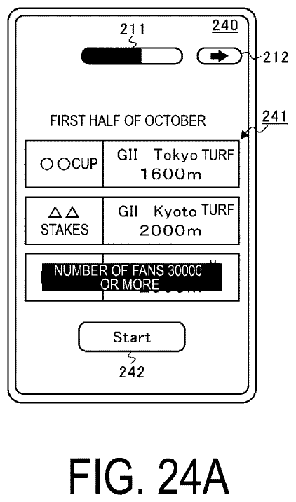

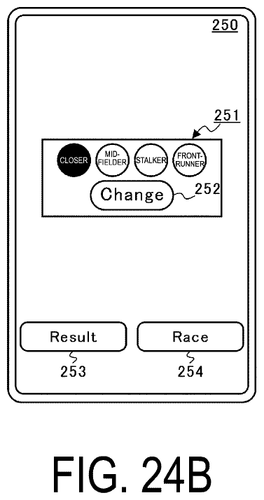

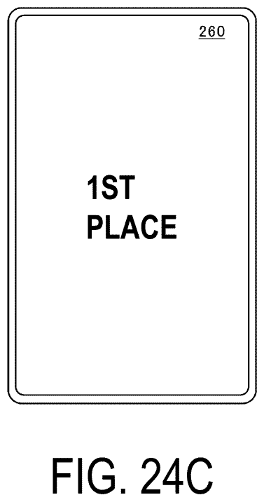

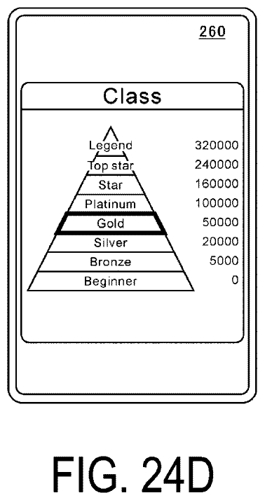

FIG. 24A is a first diagram for describing a race selection screen 240. When the race operation portion 219 of the top screen 210 is operated, the race selection screen 240 illustrated in FIG. 24A is displayed. Races have a game property in which the nurture target character races with non-player characters (hereinafter referred to as NPCs).

In the upper portion of the race selection screen 240, the energy display portion 211 and the mood display portion 212 are displayed. In addition, a race selection operation portion 241 for selecting a race event for the nurture target character to be entered in is displayed in a central portion of the race selection screen 240. In addition, a start operation portion 242 is displayed at a lower portion of the race selection screen 240. A race that can be selected via the race selection operation portion 241 of the race selection screen 240 is set in advance for each turn.

In addition, the race entry condition is set in advance for each race, and the player can only enter the nurture target character in a race with race entry conditions that are satisfied. As described above, a race may have the number of fans set as a race entry condition. For a race with a set number of fans that is not satisfied, as illustrated in FIG. 24A, the race selection operation portion 241 displays the race entry condition and notifies that the race cannot be selected. In the turn in which the target race of the clear goal is set, only the target race is displayed in a selectable manner on the race selection screen 240.

FIG. 24B is a diagram for describing a race start screen 250. When the start operation portion 242 is operated in a state where the race event of the race to enter is selected by the race selection operation portion 241, the race start screen 250 illustrated in FIG. 24B is displayed. A strategy display portion 251 is displayed at a central portion of the race start screen 250. In the strategy display portion 251, the currently selected strategy (closer, midfielder, stalker, front-runner) is highlighted. A change operation portion 252 is displayed in the strategy display portion 251. When the change operation portion 252 is operated, a strategy change screen (not illustrated) is displayed on the display 26. The player can change the strategy in the race to any strategy by an operation on the strategy change screen.

Further, at a lower portion of the race start screen 250, a result operation portion 253 and a race operation portion 254 are displayed. When the race operation portion 254 is operated, a race screen (not illustrated) is displayed on the display 26. On the race screen, a moving image of developments in the race (hereinafter also referred to as a race moving image) is displayed.

FIG. 24C is a first diagram for describing a race result screen 260. FIG. 24D is a second diagram for describing the race result screen 260. When playback of the race moving image described above ends and when the result operation portion 253 is operated, the race result screen 260 is displayed on the display 26. On the race result screen 260, as illustrated in FIG. 24C, the placing of the nurture target character in the race is displayed. Further, on the race result screen 260, as illustrated in FIG. 24D, the current class of the nurture target character is displayed.

In the present embodiment, the nurture target character is classified according to the number of fans obtained. A range of the number of fans is set for each class. Here, the nurture target character is classified into one of eight levels of classes according to the number of fans. On the race result screen 260, the cumulative number of fans obtained by adding the number of fans obtained in the current race to the number of fans obtained before is displayed. In addition, the current class corresponding to the cumulative number of fans is identifiably displayed.

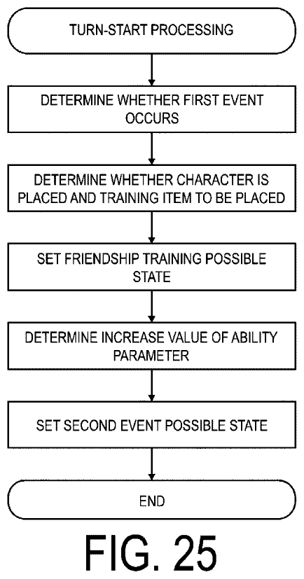

FIG. 25 is a diagram for describing a rough flow of turn-start processing. The nurture stage processing includes the turn-start processing executed at the start of each turn of the nurture game. Although the details of the turn-start processing will be described below, a rough flow of the turn-start processing will be described here.

During the nurture main game, processing to determine whether to cause various events to appear is executed in each turn. Events are roughly classified into three types: a scenario event, the above-described exclusive event provided for each nurture target character, and a support event. In each scenario, a scenario event, an exclusive event, and a support event that may appear in the nurture main game are predetermined.

A scenario event is an event set for each scenario of the nurture main game. In the present embodiment, a plurality of scenarios are provided, and the player can select a scenario. A scenario event appears for each scenario selected by the player. In other words, the scenario event that appears in the nurture main game is determined based on the scenario selected by the player.

The scenario event may include a scenario-specific event and a scenario-shared event. A scenario-specific event is an event associated with only one scenario. For example, a scenario-specific event associated with a first scenario appears only when the first scenario is selected and does not appear when another scenario is selected.

A scenario-shared event is an event that appears shared across a plurality of scenarios. Thus, the scenario-shared event appears in both cases when the first scenario is selected and when the second scenario is selected.

In this example, scenario-specific events and scenario-shared events are provided as scenario events. However, only one of the scenario-specific events and the scenario-shared events may be provided.

As described above, an exclusive event is an event set in advance for each character. In the nurture main game, an exclusive event for a character registered as a nurture target character by the player in the setting game, that is, the preparation stage processing, appears.

As described above, the support event is an event set in advance for each support card. In the nurture main game, a support event associated with the support card registered by the player in the setting game appears. The support event includes a first event that may occur at the start of a turn and a second event that may occur after training is performed. At the start of a turn, whether the first event occurs is determined based on a random number obtained at random and a first event table.

Whether the second event occurs is determined based on a randomly obtained random number and a second event table after the determination processing for each support character placed in the training is executed. Note that whether the second event occurs is determined for the placed support character only in a case where a support character is placed in training.

In the present embodiment, the first event may be selected by a support event associated with the support card selected through a lottery from among all of the support cards implemented into the game and is not limited to a support card registered in the deck by the player in the preparation stage processing. However, the selection probability of the support event associated with the support card registered in the deck is higher than the selection probability of the support card events associated with the support cards not registered in the deck.

As described above, whether a scenario event appears is determined based on the scenario. Also, whether an exclusive event and a support event appear is determined based on the nurture target character and the support card, respectively. These event types are classified by information that is referenced when whether an event appears is determined.

On the other hand, in the present embodiment, each event is classified into one of six event classifications according to the content brought about by the appearance of the event. Here, each event is classified into one of the event classifications including a first hint event, a second hint event, a first ability event, a second ability event, an aptitude event, and a story event.

As described above, the first hint event and the second hint event are events that make it possible to possess or obtain a skill. The first ability event and the second ability event are events for increasing or decreasing the ability parameter of the nurture target character. The aptitude event is an event for increasing or decreasing the aptitude parameter of the nurture target character. The story event is an event for displaying a story related to a character appearing in the nurture game. Note that story events may change an ability parameter or an aptitude parameter in addition to a story being displayed.

Here, the scenario event includes a first hint event, a second hint event, a first ability event, a second ability event, an aptitude event, and a story event. The exclusive event and the support event include a first hint event, a second hint event, a first ability event, and a second ability event. Note that the exclusive event may include a story event.

In the present embodiment, the turn-start processing includes processing of determining a scenario event and processing of determining an exclusive event. The processing of determining a scenario event and the processing of determining an exclusive event are not illustrated and described here. The turn-start processing includes “processing of determining whether a first event occurs”, “processing of determining whether a character is placed and the training item to be placed”, “processing of setting a friendship training possible state”, “processing of determining an increase value of an ability parameter”, and “processing of setting a second event possible state” as illustrated in FIG. 25. Although various other processing is executed in the turn-start processing, the processing illustrated in FIG. 25 will be sequentially described here.

### Processing of Determining Whether First Event Occurs

In the processing of determining whether the first event occurs, the first event to be caused to occur is determined through a lottery from among the support events associated with all of the support cards provided by the administrator. At this time, the success probability of a support event associated a support card registered in the deck by the player in the preparation stage processing is set to a high value.

### Processing of Determining Whether Character is Placed and Training Item to be Placed

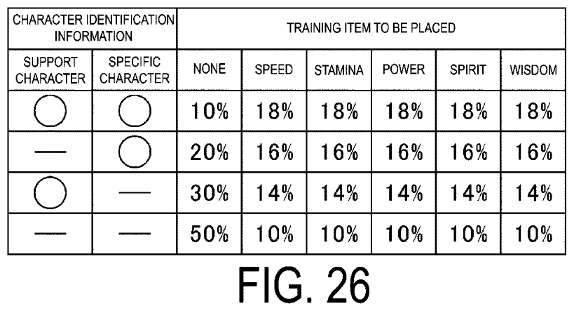

FIG. 26 is a diagram for describing the placing percentage for the training items. A placement determination table is stored in the player terminal 1 and the server 1000, and a training item in which a character is placed is determined based on the placement determination table. In the present embodiment, training items are determined for all team members and story characters, based on the character identification information.

Here, the placement determination table is provided for each piece of character identification information, and the placing percentage for each training item is different for each placement determination table. Specifically, according to the placement determination table for the support characters and the specific characters, the determination that the character is not placed in any training (“None” in the diagram) is set to 10%, and the determination that the character is placed in the training items of speed, stamina, power, spirit, and wisdom (“Speed”, “Stamina”, “Power”, “Spirit”, and “Wisdom” in the diagram) is set to 18%. The placement determination table for the support characters and the specific characters is used when the target character whose placement is to be determined is set as a support character and is set as a specific character.

Also, according to the placement determination table for the specific characters, the determination that the character is not placed in any training is set to 20%, and the determination that the character is placed in the training items of speed, stamina, power, spirit, and wisdom is set to 16%. The placement determination table for the specific characters is used when the target character is not set as a support character and is set as a specific character.

Also, according to the placement determination table for the support characters, the determination that the character is not placed in any training is set to 30%, and the determination that the character is placed in the training items of speed, stamina, power, spirit, and wisdom is set to 14%. The placement determination table for the support characters is used when the target character is set as a support character and is not set as a specific character.

Also, according to the placement determination table for other characters, the determination that the character is not placed in any training is set to 50%, and the determination that the character is placed in the training items of speed, stamina, power, spirit, and wisdom is set to 10%. The placement determination table for other characters is used when the target character is neither set as a support character nor a specific character. Note that the placement determination table for other characters may be used when the target character is a story character, for example.

In this manner, a team member registered as a support character is more likely to be placed in training than a team member not registered as a support character. Also, a team member registered as a specific character is more likely to be placed in training than a team member not registered as a specific character.

Note that as described above, favored training is set for the support cards (support characters). When the target character is a support character, based on the placement determination table illustrated in FIG. 26, a change may be made so that the selection probability of the favored training set for the support card is increased. In addition, for example, an effect of increasing the placement probability for a predetermined training item may be associated with some or all of the support cards (support characters). For a support character associated with such an effect, the placement probability for the predetermined training item is changed so that the value is increased.

Note that each training item is provided with an upper limit number for character placement. Here, “5” is set as the upper limit number for character placement for all of the training items. Thus, the number of placed characters placed in one training item is “5” at the maximum.

As described above, the training item to be associated with the character is determined for each character. At this time, the order of characters for determining a training item may be any order. Then, for example, in a case where placement of the upper limit number of placed characters has already been determined for a training item for which placement of a character has been determined, it may be determined that the character is not placed in any training item. Alternatively, the training item whose placement upper limit number has already been reached may be excluded from the lottery, and the placement probability of the other training items may be changed.

However, the placement upper limit number is not essential, and the placed character may be placed in the training item according to the lottery result. In addition, a method of determining a training item in which a character is placed is not particularly limited.

When the placed character is determined as described above, the placed character is associated with the training item. Then, the placement information in which the training item and the placed character are associated with each other is stored in the player terminal 1 and the server 1000.

### Processing of Setting Friendship Training Possible State

Referring back to FIG. 25, when the placement information is determined as described above, the friendship training possible state setting is performed. Specifically, a support character is extracted from the characters placed in the training item. Then, it is determined whether the setting condition for the friendship training possible state is satisfied for the extracted support character. As described above, here, the setting conditions for the friendship training possible state are that the training item in which the support character is placed is the favored training and that the bond parameter associated with the support character is equal to or greater than the predetermined value.

Then, the friendship training possible information is associated with the support character that satisfies the setting conditions for the friendship training possible state. Also, the friendship training possible information is associated with the training item in which the support character satisfying the setting conditions for the friendship training possible state is placed. Thus, the friendship training possible state is set.

### Processing of Determining Increase Value of Ability Parameter

In a turn in which training can be executed, an increase value of the ability parameter at the time of training success is determined for each training item.

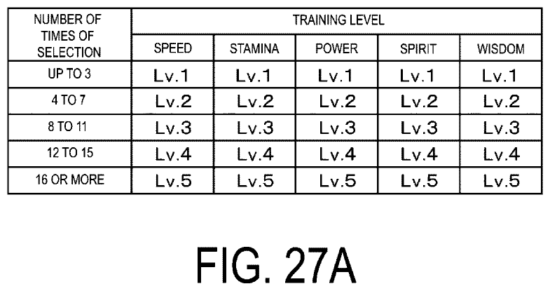

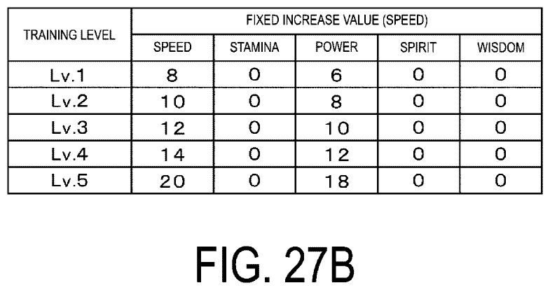

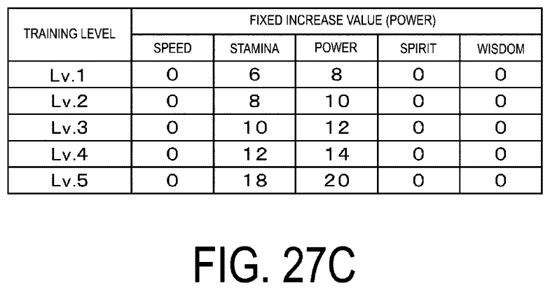

FIG. 27A is a diagram for describing a training level table. As illustrated in FIG. 27A, the training level is set to increase in accordance with the number of times each training is selected. Specifically, when the number of times each training is selected is 3 or less, each training level related to speed, stamina, power, spirit, and wisdom is set to “level 1”; when the number of times each training is selected is in a range from 4 to 7, each training level is set to “level 2”; when the number of times each training is selected is in a range from 8 to 11, each training level is set to “level 3”; when the number of times each training is selected is in a range from 12 to 15, each training level is set to “level 4”; and when the number of times each training is selected is 16 or more, each training level is set to “level 5”.

Here, a case where the training level increases in accordance with the number of times of selection of training has been described. However, the condition for increasing the training level is not limited thereto. For example, the training level may be increased or decreased by a lottery. Alternatively, the training level may be changed according to the turn number. Note that the training level is not essential.

In the present embodiment, when the training selected by the player has been performed and has been successful, the value of a predetermined ability parameter is increased by the performed training item.

Specifically, in the present embodiment, if speed training is performed and it is successful, the values of the ability parameters for speed and power are increased.

In addition, if stamina training is performed and the training is successful, the values of the ability parameters for stamina and spirit are increased.

In addition, if power training is performed and the training is successful, the values of the ability parameters for stamina and power are increased.

In addition, if spirit training is performed and the training is successful, the values of the ability parameters for speed, power, and spirit are increased.

In addition, if wisdom training is performed and the training is successful, the values of the ability parameters for speed and wisdom are increased.

In the present embodiment, the value of the ability parameter to be increased when the training is successful is calculated by adding a value obtained by adding a fixed increase value determined corresponding to the performed training item and training level to a bonus additional value to be described below to the fixed increase value.

FIG. 27B is a diagram for describing a fixed increase value (speed) table. FIG. 27C is a diagram for describing a fixed increase value table (power). That is, FIG. 27B indicates the fixed increase value when the training item is speed. Also, FIG. 27C indicates the fixed increase value when the training item is power.

As illustrated in FIGS. 27B and 27C, the fixed increase value table stores fixed increase values determined corresponding to the performed training item and the training level. Further, in the present embodiment, as illustrated in FIGS. 27B and 27C, the ability parameter is set to increase more as the training level is higher.

Although description is omitted here, fixed increase value tables in a case where stamina, spirit, and wisdom are selected as the training item are also provided.

In the present embodiment, a large number of additional conditions for the ability parameters are provided. An example of the additional conditions includes that the specific character or the support character is placed in the training item. In this case, a predetermined additional value is added to the fixed increase value. Further, for example, a growth rate may be set in advance for each training item for each nurture target character. In this case, the fixed increase value is multiplied by the growth rate for each training item.

As described above, when the additional condition is satisfied, the additional value is added to the fixed increase value or the fixed increase value is multiplied by a predetermined addition rate. Then, the calculated value is finally multiplied by the friendship bonus addition rate. The friendship bonus addition rate is used when a friendship bonus possible state is set for the training item. In addition, the friendship bonus addition rate is calculated for each placed character placed in the training item.

In this example, the friendship bonus addition rate is 20%, and three placed characters for which the friendship bonus possible state is set are placed in the same training item. In this case, the friendship bonus addition rate is 60%. In this manner, the increase value of the ability parameter increases by being multiplied by the friendship bonus addition rate.

### Processing of Setting Second Event Possible State

Referring back to FIG. 25, a second event possible state may be set for a support character placed in any of the training items. A second event is selected through a lottery from among the support events (second events) associated with the support characters (support cards) placed in the respective training items.

In the present embodiment, processing is executed to determine whether to set a second event possible state for all of the support characters placed in the training items. When the player selects the training in which the support character for which the second event possible state is set is placed, the second event occurs after the training is performed.

Note that the second event possible state may be set for each of a plurality of support characters placed in one training item. In this case, when the training is executed, only one of the second events for which the possible state is set may be executed. In addition, all the second events for which the possible state is set may be executed.

As described above, in the nurture main game, ability parameters of the nurture target character can be increased as the player progresses through the turns. The ability parameters increases with the success of training or the occurrence of various events. In the nurture main game, when all the turns are finished, the nurture game ends. If the goal set for each character was not achieved during the nurture main game, the nurture game ends at this point.

Here, when the nurture game ends, the nurture target character nurtured in the nurture game is stored as a nurtured character. More strictly, the information relating to the nurtured character nurtured in the nurture game (hereinafter referred to as nurtured character information) is stored in association with the player ID. The nurtured character information is stored in both the player terminal 1 and the server 1000. The nurtured character information stored in association with the player ID includes an ability parameter, an aptitude parameter, an obtained skill, inheritance information, and the like.

Then, in the present embodiment, the player can select an evolution skill when all the turns in the nurture main game are finished. Specifically, when the nurture target character has obtained an evolution-compatible skill during the nurture main game and the evolution condition of the evolution-compatible skill is satisfied, the player can select whether to change the obtained evolution-compatible skill to the evolution skill. That is, when the evolution condition set for each skill and set for the skill associated with the obtained information is satisfied, the skill can be changed.

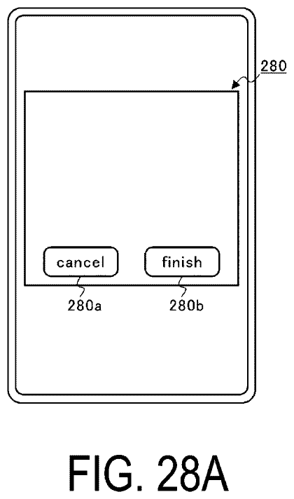

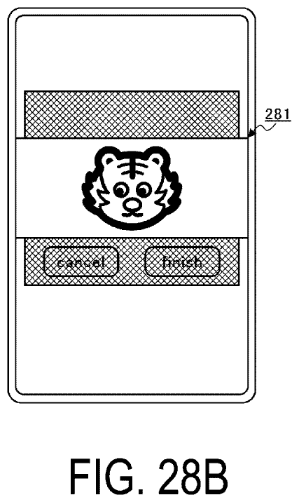

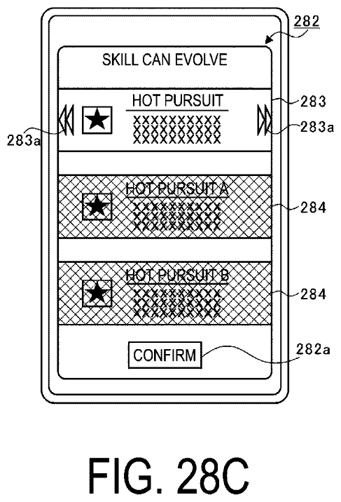

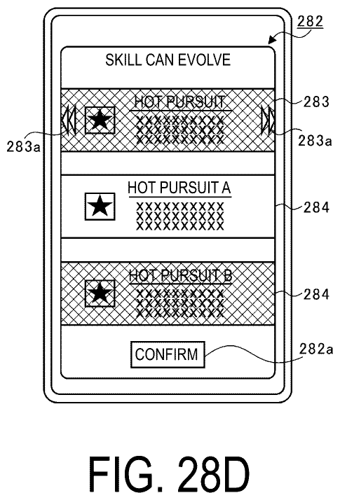

FIG. 28A is a diagram for describing an end confirmation dialog 280. FIG. 28B is a diagram for describing a suggestive image 281. FIG. 28C is a first diagram for describing an evolution skill selection dialog 282. FIG. 28D is a second diagram for describing the evolution skill selection dialog 282. In the nurture main game, when all the turns are finished, a final screen (not illustrated) is displayed. On the final screen, for example, skill points can be spent to obtain a base skill. Then, when an end button provided on the final screen is operated, the end confirmation dialog 280 illustrated in FIG. 28A is superimposed and displayed on the final screen.

The end confirmation dialog 280 is provided with a cancel operation portion 280a and a confirmation operation portion 280b. When the cancel operation portion 280a is operated, the end confirmation dialog 280 is closed. Also, the confirmation operation portion 280b receives an end operation for ending the nurture main game. In a case where the nurture target character has the obtained skill satisfying the evolution condition when the end operation is input to the confirmation operation portion 280b, the suggestive image 281 illustrated in FIG. 28B is displayed.

Here, a cut-in image in which the nurture target character is displayed is superimposed and displayed on the end confirmation dialog 280 as the suggestive image 281. After the suggestive image 281 is displayed for a predetermined amount of time, the evolution skill selection dialog 282 illustrated in FIG. 28C is displayed. That is, it can be said that the suggestive image 281 suggests that the evolution skill selection dialog 282 will be displayed, that is, that an evolution skill will be selectable. Note that the content of the suggestive image 281 is not particularly limited. However, the suggestive image 281 is content suggesting that something will occur thereafter.

An obtained skill display field 283 is displayed at the upper portion of the evolution skill selection dialog 282. In the obtained skill display field 283, a skill that has already been obtained during the nurture main game and that satisfies the evolution condition is displayed. Below the obtained skill display field 283, an evolution skill display field 284 is displayed. In the evolution skill display field 284, an evolution skill that satisfies the evolution condition, that is, an evolution skill that can be changed to from an obtained evolution-compatible skill is displayed.

In the example illustrated in FIG. 28C, a case where the evolution condition is satisfied for both of the two evolution skills associated with the evolution-compatible skill is illustrated. Thus, in this case, the two evolution skill display fields 284 are displayed as illustrated in FIG. 28C. When only the evolution condition of one of the two evolution skills associated with the evolution-compatible skill displayed in the obtained skill display field 283 is satisfied, only one evolution skill display field 284 is displayed.

As illustrated in FIG. 28C, at the start of display of the evolution skill selection dialog 282, the evolution skill display field 284 is grayed out, and the obtained skill display field 283 is highlighted to stand out more than the evolution skill display field 284. In this state, the evolution-compatible skill displayed in the obtained skill display field 283 is in a selected state. In this example, in this state, an operation input is performed on the upper row evolution skill display field 284 of the two evolution skill display fields 284.

In this example, as illustrated in FIG. 28D, the operated evolution skill display field 284 is highlighted, and the obtained skill display field 283 and the lower row evolution skill display field 284 in the lower row are grayed out. In this state, the evolution skill corresponding to the upper row evolution skill display field 284 is in a selected state.

The evolution skill selection dialog 282 is provided with a confirmation operation portion 282a. When the confirmation operation portion 282a is operated, the skill in the selected state is set as the obtained skill. Note that the player does not necessarily need to change the obtained evolution-compatible skill to the evolution skill. When the evolution-compatible skill is not changed to the evolution skill, the player may operate the confirmation operation portion 282a with the obtained skill display field 283 in a selected state.

When the evolution condition of the obtained evolution-compatible skill is satisfied, the player may be required to change the evolution-compatible skill to the evolution skill.

There may be a case where a plurality of evolution-compatible skills satisfying the evolution condition are obtained. In this case, switching operation portions 283a are provided on the left and right sides of the obtained skill display field 283 as illustrated in FIGS. 28C and 28D. When the switching operation portion 283a is operated, the evolution-compatible skill and the evolution skill displayed in the evolution skill selection dialog 282 are switched. When only one evolution-compatible skill satisfying the evolution condition has been obtained, the switching operation portions 283a are not displayed. Thus, in this case, the evolution-compatible skill and the evolution skill cannot be switched in the evolution skill selection dialog 282.

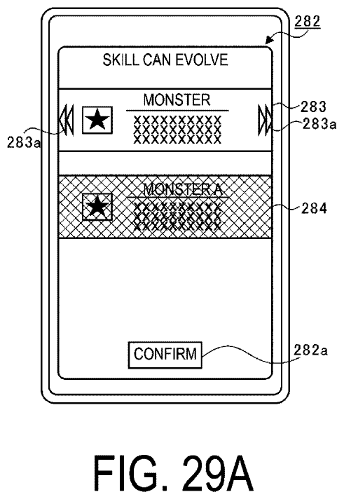

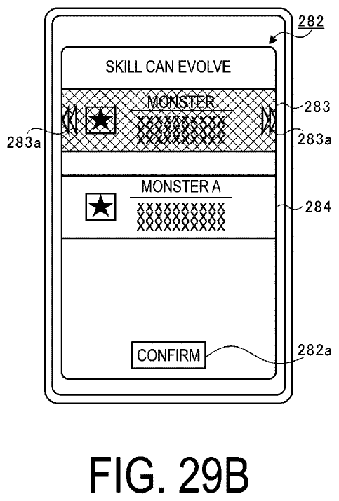

FIG. 29A is a third diagram for describing the evolution skill selection dialog 282. FIG. 29B is a fourth diagram for describing the evolution skill selection dialog 282. In this example, from the state illustrated in FIG. 28D, the switching operation portion 283a has been operated. In this example, as illustrated in FIG. 29A, the evolution-compatible skill displayed in the obtained skill display field 283 has been changed. Here, the skill “Hot pursuit” has been switched to the skill “Monster”.

In the example illustrated in FIG. 29A, the evolution condition of the skill “Monster A”, which is the evolution skill associated with the skill “Monster”, is satisfied, and the evolution condition of the skill “Monster B” is not satisfied. Thus, in this case, only the evolution skill display field 284 corresponding to “Monster A” is displayed in the evolution skill selection dialog 282. When the evolution skill display field 284 is operated in the state illustrated in FIG. 29A, the evolution skill display field 284, that is, the skill “Monster A” is put in a selected state as illustrated in FIG. 29B.

As described above, in the evolution skill selection dialog 282, the player can select a skill to be finally associated with the nurtured character for all evolution-compatible skills for which the evolution condition is satisfied.

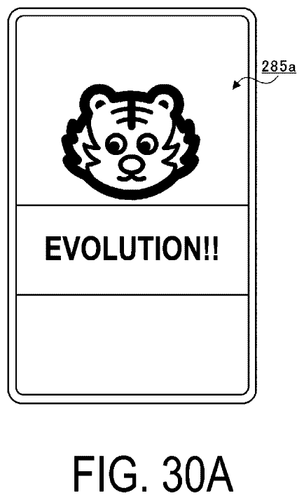

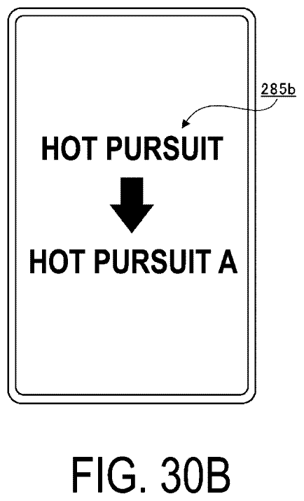

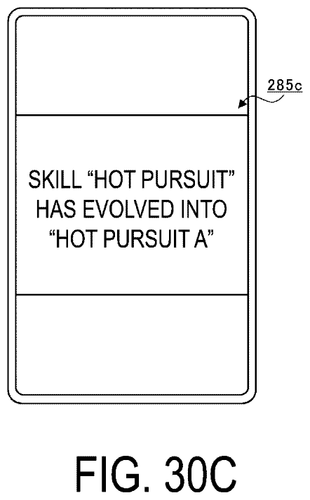

FIG. 30A is a first diagram for describing an evolution performance image. FIG. 30B is a second diagram for describing an evolution performance image. FIG. 30C is a third diagram for describing an evolution performance image. In this example, in the evolution skill selection dialog 282, the confirmation operation portion 282a has been operated in a state where at least one evolution skill is in the selected state. In this example, an evolution performance suggesting that the evolution-compatible skill will change to the evolution skill is executed. In the evolution performance, an evolution performance image is displayed on the display 26.

Here, the evolution performance image includes a first image 285a, a second image 285b, and a third image 285c. In the evolution performance, first, the first image 285a is displayed as illustrated in FIG. 30A. Here, as the first image 285a, an image in which the nurture target character is shouting “Evolution” is displayed. When the first image 285a has been displayed for a predetermined amount of time, the second image 285b is subsequently displayed. As illustrated in FIG. 30B, the second image 285b is an image suggesting that the skill “Hot pursuit” will change to the skill “Hot pursuit A”. The second image 285b is provided for each evolution-compatible skill and evolution skill.

When the second image 285b has been displayed for a predetermined amount of time, the third image 285c is subsequently displayed. As illustrated in FIG. 30C, the third image 285c is a text image including the text “The skill “Hot pursuit” has evolved into the skill “Hot pursuit A””. As described above, in the present embodiment, the content of the changed skill is suggested by the evolution performance image.

Here, when one evolution skill is selected in the evolution skill selection dialog 282, the display of one evolution performance image ends the evolution performance. On the other hand, when a plurality of evolution skills are selected in the evolution skill selection dialog 282, the display of the evolution performance image as described above is repeatedly executed as many times as the number of selected evolution skills.

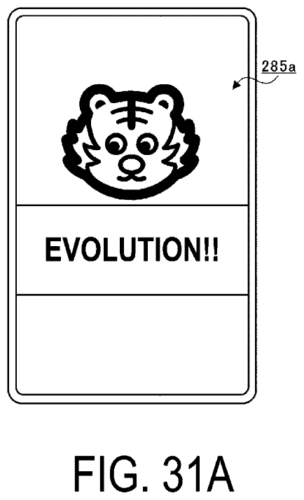

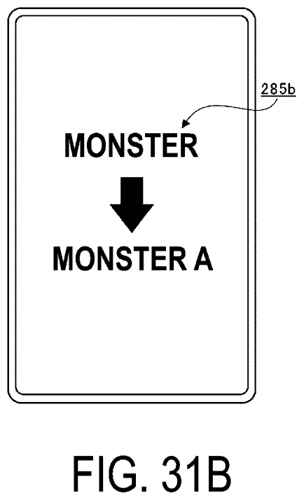

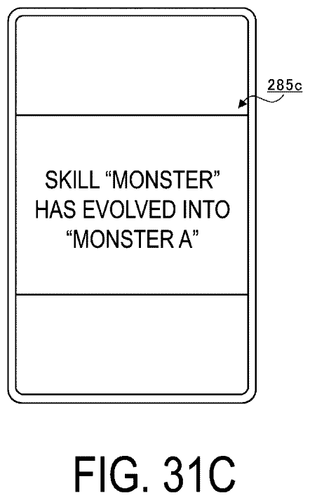

FIG. 31A is a fourth diagram for describing an evolution performance image. FIG. 31B is a fifth diagram for describing an evolution performance image. FIG. 31C is a sixth diagram for describing an evolution performance image. When a plurality of evolution-compatible skills change into evolution skills, an evolution performance image is repeatedly displayed in the evolution performance. For example, when two evolution-compatible skills are changed to evolution skills, first, as illustrated in FIGS. 30A, 30B, and 30C, the change of the first evolution-compatible skill is suggested by the display of the first evolution performance image. Thereafter, as illustrated in FIGS. 31A, 31B, and 31C, the first image 285a, the second image 285b, and the third image 285c are sequentially displayed as the second evolution performance image. This suggests the change of the second evolution-compatible skill.

As described above, in the present embodiment, an evolution performance image suggesting a skill change is displayed. When there are a plurality of skills changing, images or text corresponding to the plurality of skills are consecutively displayed in the evolution performance image. Note that the above-described evolution performance is merely an example, and specific contents of the evolution performance image are not particularly limited. Also, when there are a plurality of skills changing, images or text corresponding to the plurality of skills may be simultaneously displayed in the evolution performance image.

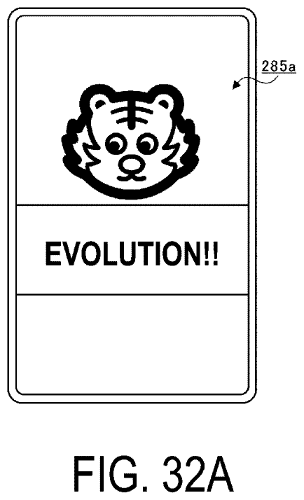

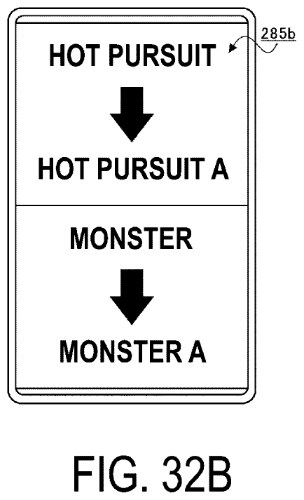

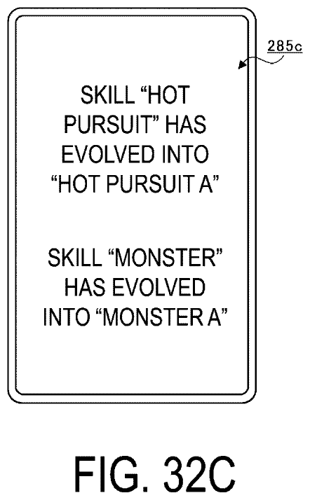

FIG. 32A is a first diagram for describing an evolution performance image according to a modified example. FIG. 32B is a second diagram for describing an evolution performance image according to the modified example. FIG. 32C is a third diagram for describing an evolution performance image according to the modified example. In a manner similar to the above, in the evolution performance image according to the modified example, the first image 285a is displayed as illustrated in FIG. 32A. Thereafter, as illustrated in FIG. 32B, the second image 285b is displayed. At this time, in the modified example, images corresponding to a plurality of evolution-compatible skills are simultaneously displayed.

Specifically, in the second image 285b, the screen is divided into two display regions. In each of the divided display regions, an image corresponding to the different evolution-compatible skill is displayed. In the example illustrated in FIG. 32B, it is suggested that the skill “Hot pursuit” will change to the skill “Hot pursuit A” in the upper display region, and it is suggested that the skill “Monster” will change to the skill “Monster A” in the lower display region.

In addition, in the third image 285c according to the modified example, a message indicating which evolution-compatible skill is changed to which evolution skill is displayed by a text image. At this time, in the third image 285c, messages corresponding to two evolution-compatible skills are simultaneously displayed in one text image.

Note that the display pattern of the evolution performance image may vary depending on the number of changing skills. For example, when the number of changing skills is less than a predetermined number, the evolution performance image may be displayed as in the above-described embodiment, and when the number of changing skills is equal to or greater than the predetermined number, the evolution performance image may be displayed as in the above-described modified example. For example, the display content of the evolution performance image such as the second image 285b or the third image 285c is determined based on the changing skill. That is, if the changing skill is different, the display content of the evolution performance image is naturally also different.

In the nurture game, the parameters of the nurture target character are important. According to the present embodiment, by the evolution representation, the player can appropriately comprehend the obtainment or change of a skill. In particular, even when a plurality of skills change, an image is displayed for each skill. Accordingly, it is possible to reduce the possibility of the player not appropriately comprehending the obtained skill and the enjoyment of the game being reduced.

As described above, when the evolution performance image is displayed in the evolution performance, the nurture game ends. When the nurture game ends, the evaluation score of the nurtured character is calculated. Here, the evaluation score is calculated based on the ability parameters, the aptitude parameters, the obtained skills, race results, team race results, and the like at the end of the nurture game. Note that the method for calculating the evaluation score, in other words, a calculation formula for calculating the evaluation score, is prepared in advance, and the evaluation score is calculated based on a predetermined calculation formula. The calculation method and the calculation formula for the evaluation score are not particularly limited. For example, the evaluation score may be calculated based only on a parameter that affects a race result when a nurtured character has run in a race in a team competition game or another game, such as an ability parameter, an aptitude parameter, an obtained skill, or the like at the end of the nurture game.

A nurture rank is set for the nurtured character, based on the evaluation score. The nurture rank is an indicator of the strength of the nurtured character, and a range of evaluation score is associated with each nurture rank. For example, a nurture rank of “A+” is given to a nurtured character having an evaluation score ranging from 13000 to 14499, and a nurture rank of “S” is given to a nurtured character having an evaluation score ranging from 14500 to 15499. In this manner, by giving the nurture rank based on the evaluation score, the approximate strength of the nurtured character is made easy to understand. The nurtured character information includes the evaluation score and the nurture rank.

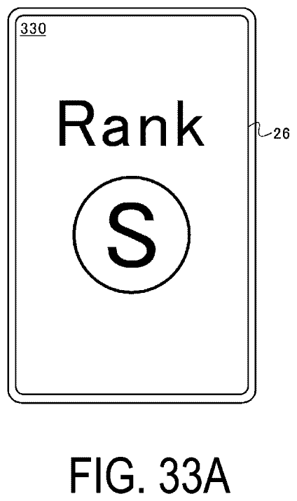

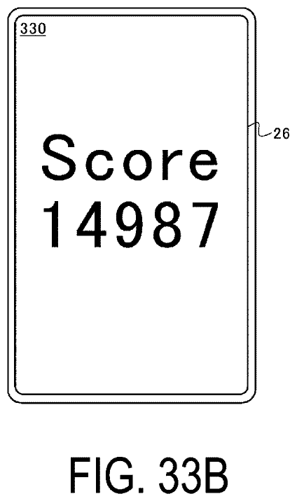

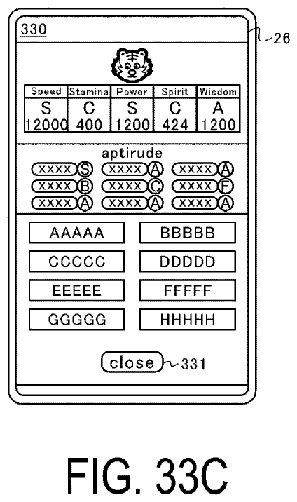

FIG. 33A is a first diagram for describing a nurture completion screen 330. FIG. 33B is a second diagram for describing the nurture completion screen 330. FIG. 33C is a third diagram for describing the nurture completion screen 330. When the nurture game ends, the nurture completion screen 330 is displayed on the display 26 as illustrated in FIG. 33A. On the nurture completion screen 330, the nurture rank of the nurtured character is first displayed, and thereafter, the evaluation score is displayed as illustrated in FIG. 33B.

When a predetermined amount of time elapses after the evaluation score is displayed, the ability parameter, the aptitude parameter, and the obtained skill of the nurtured character are displayed on the nurture completion screen 330 as illustrated in FIG. 33C. At this time, a close operation portion 331 is provided on the nurture completion screen 330. When the close operation portion 331 is tapped, the nurture completion screen 330 is hidden, and the home screen 100 is displayed on the display 26.

When the nurture game ends, a lottery for a factor to be obtained by the nurtured character is performed, and factor information is stored in association with the nurtured character. Although not illustrated, the player can display the factor information obtained by the nurtured character on the nurture completion screen 330. The lottery for a factor is executed according to preset conditions for each factor type. The factor obtaining probability and the like are set based on the result of the nurture game.

When one or more evolution skills are obtained, the nurture completion screen 330 is displayed in conjunction with the end of the display of the evolution performance image. On the other hand, when none of the evolution-compatible skills satisfying the evolution condition have been obtained, by operating the confirmation operation portion 280b of the end confirmation dialog 280 illustrated in FIG. 28A, the nurture completion screen 330 is displayed without displaying the evolution skill selection dialog 282 and the evolution performance image.

In addition, although the evolution skill selection dialog 282 is displayed, no evolution skill may be selected. In this case, when the confirmation operation portion 282a of the evolution skill selection dialog 282 is operated, the nurture completion screen 330 is displayed without displaying the evolution performance image. However, also in this case, the nurture completion screen 330 may be displayed after a performance image is displayed.

As described above, in conjunction with the end of the nurture game, the nurtured character associated with the nurture target character, the various parameters, and the skills is created. Then, the evolution performance image is displayed from the start of the nurture game until the nurtured character is created. Further, although an operation for ending the nurture game is accepted, generation of the nurtured character and display of the evolution performance image are executed based on input of the operation for ending the nurture game.

Note that the display timing of the evolution performance image may be, for example, after the end of the nurture game. For example, at the time when the nurture completion screen 330 is displayed, the nurture game has already ended. Thus, the evolution performance image may be displayed after the nurture completion screen 330 is displayed. In this case, for example, the evolution-compatible skill before the change may be displayed once as the obtained skill on the nurture completion screen 330, and the display of the obtained skill may be changed after the evolution performance image is displayed.

Further, the timing of changing the skill may be during the nurture main game. For example, at the time when the evolution condition is satisfied, the evolution-compatible skill may be changeable to the evolution skill. In this case, for example, the evolution skill may be activated in a race during the nurture main game.

Next, the functional configuration of the player terminal 1 and the server 1000 for executing the above-described nurture game will be described.

### Functional Configuration of Player Terminal 1

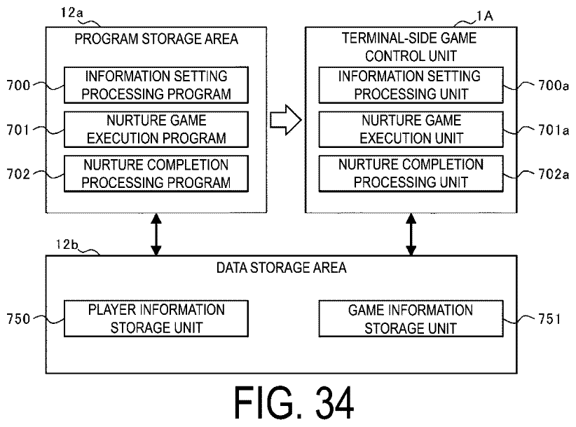

FIG. 34 is a diagram for describing a configuration of the memory 12 in the player terminal 1 and a function as a computer. The memory 12 is provided with a program storage area 12a and a data storage area 12b. When the game is started, the CPU 10 stores a terminal-side game control program (module) in the program storage area 12a.

The terminal-side game control program includes an information setting processing program 700, a nurture game execution program 701, and a nurture completion processing program 702. Note that the programs listed in FIG. 34 are examples, and many other programs are provided in the terminal-side game control program.

In the data storage area 12b, a player information storage unit 750 and a game information storage unit 751 are provided as storage units that store data. Note that the data storage area 12b is provided with a large number of other storage units. Here, information directly related to a game such as a nurture game (hereinafter referred to as game information) is stored in the game information storage unit 751. Note that various types of information during the progress of each game such as the nurture game are also temporarily stored in the game information storage unit 751. Thus, all information related to the nurtured character nurtured in the nurture game is stored in the game information storage unit 751. In addition, for example, all information other than the game information, such as information related to the player or another player, setting information of the player terminal 1, and the like, is set as player information. The player information is stored in the player information storage unit 750.

The CPU 10 operates each program stored in the program storage area 12a and updates the data in each storage unit of the data storage area 12b. Then, the CPU 10 causes the player terminal 1 (computer) to function as a terminal-side game control unit 1A by running each program stored in the program storage area 12a. The terminal-side game control unit 1A includes an information setting processing unit 700a, a nurture game execution unit 701a, and a nurture completion processing unit 702a.

To be specific, the CPU 10 runs the information setting processing program 700 to cause the computer to function as the information setting processing unit 700a. Similarly, the CPU 10 runs the nurture game execution program 701 and the nurture completion processing program 702 to cause the computer to function as the nurture game execution unit 701a and the nurture completion processing unit 702a.

When various types of information are set in the player terminal 1, the information setting processing unit 700a stores information related to the setting in the player information storage unit 750 as player information. When the information in the player information storage unit 750 is updated, the information setting processing unit 700a transmits the update information to the server 1000.

The nurture game execution unit 701a executes all processing related to the nurture game. To be specific, the nurture game execution unit 701a executes the preparation stage processing and the nurture stage processing.

The nurture completion processing unit 702a stores nurtured character information including the ability parameter, the aptitude parameter, the obtained skill, the inheritance information, the factor information, the type of the character used for nurturing, and the like of the nurtured character at the time of completion of the nurture game.

### Functional Configuration of Server 1000

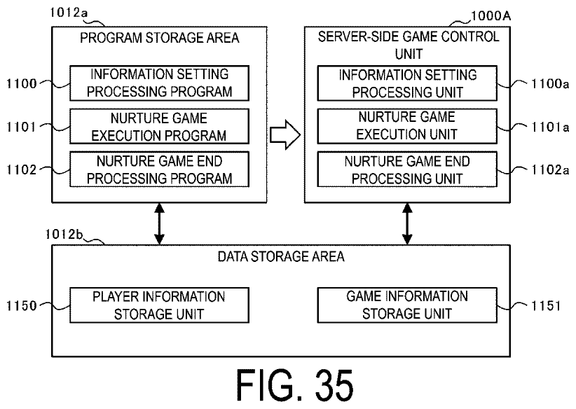

FIG. 35 is a diagram for describing the configuration of the memory 1012 in the server 1000 and the function as a computer. The memory 1012 is provided with a program storage area 1012a and a data storage area 1012b. When the game is started, the CPU 1010 stores a server-side game control program (module) in the program storage area 1012a.

The server-side game control program includes an information setting processing program 1100, a nurture game execution program 1101, and a nurture game end processing program 1102. Note that the programs listed in FIG. 35 are examples, and many other programs are provided in the server-side game control program.

In the data storage area 1012b, a player information storage unit 1150 and a game information storage unit 1151 are provided as storage units that store data. Note that the data storage area 1012b is provided with a large number of other storage units. Here, the game information of all the players is stored in the game information storage unit 1151 in association with the player ID. The player information of all the players is stored in the player information storage unit 1150 in association with the player ID.

The CPU 1010 operates each program stored in the program storage area 1012a and updates the data in each storage unit of the data storage area 1012b. Then, the CPU 1010 causes the server 1000 (computer) to function as a server-side game control unit 1000A by running each program stored in the program storage area 1012a. The server-side game control unit 1000A includes an information setting processing unit 1100a, a nurture game execution unit 1101a, and a nurture game end processing unit 1102a.

To be specific, the CPU 1010 runs the information setting processing program 1100 to cause the computer to function as the information setting processing unit 1100a. Similarly, the CPU 1010 runs the nurture game execution program 1101 and the nurture game end processing program 1102 to cause the computer to function as the nurture game execution unit 1101a and the nurture game end processing unit 1102a.

When various types of information are set in the player terminal 1, the information setting processing unit 1100a updates the player information in the player information storage unit 1150, based on the update information received from the player terminal 1. In addition, the information setting processing unit 1100a measures time and updates the game points of each player.

The nurture game execution unit 1101a executes all processing related to the nurture game.

When the nurture game ends, the nurture game end processing unit 1102a derives the evaluation score, nurture rank, and the like for the nurtured character. In addition, the nurture game end processing unit 1102a determines the factor to be obtained by the nurtured character through a lottery. The game information storage unit 1151 stores nurtured character information including the ability parameter, the aptitude parameter, the obtained skill, the inheritance information, the factor information, the type of the character used for nurturing, and the like of the nurtured character associated with the player ID.

Note that the information setting processing unit 700a in the player terminal 1 and the information setting processing unit 1100a in the server 1000 are the same in that both store player information, but are different from each other in the specific content of processing and the range of stored player information. In addition, the nurture game execution unit 701a in the player terminal 1 and the nurture game execution unit 1101a in the server 1000 are the same in that they execute processing related to the nurture game, but they have different roles, that is, different ranges of responsibility.

Processing performed by each functional unit in the player terminal 1 and the server 1000 will be described below with reference to a flowchart.

### Processing of Player Terminal 1 and Server 1000

### Processing Related to Nurture Game

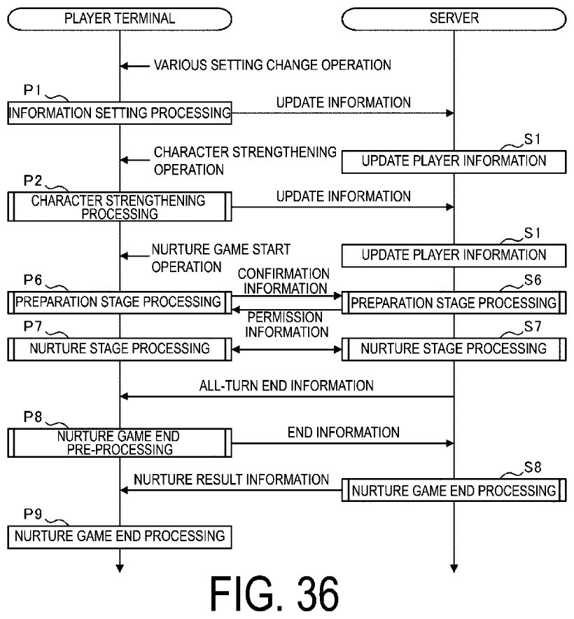

FIG. 36 is a sequence diagram for describing processing of the player terminal 1 and the server 1000 related to the nurture game. In the following description, the processing in the player terminal 1 is denoted by Pn (n is an arbitrary integer). Processing in the server 1000 is denoted by Sn (n is an arbitrary integer).

When the player performs various setting change operations on the player terminal 1, the information setting processing unit 700a of the player terminal 1 performs information setting processing of updating the player information storage unit 750, based on the operation input of the player (P1). In this information setting processing, the update information is transmitted to the server 1000. In the server 1000, when the update information is received, the information setting processing unit 1100a updates the player information of the player information storage unit 1150 (S1).

The player information updated in P1 and S1 includes, for example, profile information that can be set by the player. In addition, for example, when an operation of adding another player as a friend or an operation of removing a friend is input as a setting change operation, friend information that is information related to friends is updated. In P1 and S1, each of the information setting processing unit 700a and the information setting processing unit 1100a manages the game points spent to execute the nurture game. When the game points are less than the upper limit value, the information setting processing units 700a and 1100a measure time and give a predetermined value of game points to the player at predetermined time intervals.

When the player performs a character strengthening operation for strengthening a character (character card) in the player terminal 1, the information setting processing unit 700a executes character strengthening processing (P2).

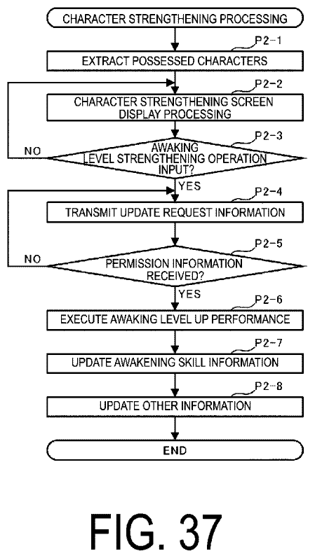

FIG. 37 is a flowchart for describing the character strengthening processing in the player terminal 1. Here, of the character strengthening processing, the processing related to awakening levels will be described, and description of other processing will be omitted. For example, when the strengthening screen selection operation portion 102b is operated, a selection screen for selecting the strengthening type is displayed. On this selection screen, the player can select either a character or a support card as the strengthening type. The player operation of selecting a character as the strengthening type on the selection screen is a character strengthening operation. In addition, as described above, the operation of the strengthening operation portion 163b on the character detail screen 160 (see FIG. 6B) is also a character strengthening operation.

When the character strengthening operation is input, the information setting processing unit 700a extracts the possessed characters (P2-1). Then, the information setting processing unit 700a executes character strengthening screen display processing (P2-2) for generating and displaying the character strengthening screen 165, based on the extracted possessed characters. In the character strengthening screen display processing, processing of switching the display screen and processing of updating the character in the selected state are executed based on the operation input of the player. Here, when the awakening level up button 169a is operated on the character strengthening screen 165, a confirmation screen is displayed.

When an awakening level up operation for increasing the awakening level is input on the confirmation screen (YES in P2-3), the information setting processing unit 700a transmits update request information to the server 1000 (P2-4). Although detailed description is omitted, in the server 1000, when the update request information is received, it is confirmed whether the player possesses an item necessary for increasing the awakening level. When the player possesses a necessary item, processing of updating the awakening level by consuming the item is executed (S1). Further, in the server 1000, the player terminal 1 is caused to receive permission information.

When the player terminal 1 receives the permission information (YES in P2-5), the information setting processing unit 700a executes an awakening level up performance suggesting an increase in the awakening level (P2-6). In addition, the information setting processing unit 700a updates the awakening skill information, based on the updated awakening level (P2-7). Here, unlock information indicating that the awakening skill has been unlocked is stored. Also, the information setting processing unit 700a updates other information such as the awakening level and the number of possessed items (P2-8).

Referring back to FIG. 36, when a nurture game start operation for starting the nurture game is input to the player terminal 1, the nurture game execution unit 701a executes the preparation stage processing (P6). Further, during the preparation stage processing, communication processing is executed between the player terminal 1 and the server 1000. In the server 1000, the nurture game execution unit 1101a executes the preparation stage processing, based on the information received from the player terminal 1 (S6).

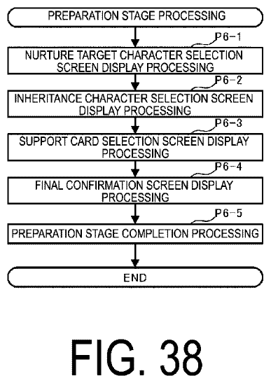

FIG. 38 is a flowchart for describing the preparation stage processing (P6) in the player terminal 1. The nurture game execution unit 701a of the player terminal 1 executes nurture target character selection screen display processing (P6-1). Here, the nurture game execution unit 701a displays the nurture target character selection screen 150 and temporarily registers, based on the operation input of the player, the nurture target character.

Specifically, the nurture game execution unit 701a switches the display screen of the display 26 when a display switching operation for switching the screen display is input by the player. When a press and hold operation of the character icon 151 on the nurture target character selection screen 150 is input, the character detail screen 160 is displayed by the nurture game execution unit 701a. When the strengthening operation portion 163b is operated on the character detail screen 160, the character strengthening screen 165 is displayed. When a selection operation (operation of the character icon 151) is input on the nurture target character selection screen 150, the nurture game execution unit 701a temporarily stores the character corresponding to the character icon 151 selected via input and switches the display screen.

When a confirm operation (operation of the next operation portion 154) is input on the nurture target character selection screen 150, the nurture game execution unit 701a temporarily registers the temporarily stored character as the nurture target character. In addition, the nurture game execution unit 701a obtains, from the server 1000, information related to a representative character extracted in accordance with a predetermined extraction condition, such as a representative character of a friend, and displays the inheritance character selection screen 170.

Next, the nurture game execution unit 701a executes inheritance character selection screen display processing (P6-2). Here, the nurture game execution unit 701a switches the display screen of the display 26 when a display switching operation is input. When a selection operation (operation of the nurtured character icon 182) is input on the nurtured character list screen 180, the nurture game execution unit 701a temporarily stores the character corresponding to the nurtured character icon 182 operated for selection as the inheritance character and switches the display screen.

In addition, when a confirm operation (operation of the next operation portion 154) is input on the inheritance character selection screen 170, the nurture game execution unit 701a displays the support card organization screen 190 on the display 26.

Next, the nurture game execution unit 701a executes support card selection screen display processing (P6-3). Here, when a selection operation (operation of the card icon 201 of the support card) is input, the nurture game execution unit 701a temporarily stores the support card corresponding to the card icon 201 operated for selection and switches the display screen.

When a display switching operation for switching the display of the screen is input while the support card organization screen 190 is being displayed, the nurture game execution unit 701a switches the display screen of the display 26. When a confirm operation (operation of the start operation portion 193) is input, the nurture game execution unit 701a displays a final confirmation screen 205 on the display 26.

Next, the nurture game execution unit 701a executes final confirmation screen display processing (P6-4). Here, the nurture game execution unit 701a switches the display screen of the display 26 when a display switching operation for switching the screen display is input.

When a selection operation (operation of the select operation portion 206c) is input on the preset selection screen 205A, the nurture game execution unit 701a temporarily stores reservation selection information corresponding to the preset operated for selection and switches the display screen.

When a confirm operation (operation of the start operation portion 205b) is input on the final confirmation screen 205, the nurture game execution unit 701a executes preparation stage completion processing (P6-5). Here, the nurture game execution unit 701a determines whether the game points are equal to or greater than a predetermined value (for example, 30) and, if the game points are equal to or greater than the predetermined value, transmits the confirmation information to the server 1000.

Note that the confirmation information includes information for identifying the nurture target character, the inheritance character, and the support card that are temporarily registered. When the confirmation information is received, the preparation stage processing (S6) is executed in the server 1000. Although details will be described later, in the server 1000, it is determined whether to permit execution of the nurture main game using the nurture target character, the inheritance character, and the support card which are temporarily registered.

When permission information is received from the server 1000 after the confirmation information is transmitted, the nurture game execution unit 701a registers the temporarily registered nurture target character. In addition, the nurture game execution unit 701a registers the nurtured character temporarily stored as the inheritance character and the temporarily stored support card in the deck.

Further, the nurture game execution unit 701a registers the character ID of the character set as the specific character, based on the specific character information. The nurture game execution unit 701a also sets initial character identification information. The nurture game execution unit 701a also registers the reservation selection information of the temporarily stored preset. Accordingly, the preparation stage completion processing ends, and the nurture main game starts.

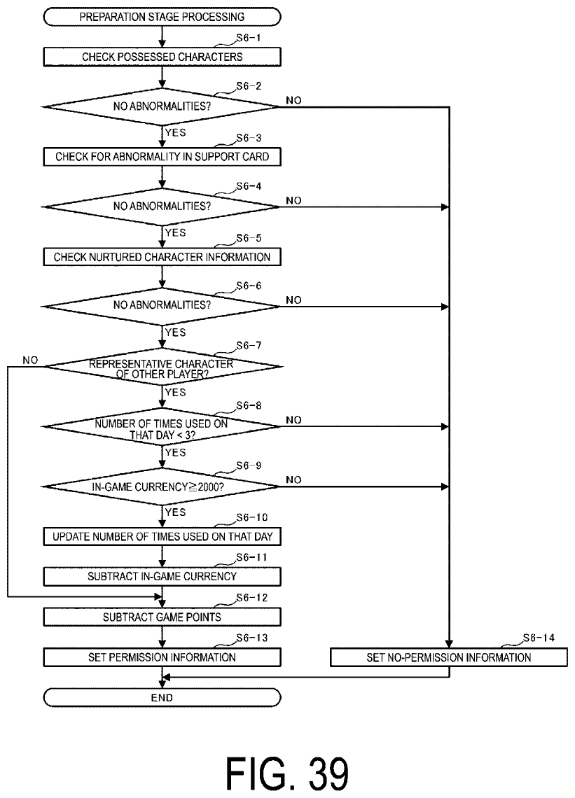

FIG. 39 is a flowchart for describing the preparation stage processing (S6) in the server 1000. When receiving the confirmation information, the nurture game execution unit 1101a confirms the possessed characters of the player stored in the player information storage unit 1150 (S6-1). If the nurture target character selected by the player is included in the possessed characters, the nurture game execution unit 1101a determines that there is no abnormality (S6-2).

If there is no abnormality in the nurture target character selected by the player (YES in S6-2), the nurture game execution unit 1101a checks whether there is an abnormality in the support card selected by the player (S6-3). In S6-3, it is determined that there is an abnormality when a support card not possessed by the player is selected, when the rental card selected by the player is not associated with the player ID of the player, when the support character overlaps with the nurture target character, or the like.

If there is no abnormality in the support card selected by the player (YES in S6-4), the nurture game execution unit 1101a checks the nurtured character information stored in the game information storage unit 1151 (S6-5). When the nurtured character selected by the player as the inheritance character is associated with the player ID of the player, that is, when the nurtured character nurtured by the player is selected as the inheritance character, the nurture game execution unit 1101a determines that there is no abnormality in the inheritance character (YES in S6-6).

When it is determined that there is no abnormality in the inheritance character, the nurture game execution unit 1101a determines whether a representative character of another player is included in the nurtured characters selected as the inheritance character by the player (S6-7). When a representative character of another player is included (YES in S6-7), the nurture game execution unit 1101a determines whether the number of uses on the day is less than three (S6-8).

When the number of uses on the day is less than three (YES in S6-8), the nurture game execution unit 1101a determines whether the predetermined in-game currency possessed by the player is 2000 or greater (S6-9). That is, in S6-8 and S6-9, it is determined whether the forming condition is satisfied. When the player possesses 2000 or greater in-game currency (YES in S6-9), the nurture game execution unit 1101a adds “1” to the number of uses on that day (S6-10). In addition, the nurture game execution unit 1101a subtracts 2000 from the amount of possessed predetermined in-game currency stored in the player information storage unit 1150 (S6-11).

Further, the nurture game execution unit 1101a subtracts a predetermined value (for example, 30) from the game points of the player (S6-12). Then, in a case where there is no abnormality in the nurture target character, the inheritance character, and the support card and the forming condition for using the representative character of another player is satisfied, the nurture game execution unit 1101a sets permission information (S6-13) and causes the player terminal 1 to receive the permission information. On the other hand, in a case where there is an abnormality in the nurture target character, the inheritance character, or the support card or the forming condition for using the representative character of another player is not satisfied, the nurture game execution unit 1101a sets no-permission information (S6-14) and causes the player terminal 1 to receive the no-permission information. When the no-permission information is received, the final confirmation screen 205 is displayed on the player terminal 1, and a predetermined error is notified.

Referring back to FIG. 36, when the preparation stage processing (P6, S6) ends, in the player terminal 1, the nurture game execution unit 701a executes the nurture stage processing (P7). Further, during the nurture stage processing, communication processing is executed between the player terminal 1 and the server 1000. In the server 1000, the nurture game execution unit 1101a executes the nurture stage processing, based on the information received from the player terminal 1 (S7).

Hereinafter, the nurture stage processing (P7) executed in the player terminal 1 and the nurture stage processing (S7) executed in the server 1000 will be described. However, here, in order to facilitate understanding, the processing in the player terminal 1 and the processing in the server 1000 will be described by appropriately changing the order.

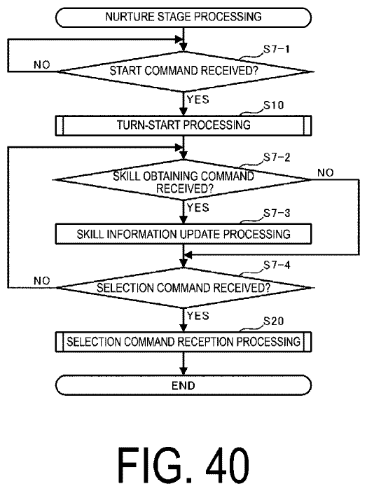

FIG. 40 is a flowchart for describing the nurture stage processing in the server 1000. The nurture game execution unit 1101a of the server 1000 waits for reception of a start command from the player terminal 1 (S7-1). When the start command is received (YES in S7-1), the nurture game execution unit 1101a executes the turn-start processing (S10). Note that the start command is transmitted from the player terminal 1 to the server 1000, for example, when processing or a performance related to the current turn is completed.

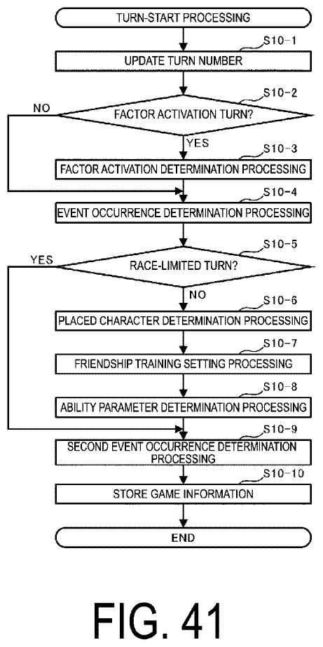

FIG. 41 is a flowchart for describing the turn-start processing in the server 1000. The nurture game execution unit 1101a of the server 1000 updates the current turn number (S10-1). If the current turn is a factor activation turn (YES in S10-2), the nurture game execution unit 1101a executes activation factor determination processing (S10-3). Here, whether to activate a factor is determined for each registered inheritance character.

Also, the nurture game execution unit 1101a executes event occurrence determination processing (S10-4). Here, the nurture game execution unit 1101a determines an event to be generated in the current turn for the scenario event, the exclusive event, the first event, or the like.

If the current turn is not a race-limited turn (NO in S10-5), the nurture game execution unit 1101a executes placed character determination processing (S10-6). Here, for each of the support character and specific character such as a story character, the nurture game execution unit 1101a determines whether to place or not and the training item to be placed in through a lottery, based on the placement table (FIG. 26). At this time, when the training item to be placed is determined, the nurture game execution unit 1101a stores the character in association with the determined training item.

Next, the nurture game execution unit 1101a executes friendship training setting processing (S10-7). Here, the “Processing of setting the friendship training possible state” described using FIG. 25 is executed. That is, the nurture game execution unit 1101a extracts a support character placed in any one of the training items. Then, it is determined whether each setting condition for the friendship training possible state is satisfied for the extracted support character. The nurture game execution unit 1101a associates the friendship training occurrence information with the support character satisfying the setting condition of the friendship training possible state. Also, the friendship training possible information is associated with the training item in which the support character satisfying the setting conditions for the friendship training possible state is placed.

Next, the nurture game execution unit 1101a executes ability parameter determination processing (S10-8). Here, the “processing of determining the increase value of the ability parameter” described using FIG. 25 is executed. That is, the nurture game execution unit 1101a selects any one of the five training items as a processing target. The nurture game execution unit 1101a obtains the training level of the ability parameter that is the processing target and determines the fixed increase value.

In addition, the nurture game execution unit 1101a obtains the placement information of the placed character and determines the additional value. In addition, the nurture game execution unit 1101a determines whether other additional conditions are satisfied and determines the final increase value of the training item that is the processing target, based on the satisfied additional condition. The determination of the final increase value for the ability parameter is executed for each training item.

Although a detailed description is omitted, in the ability parameter determination processing, an energy decrease amount or an energy recovery amount when each training item is executed is determined. The nurture game execution unit 1101a calculates a failure rate of training for each training item, based on the energy of the nurture target character.

Next, the nurture game execution unit 1101a executes second event occurrence determination processing (S10-9). Here, the “Processing of setting the second event possible state” described using FIG. 25 is executed. In other words, the nurture game execution unit 1101a determines whether to execute a support event set in advance for the support card associated with the training item through a lottery.

Then, the nurture game execution unit 1101a stores the information determined in the above processing as the game information received by the player terminal 1 (S10-10).

Referring back to FIG. 40, when a skill obtaining command indicating obtainment of any base skill is received from the player terminal 1 after the turn-start processing has ended (YES in S7-2), skill information such as the skill obtainment information is updated (S7-3). Here, the obtainment information is associated with the obtained skill. Here, the nurture game execution unit 1101a subtracts the skill points required to obtain the skill from the currently possessed skill points. Here, the updated skill information is caused to be received by the player terminal 1. Further, the server 1000 waits until a selection command is received from the player terminal 1 (S7-4).

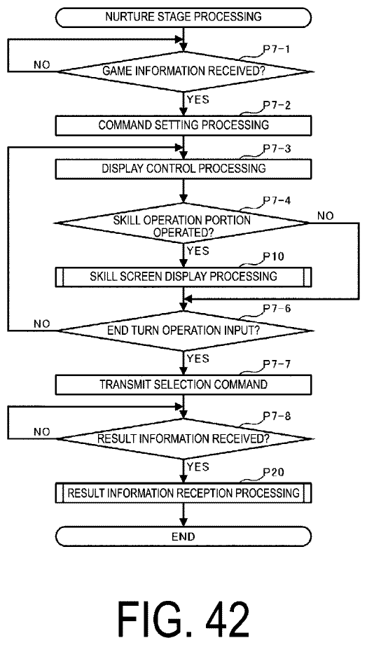

FIG. 42 is a flowchart for describing the nurture stage processing in the player terminal 1. The nurture game execution unit 701a of the player terminal 1 waits for reception of game information from the server 1000 (P7-1). Then, when the game information is received (YES in P7-1), the nurture game execution unit 701a executes command setting processing (P7-2). Here, processing of setting a command that can be selected by the player is executed based on the current turn number.

Further, the nurture game execution unit 701a executes display control processing of displaying a game screen, based on the received game information (P7-3). Here, the nurture game execution unit 701a displays the top screen 210, the training screen 220, and the like, based on the received game information. Specifically, the nurture game execution unit 701a displays the placed character icon 228 for each training item on the training screen 220. The nurture game execution unit 701a performs display control of the stats display portion 213. Further, the nurture game execution unit 701a causes the operation portion corresponding to the training item set to the friendship training possible state and the training operation portion 216 of the top screen 210 to display an effect.

When the skill operation portion 217 is operated (YES in P7-4), the nurture game execution unit 701a executes skill screen display processing (P10).

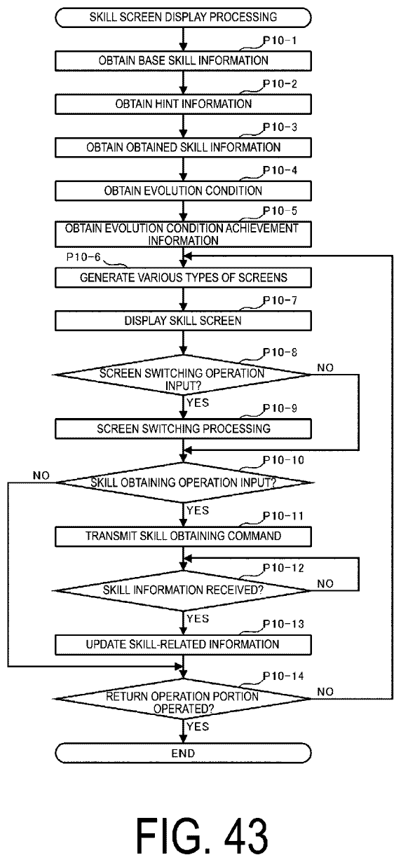

FIG. 43 is a flowchart for describing the skill screen display processing in the player terminal 1. The nurture game execution unit 701a obtains base skill information (P10-1), obtains hint information (P10-2), and obtains obtained skill information (P10-3). In addition, the nurture game execution unit 701a obtains the evolution condition set for the evolution-compatible skill of the nurture target character (P10-4). In addition, the nurture game execution unit 701a obtains evolution condition achievement information indicating whether the evolution condition is achieved (P10-5).

The nurture game execution unit 701a generates various screens such as the skill screen 230, the evolution skill confirmation screen 236, and the evolution condition confirmation screen 238, based on the obtained information (P10-6). Then, the nurture game execution unit 701a displays the generated skill screen 230 (P10-7). When an operation for switching the screen is input (YES in P10-8), the nurture game execution unit 701a executes screen switching processing of switching the display screen (P10-9).

When a skill obtaining operation (tap of the confirmation operation portion 235a) for obtaining any of the base skills is input (YES in P10-10), the nurture game execution unit 701a transmits a skill obtaining command to the server 1000 (P10-11). Thereafter, when the skill information is received from the server 1000 (YES in P10-12), the nurture game execution unit 701a updates the skill-related information related to the skill (P10-13). When the return operation portion 235c is operated (YES in P10-14), the display of the skill screen 230 is ended.

Referring back to FIG. 42, the nurture game execution unit 701a switches the display screen of the display 26, based on the operation input by the player, until the turn end operation is input (NO in P7-6). Here, the turn end operation is an operation of ending the current turn and includes: an operation of the rest operation portion 215, the going out operation portion 218, the speed operation portion 221, the stamina operation portion 222, the power operation portion 223, the spirit operation portion 224, and the wisdom operation portion 225; an operation of determining a race event of a race; and the like.

When the turn end operation is input (YES in P7-6), the nurture game execution unit 701a transmits a selection command corresponding to the turn end operation input by the player to the server 1000 (P7-7). Thereafter, the player terminal 1 waits until the result information is received from the server 1000 (NO in P7-8).

Referring back to FIG. 40, when a selection command is received from the player terminal 1 (YES in S7-4), the nurture game execution unit 1101a executes selection command reception processing (S20).

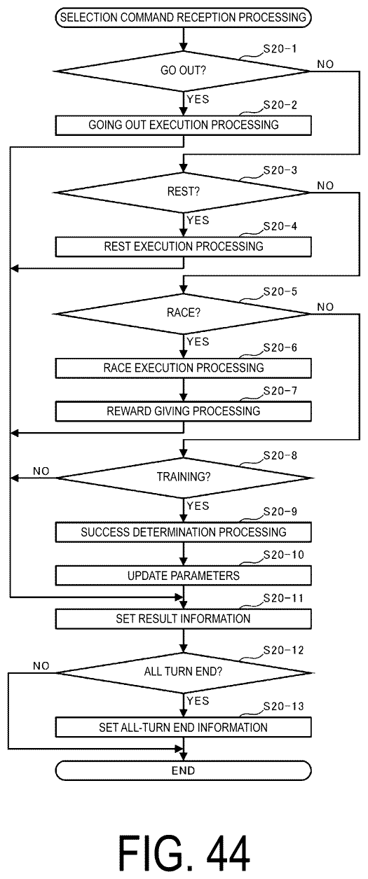

FIG. 44 is a flowchart for describing the selection command reception processing in the server 1000. When the selection command indicating an operation input of the going out operation portion 218 is received (YES in S20-1), the nurture game execution unit 1101a executes going out execution processing (S20-2). Here, a going out event is determined that increases the energy and mood parameters. Further, the parameters for the energy and mood are updated based on the determined going out event.

When the selection command indicating an operation input of the rest operation portion 215 is received (YES in S20-3), the nurture game execution unit 1101a executes rest execution processing (S20-4). Here, a rest event is determined that increases the energy parameter. Further, the parameter for the energy is updated based on the determined rest event.

When the selection command indicating an operation input to start a race is received (YES in S20-5), the nurture game execution unit 1101a executes race execution processing (S20-6). Here, a race simulation is executed based on the parameters of the nurture target character and the NPCs that run in the race. Further, the nurture game execution unit 1101a executes reward giving processing of giving a reward to the player (S20-7). Here, a reward is determined based on the result of the simulation, that is, the placing, the race development, and the like of the nurture target character, and the determined reward is given to the player.

When the selection command indicating execution of any training is received (YES in S20-8), the nurture game execution unit 1101a executes success determination processing (S20-9). Here, the success or failure of the training is determined based on the failure rate calculated in advance. Then, the nurture game execution unit 1101a updates various parameters, based on the determination result of S20-9 (S20-10).

Here, the ability parameters and the like are updated as determined in S10-8 at the start of the training. In this case, the value of the bond parameter of the placed character is updated. Then, the nurture game execution unit 1101a sets result information including: the results of the going out execution processing, the rest execution processing, the race execution processing, the reward giving processing, and the success determination processing; and various updated information, and causes the player terminal 1 to receive the result information (S20-11).

When all the turns are completed in the server 1000 (YES in S20-12), the nurture game execution unit 1101a causes the player terminal 1 to receive all-turn end information indicating that all of the turns are finished (S20-13).

Referring back to FIG. 42, when the player terminal 1 receives the result information from the server 1000 (YES in P7-8), the nurture game execution unit 701a executes result information reception processing (P20).

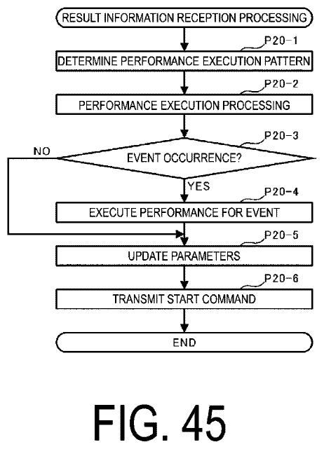

FIG. 45 is a flowchart for describing the result information reception processing in the player terminal 1. The nurture game execution unit 701a determines, based on the received result information, the performance execution pattern (P20-1). Then, the nurture game execution unit 701a executes a performance in the execution pattern determined in P20-1 (P20-2). Here, when the training in which the friendship training possible state is set is successful, a friendship-training-exclusive performance is executed.

Specifically, in P20-1, the nurture game execution unit 701a specifies a character associated with the successful training item and associated with the friendship training possible information. Then, the nurture game execution unit 701a determines the execution pattern of the friendship-training-exclusive performance corresponding to the specified character and the executed training item. In the friendship-training-exclusive performance determined at this time, the character associated with the friendship training possible information is displayed.

When the second event occurs (YES in P20-3), the nurture game execution unit 701a executes a performance for the occurring event (P20-4). Also, the nurture game execution unit 701a updates the parameters, based on the received result information (P20-5). Here, the evolution condition achievement information is updated based on the received result information. For example, in a case where executing going out is set as the first condition of the evolution condition and going out is executed, the achievement information is associated with the first condition. Also, for example, in a case where winning a predetermined race is set as the second condition of the evolution condition and the predetermined race is won, the achievement information is associated with the second condition.

When all the performances to be executed in the current turn are finished, the nurture game execution unit 701a transmits a start command to the server 1000 (P20-6). In this manner, the current turn is ended in the player terminal 1. Then, when the server 1000 receives the start command, thereafter, processing related to the next turn is executed by processing similar to that described above.

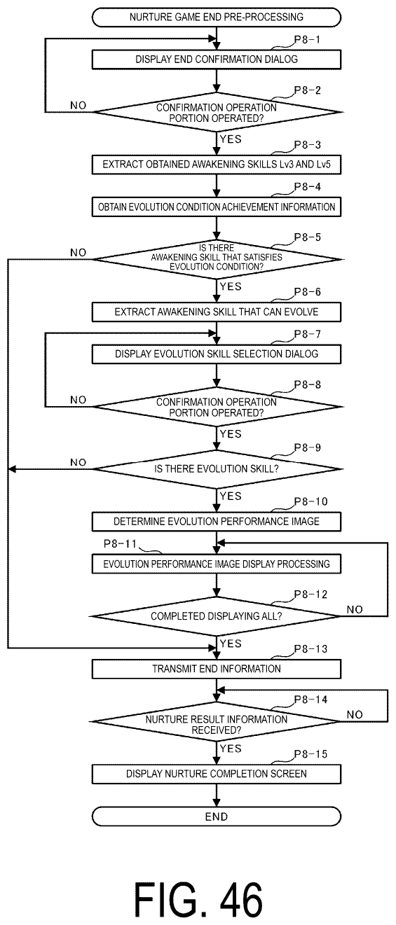

Referring back to FIG. 36, in the server 1000, when the above-described nurture stage processing (S7) ends, the player terminal 1 receives all-turn end information from the server 1000. When the all-turn end information is received, the nurture game execution unit 701a executes nurture game end pre-processing (P8). FIG. 46 is a flowchart for describing the nurture game end pre-processing in the player terminal 1. When the all-turn end information is received, the nurture game execution unit 701a displays the end confirmation dialog 280 (P8-1). When the confirmation operation portion 280b of the end confirmation dialog 280 is operated (YES in P8-2), the nurture game execution unit 701a extracts an awakening skill with an awakening level of “3” or “5” from among the obtained skills (P8-3). Here, a specific processing method is not particularly limited as long as a skill ID associated with an awakening skill with an awakening level of “3” or “5” is extracted.

Further, the nurture game execution unit 701a obtains evolution condition achievement information (P8-4). Then, when there is an awakening skill satisfying the evolution condition (YES in P8-5), the nurture game execution unit 701a extracts the awakening skill (P8-6). Then, the nurture game execution unit 701a displays the evolution skill selection dialog 282, based on the extracted awakening skill (P8-7). Here, processing of updating the skill in the selected state and processing of switching the screen are executed based on the operation input by the player.

When the confirmation operation portion 282a of the evolution skill selection dialog 282 is operated (YES in P8-8), the nurture game execution unit 701a determines whether one or more evolution skills are included in the selected skills (P8-9). When the evolution skill is included (YES in P8-9), the nurture game execution unit 701a determines the evolution performance image, that is, the content and display pattern of the evolution performance image for each evolution skill, based on the selected evolution skill and the pre-evolution awakening skill (P8-10).

The nurture game execution unit 701a executes evolution performance image display processing of displaying the evolution performance image determined in P8-10 (P8-11). Then, the nurture game execution unit 701a sequentially displays the evolution performance images until the display of all of the evolution performance images is completed (NO in P8-12). When the display of all of the evolution performance images is completed (YES in P8-12), the nurture game execution unit 701a transmits end information indicating the end of the nurture game (P8-13). The end information includes information indicating the skill selected by the player. When the nurture result information is received from the server 1000 (YES in P8-14), the nurture game execution unit 701a displays the nurture completion screen 330 (P8-15).

Referring back to FIG. 36, when the end information is received, the nurture game end processing unit 1102a executes the nurture game end processing (S8).

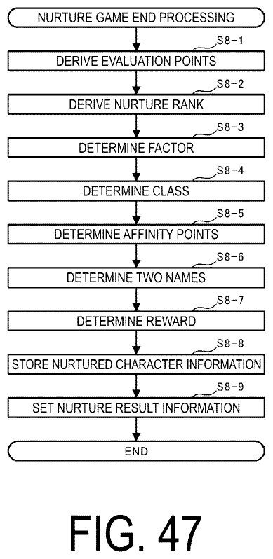

FIG. 47 is a flowchart for describing the nurture game end processing in the server 1000. The nurture game end processing unit 1102a derives evaluation scores, based on various parameters of the nurture target character (S8-1). Further, the nurture game end processing unit 1102a derives a nurture rank, based on the derived evaluation scores (S8-2).

In addition, the nurture game end processing unit 1102a determines the factor to be obtained by the nurtured character (S8-3). Further, the nurture game end processing unit 1102a determines a class, based on the number of fans obtained (S8-4). Further, the nurture game end processing unit 1102a determines affinity points, based on a predetermined parameter such as the nurture rank, the number of fans, or the like (S8-5). Although a detailed description is omitted, the affinity points are points given not to the nurtured character but to a character serving as a source of the nurtured character.

A plurality of story screens are provided for each character, and an unlock condition is set for some of the story screens. There is a story screen in which affinity points are set as an unlock condition, and when the affinity points are equal to or greater than a threshold, the player can view the story screen.

Further, the nurture game end processing unit 1102a determines two names (S8-6). Here, the condition achieved in the nurture main game is confirmed, and two names to be obtained by the nurtured character are determined. Further, the nurture game end processing unit 1102a determines a reward to be given to the player (S8-7). The nurture game end processing unit 1102a stores nurtured character information including the evaluation scores, the nurture rank, the ability parameters, the aptitude parameters, the obtained skills, the inheritance information, the factor information, the class, the two names, and the like in association with the player ID of the player in the game information storage unit 1151 (S8-8). In addition, the nurture game end processing unit 1102a sets nurture result information and causes the player terminal 1 to receive the nurture result information (S8-9).

Referring back to FIG. 36, when the player terminal 1 receives the nurture result information, the nurture completion processing unit 702a executes the nurture game end processing (P9). Here, the nurture completion processing unit 702a stores the received nurture result information in the game information storage unit 751. The nurture completion processing unit 702a displays the nurture completion screen 330 (see FIGS. 33A, 33B, and 33C) on the display 26, based on the nurture result information.

The above-described nurture game is realized via the above-described processing. Also, the nurtured character information related to the nurtured character nurtured (created) via the nurture game is stored in association with a player ID. The processing in the player terminal 1 and the server 1000 described above are merely examples. Further, each item of processing described above may be executed only by the player terminal 1 or only by the server 1000.

Here, an aspect of the embodiment has been described with reference to the accompanying drawings. However, it goes without saying that the present invention is not limited to the above-described embodiment. It is apparent to those skilled in the art that various modifications and corrections can be made within the scope of the claims, and it should be understood that such modifications and corrections also obviously fall within the technical scope of the present disclosure.

The game properties and the processing in the player terminal 1 and the server 1000 described in the above embodiment are merely examples. In addition, the content of the skill in the above-described embodiment, that is, the effect set for the skill can be appropriately designed.

In the above-described embodiment, an evolution-compatible skill for which an evolution condition is satisfied can be changed to another skill. However, the effect set for the evolution-compatible skill for which the evolution condition is satisfied may be changeable. For example, a basic effect of recovering stamina by 100 by activation during a race is set to the skill A. In addition, an evolution effect of recovering stamina by 150 is set to the skill A.

When the evolution condition of the skill A is not satisfied, the basic effect is associated with the nurture target character. On the other hand, when the evolution condition of the skill A is satisfied, the player can select the basic effect or the evolution effect. When the evolution effect is selected, the name of the skill may be changed or need not to be changed. In this case, the type of skill does not change, but the effect of the skill changes.

In other words, the information processing program causes a computer (in the embodiment, the player terminal 1 and/or the server 1000) to execute the following processing.

### Mode of Processing Executed by Computer

Processing (P20-5 and S20-10 as an example in the embodiment) of updating the parameters associated with the nurture target character, based on a player operation during the nurture game.

Processing (in the embodiment, for example, P10) of enabling a skill (in the embodiment, for example, an awakening skill) to be obtained by consuming points (in the embodiment, for example, skill points) during the nurture game, the skill being set with a first effect and associated with the nurture target character when the nurture game starts.

Processing (in the embodiment, for example, P10-13 and S7-3) of associating obtained information with an obtained skill.

Processing (in the embodiment, for example, P8) of enabling a skill or the first effect set for the skill to be changed when a change condition (in the embodiment, for example, an evolution condition) set for each skill and set for a skill associated with obtained information is satisfied.

A skill may be associated with a plurality of second skills (in the embodiment, for example, evolution skills) or a plurality of second effects (evolution effect according to a modified example).

Further, the second skill or the second effect may be selectable by the player. Note that when there are a plurality of changeable second skills or second effects, any one of them may be determined through a lottery.

A plurality of second skills or second effects may be associated with different change conditions, and the skill or the first effect may be changeable to the second skill or the second effect for which the change condition is satisfied. However, a common change condition may be associated with a plurality of second skills or second effects.

Further, during the nurture game, the computer may be caused to execute processing (in the embodiment, for example, P10-7) of displaying an obtainment screen (in the embodiment, for example, the skill screen 230) where a skill can be obtained.

In addition, the change condition set for the skill and the achievement level of the change condition may be displayed on the obtainment screen.

In addition, the skill for which the change condition is satisfied may be highlighted on the obtainment screen.

Another Mode of Processing Executed by Computer Processing (P20-5 and S20-10 as an example in the embodiment) of updating the parameters associated with the nurture target character, based on a player operation during the game.

Processing (in the embodiment, for example, P10-13 and S7-3) of associating, with the nurture target character, obtained information of a skill (in the embodiment, for example, an awakening skill) for which an effect is set, when an obtaining condition is satisfied during a game.

Processing (in the embodiment, for example, P8-13) of changing a skill associated with the obtained information and satisfying a preset change determination condition (in the embodiment, for example, the player selecting an evolution skill corresponding to an evolution-compatible skill satisfying an evolution condition) or an effect set for the skill.

Processing (in the embodiment, for example, P8-11) of displaying a performance image (in the embodiment, for example, an evolution performance image) suggesting a change of skill or effect and, when there are a plurality of changing skills or effects, simultaneously or consecutively displaying images or text corresponding to the plurality of skills in the performance image.

In addition, the game includes a nurture game, and the computer is caused to execute processing (in the embodiment, for example, S8-8) of generating a nurture completion character (in the embodiment, for example, a nurtured character) associated with a nurture target character, a parameter, and a skill in conjunction with the end of the nurture game.

Then, the performance image may be displayed from the start of the nurture game until the nurture completion character is created.

In addition, the computer is caused to execute processing (in the embodiment, for example, P8-7) of receiving an operation to end the nurture game.

Then, the processing of generating the nurture completion character and the processing of displaying the performance image may be executed based on an input of an operation to end the nurture game.

However, as described above, the timing at which the skill can be changed may be outside of the nurture game. In this case, the evolution performance image is displayed outside of the nurture game.

Further, the display content of the performance image may be determined based on the skill for which the change determination condition is satisfied (in the embodiment, for example, P8-10).

A skill may be associated with a plurality of second skills (in the embodiment, for example, evolution skills) or a plurality of second effects (evolution effect according to a modified example).

Further, the second skill or the second effect may be selectable by the player. Note that when there are a plurality of changeable second skills or second effects, any one of them may be determined through a lottery.

A plurality of second skills or second effects may be associated with different change conditions, and the skill or the effect may be changeable to the second skill or the second effect for which the change condition is satisfied. However, a common change condition may be associated with a plurality of second skills or second effects.

Note that some of the functions of the nurture game described in the embodiment described above may not be provided. A part or all of the processing in the player terminal 1 described above may be executed in the server 1000. Similarly, a part or all of the processing in the server 1000 described above may be executed in the player terminal 1. Thus, communication between the player terminal 1 and the server 1000 is not essential, and for example, all of the programs for executing the game may be stored in the player terminal 1.

An information processing program for executing the processing in the above-described embodiment and various modified examples may be stored in a non-transitory computer-readable storage medium and provided as a storage medium. Furthermore, a game terminal apparatus including the storage medium may be provided. In addition, the above-described embodiment and various modified examples may correspond to an information processing method for implementing each function and the steps illustrated in the flowcharts.

According to another aspect of the present disclosure, there is provided an information processing program that causes a computer to execute processing of updating a parameter associated with a nurture target character, based on a player operation during a game, processing of associating obtained information of a skill set with an effect with the nurture target character when an obtaining condition is satisfied during the game, processing of changing the skill associated with the obtained information and for which a preset change determination condition is satisfied, or the effect set for the skill, and processing of displaying a performance image suggesting a change of the skill or effect and, when there are a plurality of changing skills or effects, displaying images or text corresponding to the plurality of skills simultaneously or consecutively in the performance image.

In this case, the game may include a nurture game, the information processing program may further cause the computer to execute processing of generating a nurture completion character associated with the nurture target character, the parameter, and the skill in conjunction with the end of the nurture game. The performance image may be displayed during a period from a start of the nurture game until the nurture completion character is created.

Also, in this case, the information processing program may further cause the computer to execute processing of receiving an operation to end the nurture game, and the processing of creating the nurture completion character and the processing of displaying the performance image may be executed based on an input of an operation to end the nurture game.

In this case, in the processing of displaying a performance image, the display content of the performance image may be determined based on the skill for which the change determination condition is satisfied.

According to another aspect of the present disclosure, there is provided an information processing method executed by one or more computers, the method including processing of updating a parameter associated with a nurture target character, based on a player operation during a game, processing of associating obtained information of a skill set with an effect with the nurture target character when an obtaining condition is satisfied during the game, processing of changing the skill associated with the obtained information and for which a preset change determination condition is satisfied, or the effect set for the skill, and processing of displaying a performance image suggesting a change of the skill or effect and, when there are a plurality of changing skills or effects, displaying images or text corresponding to the plurality of skills simultaneously or consecutively in the performance image.

According to another aspect of the present disclosure, there is provided a game apparatus including one or more computers, wherein the one or more computers execute processing of updating a parameter associated with a nurture target character, based on a player operation during a game, processing of associating obtained information of a skill set with an effect with the nurture target character when an obtaining condition is satisfied during the game, processing of changing the skill associated with the obtained information and for which a preset change determination condition is satisfied, or the effect set for the skill, and processing of displaying a performance image suggesting a change of the skill or effect and, when there are a plurality of changing skills or effects, displaying images or text corresponding to the plurality of skills simultaneously or consecutively in the performance image.

What is claimed is:

1. A non-transitory computer readable medium storing a program that causes a computer to execute:
processing of updating a parameter associated with a nurture target character, based on a player operation during a nurture game;
processing of enabling a skill to be obtained by consuming points during the nurture game, the skill being set with a first effect and associated with the nurture target character at a start of the nurture game;
processing of associating obtained information to the skill obtained; and
processing of enabling, when a change condition set for each skill and set for the skill associated with the obtained information is satisfied, the skill or the first effect set for the skill to be changed.

2. The non-transitory computer readable medium according to claim 1, wherein
the skill is associated with a plurality of second skills or second effects, and
the processing of enabling the skill or the first effect to be changed includes enabling a player to select the second skill or the second effect.

3. The non-transitory computer readable medium according to claim 1, wherein
the skill is associated with a plurality of second skills or second effects,
each of the plurality of second skills or second effects is associated with a different change condition, and
the processing of enabling the skill or the first effect to be changed includes enabling the skill or the first effect to be changed to the second skill or second effect for which the change condition is satisfied.

4. The non-transitory computer readable medium according to claim 1, wherein the program causes the computer to execute:
processing of displaying an obtainment screen where the skill can be obtained, during the nurture game, and
the change condition set for the skill and an achievement level of the change condition are displayed on the obtainment screen.

5. The non-transitory computer readable medium according to claim 1, wherein the program causes the computer to execute:
processing of displaying an obtainment screen where the skill can be obtained, during the nurture game, and
the skill for which the change condition is satisfied is highlighted on the obtainment screen.

6. An information processing method executed by one or more computers, the method comprising:
processing of updating a parameter associated with a nurture target character, based on a player operation during a nurture game;
processing of enabling a skill to be obtained by consuming points during the nurture game, the skill being set with a first effect and associated with the nurture target character at a start of the nurture game;
processing of associating obtained information to the skill obtained; and
processing of enabling the skill or the first effect set for the skill to be changed, when a change condition set for each skill and set for the skill associated with the obtained information is satisfied.

7. A game apparatus comprising one or more computers, wherein
the one or more computers execute:
processing of updating a parameter associated with a nurture target character, based on a player operation during a nurture game;
processing of enabling a skill to be obtained by consuming points during the nurture game, the skill being set with a first effect and associated with the nurture target character at a start of the nurture game;
processing of associating obtained information to the skill obtained; and
processing of enabling the skill or the first effect set for the skill to be changed, when a change condition set for each skill and set for the skill associated with the obtained information is satisfied.
